(19) United States
(12) Patent Application Publication
(10) Pub. No.: US 2026/0112773 A1
(43) Pub. Date: Apr. 23, 2026

(54) ACID SURFACE TREATMENT OF SOLID ELECTROLYTES

(71) Applicant: QuantumScape Battery, Inc., San Jose, CA (US)

(72) Inventors: Aram YANG, San Jose, CA (US); Thomas Arnold, San Jose, CA (US); Daven Somabhai Mistry, San Jose, CA (US); Meagan Kelso, San Jose, CA (US); Samira Daneshmandi, San Jose, CA (US); Megan Donoghue, San Jose, CA (US)

(21) Appl. No.: 19/423,981

(22) Filed: Dec. 17, 2025

Related U.S. Application Data
(63) Continuation of application No. PCT/US2024/038812, filed on Jul. 19, 2024.
(60) Provisional application No. 63/514,520, filed on Jul. 19, 2023.

(51) Int. Cl. H01M 50/403; H01M 10/0562; H01M 50/434; H01M 50/443; H01M 50/449

(52) U.S. Cl. CPC H01M 50/403; H01M 10/0562; H01M 50/434; H01M 50/443; H01M 50/449; H01M 2300/0077

(57) ABSTRACT

Described herein are acid-treated solid-state electrolytes, processes for acid-treating solid-state electrolyte thin films, and electrochemical devices comprising acid-treated solid-state electrolyte thin films.

This application is a continuation of International Patent Application No. PCT/US2024/038812, filed Jul. 19, 2024, which claims priority to, and the benefit of U.S. Provisional Patent Application No. 63/514,520, filed Jul. 19, 2023, the entire contents of which are herein incorporated by reference in its entirety for all purposes.

### BACKGROUND

Conventional rechargeable batteries use liquid electrolytes to physically separate and thereby electrically insulate the positive and negative electrodes (i.e., cathodes and anodes, respectively). However, liquid electrolytes suffer from several problems including flammability during thermal runaway, outgassing at high voltages, and chemical incompatibility with lithium metal negative electrodes. As an alternative, solid electrolytes have been proposed for next generation rechargeable batteries. For example, Li⁺ ion-conducting ceramic oxides, such as lithium-stuffed garnets (e.g., Li₃La₇Zr₂O₁₂, aka LLZO), have been considered as electrolyte separators. See, for example, US Patent Application Publication No. 2015/0099190, published Apr. 9, 2015, and filed Oct. 7, 2014, titled GARNET MATERIALS FOR LI SECONDARY BATTERIES AND METHODS OF MAKING AND USING GARNET MATERIALS; U.S. Pat. Nos. 8,658,317; 8,092,941; and 7,901,658; also US Patent Application Publication Nos. 2011/0281175; 2013/0085055; 2014/0093785; and 2014/0170504, the entire contents of each of these publications are incorporated by reference in their entirety for all purposes.

When LLZO is sintered and subsequently exposed to ambient conditions (room temperature, natural atmosphere, e.g., 78% N₂ & 21% O₂; and/or with moisture also present), the surface of LLZO may be contaminated with surface species which negatively affect Li⁺ ion-conductivity. For example, lithium carbonate (Li₂CO₃) spontaneously forms on LLZO surfaces when exposed to ambient conditions. The mechanism of lithium carbonate formation on LLZO when exposed to ambient conditions is described in, for example, Cheng, L., et al., “Interrelationships among Grain Size, Surface Composition, Air Stability, and Interfacial Resistance of Al-Substituted Li₇La₃Zr₂O₁₂ Solid Electrolytes,” ACS Appl. Mater. Interfaces, 2015, 7 (32), pp 17649-17655, which discloses that LLZO can form Li₂CO₃ via two pathways: the first pathway involves a reaction with moisture in air to form LiOH, which subsequently reacts with CO₂ to form Li₂CO₃; and the second pathway involves direct reaction between LLZO and CO₂. See also Cheng, L., et al., Phys. Chem. Chem. Phys., 2014, 16, 18294-18300, which discloses that Li₂CO₃ was formed on the surface when LLZO pellets were exposed to air. Lithium carbonate as well as other forms of surface contamination, e.g., oxides, carbonates or organics, may negatively affect the electrochemical performance of a solid electrolyte in an electrochemical device by increasing the interfacial impedance between the LLZO solid electrolyte and other electrochemical device components. Previous solutions, e.g., those described in U.S. Pat. No. 9,966,630 B2, which issued May 8, 2018, and is titled ANNEALED GARNET ELECTROLYTE SEPARATORS, the entire contents of which are herein incorporated by reference in its entirety for all purposes, include using annealing to remove surface species that negatively affect electrochemical performance. PCT Application WO 2019/090360, filed Nov. 6, 2018, titled LITHIUM-STUFFED GARNET THIN FILMS AND PELLETS HAVING AN OXYFLUORINATED AND/OR FLUORINATED SURFACE AND METHODS OF MAKING AND USING THE THIN FILMS AND PELLETS, the entire contents of which are herein incorporated by reference in its entirety for all purposes, uses a solution that includes a fluoride salt and solvent to remove surface species. However, improvements are still needed.

Therefore, there is a need for processes that decrease the interfacial resistance of LLZO thin film solid electrolytes. For example, processes for mitigating surface contaminants are needed as well as processes that passivate the LLZO surface from later reacting with rechargeable battery components. New materials made by these processes are also needed. The instant disclosure sets forth solutions to these problems as well as other unmet needs in the relevant art.

### SUMMARY

In one aspect, set forth herein is a process for treating a bilayer, wherein the bilayer comprises a metal foil or metal powder layer, and a lithium-stuffed garnet layer, comprising: (a) providing a solution comprising an acid source at a concentration of about 10 ppm to 5500 ppm; (b) contacting the bilayer with the solution for about one hour or less; and (c) removing the bilayer from the solution to afford an acid-treated bilayer.

In a second aspect, set forth herein is a bilayer made by a process set forth herein.

In a third aspect, set forth herein is a bilayer comprising a metal foil or metal powder layer, and a lithium-stuffed garnet layer, wherein the lithium-stuffed garnet layer comprises a member selected from the group consisting of phosphorus (P), titanium (Ti), chlorine (Cl), sulfur (S), boron (B), zirconium (Zr), an ion thereof, and combinations thereof, at a depth of penetration of about 1 μm to 20 μm as measured by X-ray photo-electron spectroscopy (XPS).

In certain embodiments, the bilayer comprises a member selected from the group consisting of phosphorus (P), titanium (Ti), chlorine (Cl), sulfur (S), boron (B), or zirconium (Zr), an ion thereof, and combinations thereof at a depth of penetration of about 1 μm to 10 μm as measured by X-ray photo-electron spectroscopy. In certain embodiments, the bilayer is characterized as having less than 1 μm layer thereupon which includes a lithium carbonate, lithium hydroxide, lithium oxide, a hydrate thereof, an oxide thereof, or a combination thereof. In certain embodiments, the bilayer has less than about 1, but greater than 0, atomic percent of lithium carbonate as measured by X-ray photoelectron spectroscopy (XPS). In certain embodiments, the bilayer is a lithium-stuffed garnet thin film.

In certain embodiments, the bilayer comprises an acid, and/or its conjugate base, and/or dissolved ions thereof, incorporated into, or bonded, to the bilayer wherein the acid, and/or its conjugate base, and/or dissolved ions thereof is selected from the group consisting of.
(a) H₃PO₄ and/or H₂PO₄⁻ and/or PO₄³⁻ and/or PO₄²⁻;
(b) H₂SO₄ and/or HSO₄⁻ and/or SO₄⁻ and/or SO₄⁻;
(c) HCl and/or Cl⁻;
(d) H₃BO₃ and/or B(OH)₄⁻ and/or BH₂O³⁻;
(e) H₂TiF₆ and/or TiF₆²⁻;
(f) H₂ZrF₆ and/or ZrF₆²⁻; and
(g) combinations thereof.

In certain embodiments, the bilayer comprises H₃PO₄ and/or H₂PO₄⁻ and/or PO₄³⁻ and/or PO₄²⁻. In certain embodiments, the bilayer comprises phosphorus at a depth of penetration of about 1 μm to 20 μm as measured by X-ray photo-electron spectroscopy. In certain embodiments, the bilayer comprises a phosphorous-containing layer of Li₃PO₄, LiH₂PO₄, or combinations thereof.

In certain embodiments, a bilayer made by a process set forth herein or a bilayer described herein, for example, a sintered lithium-stuffed garnet thin film described herein, is characterized by an area specific resistance (ASR) at 25° C. of about 50 Ω-cm² and 5 Ω-cm², about 40 Ω-cm² and 5 Ω-cm², about 35 Ω-cm² and 5 Ω-cm², about 30 Ω-cm² and 5 Ω-cm², or about 20 Ω-cm² and 15 Ω-cm². In certain embodiments, the ASR of the acid-treated sintered lithium-stuffed garnet thin film is sustained, even when exposed to high temperature and high voltage conditions (HTHV).

In a fourth aspect, set forth herein is an electrochemical cell or rechargeable battery comprising a bilayer made by a process set forth herein or a bilayer described herein. In certain embodiments, the bilayer is sintered. In certain embodiments, the bilayer is a lithium-stuffed garnet thin film. In certain embodiments, the bilayer is sintered a lithium-stuffed garnet thin film.

In a fifth aspect, set forth herein is a continuous bilayer treatment line comprising: a front roller unto which is wound a bilayer, wherein the bilayer comprises a metal foil or metal powder layer, and a lithium-stuffed garnet layer; wherein the metal layer contacts the front roller; an end roller; at least one acid treatment section between the front roller and the end roller comprising: a reservoir or a dispense unit; wherein the reservoir or the dispense unit is suspended on top of the bilayer; and wherein the reservoir or the dispense unit contains a solution comprising an acid source at a concentration of about 10 ppm to 5500 ppm.

### BRIEF DESCRIPTION OF DRAWINGS

FIG. 1 is a graph of the area-specific resistance (ASR) of co-sintered (CSC) films treated with an acid selected from H₂TiF₆, H₃PO₄, and H₃BO₃ post treatment.

FIG. 2 is a graph of the ASR of CSC films treated with an acid selected from H₂TiF₆, H₃PO₄, and H₃BO₃ post a HTHV test at 60° C. for 1 month.

FIG. 3 is a graph of the ASR of bilayers treated with H₃PO₄ post treatment.

FIG. 4 is a graph of the ASR of bilayers treated with H₃PO₄ post a HTHV test at 60° C. for 1 month.

FIG. 5 is a graph of the ASR of bilayers treated with various concentrations of H₃PO₄ post treatment.

FIG. 6 is a graph of the ASR of bilayers treated with various concentrations of H₃PO₄ post a HTHV test at 60° C. for 1 month.

### DETAILED DESCRIPTION

The following description is presented to enable one of ordinary skill in the art to make and use the instant disclosure and to incorporate it in the context of particular applications. Various modifications, as well as a variety of uses in different applications will be readily apparent to those skilled in the art, and the general principles defined herein may be applied to a wide range of embodiments. Thus, the disclosure herein are not intended to be limited to the embodiments presented, but are to be accorded their widest scope consistent with the principles and novel features disclosed herein.

All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Please note, if used, the labels left, right, front, back, top, bottom, forward, reverse, clockwise and counterclockwise have been used for convenience purposes only and are not intended to imply any particular fixed direction. Instead, they are used to reflect relative locations and/or directions between various portions of an object.

The instant disclosure sets forth processes that include simple, industrial scalable steps, which are carried out under mild conditions using solutions that comprise aqueous acids and which enhance the interfacial property of a bilayer, comprising a metal foil or metal powder layer, and a lithium-stuffed garnet layer. In some embodiments, the lithium-stuffed garnet layer is a lithium-stuffed garnet thin film. In some embodiments, the bilayer has a minimal amount of lithium carbonate. In some embodiments, the lithium-stuffed garnet layer of the bilayer has a minimal amount of lithium carbonate. The bilayer formed (i.e., acid-treated or modified) by the processes described herein has an acid-treated surface and in certain embodiments, the surface comprises an acid and/or its conjugate base and/or ions thereof incorporated into, or bonded to, the lithium-stuffed garnet layer.

It has been unexpectedly discovered that certain types of acidic solutions etch away surface contaminants, e.g., Li₂CO₃, on bilayers, for example, garnet-type solid electrolytes. For example, the resulting acid-treated garnet-type solid electrolyte is capable of maintaining a stable area-specific resistance (ASR), even when exposed to high temperature and high voltage conditions (HTHV). For example, in certain embodiments the acid-treated garnet-type solid electrolyte experiences less than about a 10% increase in ASR following a HTHV test and this low ASR is sustained for at least about one week. In certain embodiments the acid-treated garnet-type solid electrolyte does not experience more than about a 10% increase, more than about a 15% increase, more than about a 20% increase, more than about a 30% increase, more than about a 40%, more than about a 50% increase, more than about a 60% increase, or more than about a 70% increase in ASR following a HTHV test. In certain embodiments, the low ASR is sustained for at least about one week, at least about two weeks, at least about three weeks, at least about one month, at least about two months, at least about four months, at least about six months, at least about one year, or longer.

The processes set forth herein include, but are not limited to, (1) a process that removes contaminants from a bilayer comprising a metal foil or metal powder layer, and a lithium-stuffed garnet layer; (2) a process that provides a bilayer comprising an acid and/or its conjugate base and/or ions thereof incorporated into or bonded to the bilayer; and, (3) a process that provides a bilayer characterized by less than about 1 atomic percent, but greater than 0 atomic percent, of lithium carbonate as measured by XPS. In one embodiment, the contaminant is lithium carbonate.

In certain embodiments, the processes set forth herein not only remove contaminants from a bilayer, but also provide a stable bilayer that inhibits or slows the rate of formation of contaminants when the bilayer is exposed to ambient conditions, or even conditions of high temperature and high voltage, to afford a bilayer capable of maintaining a stable ASR.

### Definitions

As used herein, the term “about,” when qualifying a number, e.g., 15% w/w, refers to the number qualified and optionally the numbers included in a range about that qualified number that includes ±10% of the number. For example, about 15% w/w includes 15% w/w as well as 13.5% w/w, 14% w/w, 14.5% w/w, 15.5% w/w, 16% w/w, or 16.5% w/w. For example, “about 75° C.,” includes 75° C. as well 68° C., 69° C., 70° C., 71° C., 72° C., 73° C., 74° C., 75° C., 76° C., 77° C., 78° C., 79° C., 80° C., 81° C., 82° C., or 83° C.

As used herein, the phrase “ambient conditions,” refers to room temperature and a natural atmosphere such as the atmosphere of planet Earth that includes approximately 78% N₂ & 21% 02; and/or with moisture also present. Ambient conditions include standard temperature and pressure, with a relative humidity of at least 1%.

As used herein, the term “annealing” refers to a process wherein an electrolyte thin film is heated from 200° C. to 1000° C. in a reducing atmosphere such as but not limited to argon, hydrogen, or a combination thereof. Example annealing processes are described in U.S. Pat. No. 9,966,630 B2, which issued May 8, 2018, and is titled ANNEALED GARNET ELECTROLYTE SEPARATORS, the entire contents of which are herein incorporated by reference in its entirety for all purposes.

As used herein, the phrase “at least one member selected from the group” includes a single member from the group, more than one member from the group, or a combination of members from the group. At least one member selected from the group consisting of A, B, and C includes, for example, A, only, B, only, or C, only, as well as A and B as well as A and C as well as B and C as well as A, B, and C or any combination of A, B, and C.

As used herein, the term “ASR” refers to area specific resistance. As used herein, the phrase “lithium interfacial resistance” refers to the interfacial resistance of a material towards the incorporation or conduction of Li⁺ ions. A lithium interfacial ASR (ASR_{interface}) is calculated from the interfacial resistance (R_{interface}) via ASR_{interface}=R_{interface}*A/2 where A is the area of the electrodes in contact with the bilayer and the factor of 2 accounts for 2 interfaces, assuming the cell is symmetric.

As used herein, area-specific resistance (ASR) is measured by electrochemical cycling using an Arbin or Biologic instrument unless otherwise specified to the contrary. ASR may be measured using electrochemical impedance spectroscopy (EIS). EIS can be performed on a Biologic VMP3 instrument or an equivalent thereof. In an example ASR measurement, lithium contacts are deposited on two sides of a sample. An AC voltage of 25 mV rms is applied across a frequency of 300 kHz-0.1 mHz while the current is measured.

As used herein, the term “bulk” refers to a portion or part of a material that is extended in space in three-dimensions by at least 1 micron (μm). The bulk refers to the portion or part of a material which is exclusive of its surface, as defined below. The bulk portion of a material, that has an acid-treated surface is the interior portion of the material which is not acid treated. Whether a portion of the material is acid treated is determined by whether P, Ti, Cl, S, B, Zr, and/or F species are detectable by XPS in the portion. The bulk of a material is also characterized as the portion of the material which is not at the surface of the material and which is therefore not exposed at the surface of the material. The bulk portion of a bilayer, wherein the bilayer comprises a metal foil or metal powder layer and a lithium-stuffed garnet layer, may refer to the bulk portion of either layer in the bilayer, if the layer is not specified.

As used herein, the term “contaminant” refers to a chemical deviation from a pristine material. A contaminant in a bilayer, may include any material other than the bilayer such as, but not limited to, a lithium carbonate, a lithium hydroxide, a lithium oxide, a lithium peroxide, a hydrate thereof, an oxide thereof, or a combination thereof, wherein oxide and lithium oxide do not include a lithium-stuffed garnet. Contaminants of a bilayer may include, but are not limited to, hydroxides, peroxides, oxides, carbonates, and combination thereof, which are not the bilayer.

As used herein, the term “drying” refers to a process of evaporating a solvent or a solution from a material such as a bilayer or thin film. Drying can be passive wherein a bilayer or thin film is dried where it is stored by allowing the solvent or solution to evaporate. Drying can be active wherein a bilayer or thin film is subjected to low pressure compressed air to drive off a solvent or a solution. Active drying can also be wherein the bilayer or thin film is subjected to heat to drive off a solvent or solution. Drying, storing, and heating may be performed in ambient conditions. Drying, storing, and heating may be performed in dry room conditions. Drying, storing, and heating may be performed in glove box conditions.

As used herein, the term “electrolyte” refers to an ionically conductive and electrically insulating material. Electrolytes are useful for electrically insulating the positive and negative electrodes of a rechargeable battery while allowing for the conduction of ions, e.g., Li⁺, through the electrolyte.

As used herein, the phrases “electrochemical cell” or “battery cell” shall, unless specified to the contrary, mean a single cell including a positive electrode and a negative electrode, which have ionic communication between the two using an electrolyte. In some embodiments, a battery or module includes multiple positive electrodes and/or multiple negative electrodes enclosed in one container, i.e., stacks of electrochemical cells. A symmetric cell unless specified to the contrary is a cell having two Li metal anodes separated by a solid-state electrolyte.

As used herein, the phrase “electrochemical device” refers to an energy storage device, such as, but not limited to a Li-secondary battery that operates or produces electricity or an electrical current by an electrochemical reaction, e.g., a conversion chemistry reaction such as 3Li+FeF₃↔3LiF+Fe.

As used herein, the phrase “film” or “thin film” refers to a thin membrane of less than 0.5 mm in thickness and greater than 10 nm in thickness. A thin film is also greater than 5 mm in a lateral dimension. A “film” or “thin-film” may be produced by a continuous process such as tape-casting, slip casting, or screen-printing.

As used herein, the phrase “film thickness” refers to the distance, or median measured distance, between the top and bottom faces of a film. As used herein, the top and bottom faces refer to the sides of the film having the largest surface area. As used herein, thickness is measured by cross-sectional scanning electron microscopy.

As used herein, the phrase “high temperature high voltage” refer to open-circuit storage of the completed battery at 100% state-of-charge and elevated temperature (a temperature above room temperature) for a desired period of time. High temperature is at least 60° C., for example, 60° C., 65° C., 70° C., 75° C., and 80° C. High voltage is at least 4.0V, for example, 4.0V, 4.1V, 4.2V, or 4.3V wherein the voltage is versus lithium (which is 0V relative to lithium metal).

In some embodiments, high temperature high voltage tests refer to temperature holds at 45° C. or 60° C. for a period of 1 week or 1 month at 4V or more (such as 4.0V, 4.15V, 4.25V, or 4.35V).

As used herein, the phrase “lithium-stuffed garnet” refers to oxides that are characterized by a crystal structure related to a garnet crystal structure. Lithium-stuffed garnets include compounds having the formula Li_{A}La_{B}M′_{C}M″_{D}Zr_{E}O_{F}, or Li_{A}La_{B}M′_{C}M″-_{D}Nb_{E}O_{F}, wherein 4<A<8.5, 1.5<B<4, 0≤C≤2, 0≤D≤2; 0≤E<2.5, 10<F<13, and M′ and M″ are each, independently in each instance selected from Al, Mo, W, Nb, Ga, Sb, Ca, Ba, Sr, Ce, Hf, Rb, and Ta; or LiₐLa_{b}Zr_{c}Al_{d}M″ₑO_{f}, wherein 5<a<7.7; 2<b<4; 0<c<2.5; 0<d<2; 0<e<2, 10<f<13 and M″ₑ is a metal selected from Nb, V, W, Mo, Ta, Ga, and Sb. Garnets, as used herein, also include those garnets described above that are doped with Al or Al₂O₃. Also, garnets as used herein include, but are not limited to, LiₓLa₃Zr₂O₁₂+yAl₂O₃, wherein x may be from 5.8 to 7.0, and y may be 0.1, 0.2, 0.3, 0.4, 0.5, 0.6, 0.7, 0.8, 0.9, or 1.0. As used herein, garnet does not include YAG-garnets (i.e., yttrium aluminum garnets, or, e.g., Y₃—Al₅O₁₂). As used herein, garnet does not include silicate-based garnets such as pyrope, almandine, spessartine, grossular, hessonite, or cinnamon-stone, tsavorite, uvarovite and andradite and the solid solutions pyrope-almandine-spessarite and uvarovite-grossular-andradite. Garnets herein do not include nesosilicates having the general formula X₃Y₂(SiO₄)₃ wherein X is Ca, Mg, Fe, and, or, Mn; and Y is Al, Fe, and, or, Cr.

As used herein, the phrase “positive electrode” refers to the electrode in a secondary battery towards which positive ions, e.g., Li+, conduct during discharge of the battery. As used herein, the phrase “negative electrode” refers to the electrode in a secondary battery from where positive ions, e.g., Li+, conduct during discharge of the battery. In a battery comprised of a Li-metal electrode and a conversion chemistry electrode (i.e., active material; e.g., NiFₓ), the electrode having the conversion chemistry materials is referred to as the positive electrode. In some common usages, cathode is used in place of positive electrode, and anode is used in place of negative electrode. When a Li-secondary battery is charged, Li ions conduct from the positive electrode (e.g., NiFₓ) towards the negative electrode (Li-metal). When a Li-secondary battery is discharged, Li ions conduct towards the positive electrode (e.g., NiFₓ; i.e., cathode) and from the negative electrode (e.g., Li-metal; i.e., anode).

As used herein, the term “separator” refers to a solid electrolyte which conducts Li⁺ ions, is substantially insulating to electrons, and is suitable for use as a physical barrier or spacer between the positive and negative electrodes in an electrochemical cell or a rechargeable battery. A separator, as used herein, is substantially insulating to electrons when the separator's lithium ion conductivity is at least 10³ times, and typically 10⁶ times, greater than the separator's electron conductivity. Unless explicitly specified to the contrary, a separator as used herein is stable when in contact with lithium metal. In one embodiment, the separator is a thin film garnet separator, for example, a lithium-stuffed garnet thin film. In one embodiment, the separator is a bare film, a CSC film, or a film-on-foil film (e.g., a bilayer, wherein the bilayer comprises a metal foil or metal powder layer and a lithium-stuffed garnet layer).

As used herein, the term “surface” refers to a material, or portion of a material, that is near or at an interface between two different phases, chemicals, or states of matter. A surface is the area of contact between two different phases or states of matter (e.g., solid-gas, liquid-gas, or solid-liquid). For example, the interface of two solids which are in direct contact with each other is a surface. For example, a bilayer, including but not limited, to a thin film garnet bilayer, when exposed to air has a surface described by the periphery or outside portion of the bilayer which contacts the air. For rectangular-shaped bilayers, there is a top and a bottom surface which both individually have higher total geometric surface areas than each of the four side surfaces individually. In this rectangular-shaped bilayer example, there are four side surfaces which each have geometric surface areas less than either of the top and bottom surfaces. For a disc-shaped bilayer, there is a top and a bottom surface which both individually have higher geometric surface areas than the circumference-side of the disc-shaped bilayer. Geometric surface area is calculated for a square or rectangular shaped-surface by multiplying length of the surface by the width of the surface. Geometric surface area is calculated for a disc-shaped surface by multiplying π by the squared radius of the disc, i.e., πr² wherein r is the radius of the disc surface. Geometric surface area is calculated for the side of a disc by multiplying the disc circumference by the width of the side of the disc. When used as an electrolyte in an electrochemical cell, either the top or bottom surface is the surface of the bilayer which directly contacts the negative electrode (e.g., Li metal), the positive electrode (i.e., cathode or catholyte in the cathode), and/or a layer or adhesive bonding agent disposed between the bilayer and the positive electrode. A surface is defined by an area that has larger, or more extended, x- and y-axis physical dimensions than it does z-axis physical dimensions, wherein the z-axis dimension is perpendicular to the surface. The depth, roughness or thickness of a surface can be of a molecular order (0.1 nanometers to 10 nanometers) of magnitude or up to 1, 2, 3, 4, or 5 μm.

As used herein, the term “XPS” refers to X-ray photoelectron spectroscopy, a surface-sensitive quantitative spectroscopic technique that measures the elemental composition at the parts per thousand range. XPS is useful for determining the empirical formula of an analyzed species. XPS is useful for determining the chemical state and electronic state of the elements that exist within a material.

As used herein, the term “LLZO” refers to a lithium lanthanum zirconium oxide, which when crystallized into the garnet crystal form is referred to as lithium-stuffed garnet as defined above.

As used herein, the term “ESS” refers to a mixture of ethylene sulfite (ES) and sulfolane. Sulfolane refers to tetrahydrothiophene 1,1-dioxide, having the cyclic sulfone structure shown below:

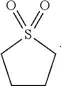

A ratio of ES:sulfolane is by volume (v/v) unless specified to the contrary.

### Processes for the Acid-Treatment of Lithium-Stuffed Garnet Electrolytes

In an aspect, set forth herein is a process for treating a bilayer, wherein the bilayer comprises a metal foil or metal powder layer, and a lithium-stuffed garnet layer, comprising: (a) providing a solution comprising an acid source at a concentration of about 10 ppm to 5500 ppm; (b) contacting the bilayer with the solution for about one hour or less; and (c) removing the bilayer from the solution to afford an acid-treated bilayer.

In some embodiments, the metal foil of the bilayer comprises pure nickel. In some embodiments, the metal foil of the bilayer comprises a nickel alloy. In some embodiments, the nickel alloy comprises nickel and iron. In some embodiments, the nickel alloy comprises an 85:15 ratio of nickel to iron.

In some embodiments, the bilayer is sintered. In some embodiments, the bilayer comprises a sintered lithium-stuffed garnet layer.

In some embodiments, including any of the foregoing, the acid source comprises an acid, and/or its conjugate base, and/or dissolved ions thereof, selected from the group consisting of:
(a) H₃PO₄ and/or H₂PO₄ and/or PO₄³⁻ and/or PO₄²⁻;
(b) H₂SO₄ and/or HSO₄⁻ and/or SO₄⁻ and/or SO₄⁻;
(c) HCl and/or Cl⁻;
(d) H₃BO₃ and/or B(OH)₄⁻ and/or BH₂O³⁻;
(e) H₂TiF₆ and/or TiF₆²⁻;
(f) H₂ZrF₆ and/or ZrF₆²⁻; and
(g) combinations thereof.

In one embodiment, including any of the foregoing, the acid source further comprises water.

In one embodiment, including any of the foregoing, the acid source comprises H₃PO₄ and/or H₂PO₄⁻ and/or PO₄³⁻ and/or PO₄²⁻. In one embodiment, including any of the foregoing, the acid source comprises H₃PO₄ and/or H₂PO₄⁻ and/or PO₄³⁻ and/or PO₄²⁻ in an aqueous solution. In one embodiment, including any of the foregoing, the acid source comprises H₃PO₄ and/or H₂PO₄⁻ and/or PO₄³⁻ and/or PO₄²⁻ in an aqueous solution wherein the concentration is about 85 wt %.

In one embodiment, including any of the foregoing, the acid source comprises H₂TiF₆ and/or TiF₆²⁻. In one embodiment, including any of the foregoing, the acid source comprises H₂TiF₆ and/or TiF₆²⁻ in an aqueous solution.

In one embodiment, including any of the foregoing, the acid source comprises HCl and/or Cl⁻. In one embodiment, including any of the foregoing, the acid source comprises HCl and/or Cl⁻ in an aqueous solution.

In one embodiment, including any of the foregoing, the acid source comprises H₂SO₄ and/or HSO₄⁻ and/or SO₄⁻ and/or SO₄⁻. In one embodiment, including any of the foregoing, the acid source comprises H₂SO₄ and/or HSO₄⁻ and/or SO₄⁻ and/or SO₄⁻ in an aqueous solution.

In one embodiment, including any of the foregoing, the acid source comprises H₃BO₃ and/or B(OH)₄⁻ and/or BH₂O³⁻. In one embodiment, including any of the foregoing, the acid source comprises H₃BO₃ and/or B(OH)₄⁻ and/or BH₂O³⁻ in an aqueous solution.

In one embodiment, including any of the foregoing, the acid source comprises H₂ZrF₆ and/or ZrF₆²⁻. In one embodiment, including any of the foregoing, the acid source comprises H₂ZrF₆ and/or ZrF₆²⁻ in an aqueous solution.

In one embodiment, including any of the foregoing, the concentration of the acid source in the solution is about 0.001% (w/v) to 0.1% (w/v). In one embodiment, including any of the foregoing, the concentration of the acid source in the solution is about 0.003% (w/v) to 0.03% (w/v). In one embodiment, including any of the foregoing, the concentration of the acid source in the solution is about 0.005% (w/v) to 0.05% (w/v). In one embodiment, including any of the foregoing, the concentration of the acid source in the solution is about 0.008% (w/v) to 0.08% (w/v).

In one embodiment, including any of the foregoing, the concentration of the acid source in the solution is about 0.001% (w/v), about 0.002% (w/v), about 0.003% (w/v), about 0.004% (w/v), about 0.005% (w/v), about 0.006% (w/v), about 0.007% (w/v), about 0.008% (w/v), about 0.009% (w/v), about 0.01% (w/v), about 0.02% (w/v), about 0.03% (w/v), about 0.04% (w/v), about 0.05% (w/v), about 0.06% (w/v), about 0.07% (w/v), about 0.08% (w/v), about 0.09% (w/v), or about 0.1% (w/v).

In one embodiment, including any of the foregoing, the concentration of the acid source in the solution is about 0.001% (w/v) to 0.0025% (w/v), about 0.002% (w/v) to 0.004% (w/v), about 0.003% (w/v) to 0.005% (w/v), about 0.004% (w/v) to 0.006% (w/v), or about 0.0045% (w/v) to 0.0065% (w/v).

In one embodiment, including any of the foregoing, the concentration of the acid source in the solution is about 0.03% (w/v) to 0.04% (w/v), about 0.035% (w/v) to 0.045% (w/v), about 0.04% (w/v) to 0.05% (w/v), about 0.045% (w/v) to 0.055% (w/v), or about 0.045% (w/v) to 0.06% (w/v).

In one embodiment, including any of the foregoing, the concentration of the acid source in the solution is about 0.001% (w/v). In one embodiment, including any of the foregoing, the concentration of the acid source in the solution is about 0.0025% (w/v). In one embodiment, including any of the foregoing, the concentration of the acid source in the solution is about 0.003% (w/v). In one embodiment, including any of the foregoing, the concentration of the acid source in the solution is about 0.005% (w/v). In one embodiment, including any of the foregoing, the concentration of the acid source in the solution is about 0.008% (w/v). In one embodiment, including any of the foregoing, the concentration of the acid source in the solution is about 0.025% (w/v). In one embodiment, including any of the foregoing, the concentration of the acid source in the solution is about 0.03% (w/v). In one embodiment, including any of the foregoing, the concentration of the acid source in the solution is about 0.05% (w/v). In one embodiment, including any of the foregoing, the concentration of the acid source in the solution is about 0.08% (w/v).

In some embodiments, the concentration of the acid sources in the solution is about 10 ppm to about 5500 ppm.

In one embodiment, including any of the foregoing, the concentration of the acid source in the solution is about 10 ppm to about 1000 ppm, about 100 ppm to about 800 ppm, about 250 ppm to about 750 ppm, or about 400 ppm to about 600 ppm.

In one embodiment, including any of the foregoing, the concentration of the acid source in the solution is about 10 ppm to 50 ppm, about 50 ppm to 100 ppm, about 100 ppm to 300 ppm, about 300 ppm to 500 ppm, about 500 ppm to 700 ppm, or about 700 ppm to 1000 ppm.

In one embodiment, including any of the foregoing, the concentration of the acid source in the solution is about 10 ppm to 25 ppm, about 20 ppm to 40 ppm, about 30 ppm to 50 ppm, about 40 ppm to 60 ppm, or about 45 ppm to 65 ppm. In one embodiment, including any of the foregoing, the concentration of the acid source in the solution is about 300 ppm to 400 ppm, about 350 ppm to 450 ppm, about 400 ppm to 500 ppm, about 450 ppm to 550 ppm, or about 450 ppm to 600 ppm. In one embodiment, including any of the foregoing, the concentration of the acid source in the solution is about 1000 ppm to 5500 ppm, about 2000 ppm to 5500 ppm, about 3000 ppm to 5500 ppm, or about 4000 ppm to 5500 ppm. In some embodiments, the concentration of the acid source in the solution is about 1000 ppm to 2000 ppm, about 1500 ppm to 2500 ppm, about 2000 ppm to 3000 ppm, about 2500 ppm to 3500 ppm, about 3000 ppm to 4000 ppm, about 3500 ppm to 4500 ppm, about 4000 to 5000 ppm, about 4500 ppm to 5500 ppm.

In one embodiment, including any of the foregoing, the concentration of the acid source in the solution is about 10 ppm. In one embodiment, including any of the foregoing, the concentration of the acid source in the solution is about 50 ppm. In one embodiment, including any of the foregoing, the concentration of the acid source in the solution is about 60 ppm. In one embodiment, including any of the foregoing, the concentration of the acid source in the solution is about 75 ppm. In one embodiment, including any of the foregoing, the concentration of the acid source in the solution is about 100 ppm. In one embodiment, including any of the foregoing, the concentration of the acid source in the solution is about 150 ppm. In one embodiment, including any of the foregoing, the concentration of the acid source in the solution is about 200 ppm. In one embodiment, including any of the foregoing, the concentration of the acid source in the solution is about 300 ppm. In one embodiment, including any of the foregoing, the concentration of the acid source in the solution is about 400 ppm. In one embodiment, including any of the foregoing, the concentration of the acid source in the solution is about 450 ppm. In one embodiment, including any of the foregoing, the concentration of the acid source in the solution is about 500 ppm. In one embodiment, including any of the foregoing, the concentration of the acid source in the solution is about 550 ppm. In one embodiment, including any of the foregoing, the concentration of the acid source in the solution is about 600 ppm. In one embodiment, including any of the foregoing, the concentration of the acid source in the solution is about 650 ppm. In one embodiment, including any of the foregoing, the concentration of the acid source in the solution is about 700 ppm. In one embodiment, including any of the foregoing, the concentration of the acid source in the solution is about 800 ppm. In one embodiment, including any of the foregoing, the concentration of the acid source in the solution is about 900 ppm.

In some embodiments, the concentration of the acid source in the solution is about 1000 ppm-5000 ppm.

In one embodiment, including any of the foregoing, the solution comprises an acid source wherein the acid source comprises a member selected from the group consisting of H₃PO₄, H₂TiF₆, HCl, H₂SO₄, H₃BO₃, H₂ZrF₆, and a combination thereof, and the concentration of the acid source in the acidic solution is about 0.001% (w/v), about 0.002% (w/v), about 0.003% (w/v), about 0.004% (w/v), about 0.005% (w/v), about 0.006% (w/v), about 0.007% (w/v), about 0.008% (w/v), about 0.009% (w/v), about 0.01% (w/v), about 0.02% (w/v), about 0.03% (w/v), about 0.04% (w/v), about 0.05% (w/v), about 0.06% (w/v), about 0.07% (w/v), about 0.08% (w/v), about 0.09% (w/v), or about 0.1% (w/v).

In one embodiment, including any of the foregoing, the solution comprises an acid source wherein the acid source comprises a member selected from the group consisting of H₃PO₄, H₂TiF₆, HCl, H₂SO₄, H₃BO₃, H₂ZrF₆, and a combination thereof, and the concentration of the acid source in the acidic solution is about 0.001% (w/v) to 0.0025% (w/v), about 0.002% (w/v) to 0.004% (w/v), about 0.003% (w/v) to 0.005% (w/v), about 0.004% (w/v) to 0.006% (w/v), or about 0.0045% (w/v) to 0.0065% (w/v). In one embodiment, including any of the foregoing, the solution comprises an acid source wherein the acid source comprises a member selected from the group consisting of H₃PO₄, H₂TiF₆, HCl, H₂SO₄, H₃BO₃, H₂ZrF₆, and a combination thereof, and the concentration of the acid source in the acidic solution is about 0.03% (w/v) to 0.04% (w/v), about 0.035% (w/v) to 0.045% (w/v), about 0.04% (w/v) to 0.05% (w/v), about 0.045% (w/v) to 0.055% (w/v), or about 0.045% (w/v) to 0.06% (w/v). In one embodiment, including any of the foregoing, the solution comprises an acid source wherein the acid source comprises a member selected from the group consisting of H₃PO₄, H₂TiF₆, HCl, H₂SO₄, H₃BO₃, H₂ZrF₆ and a combination thereof, and the concentration of the acid source in the acidic solution is about 10 ppm to 25 ppm, about 20 ppm to 40 ppm about 30 ppm to 50 ppm, about 40 ppm to 60 ppm, or about 45 ppm to 65 ppm. In one embodiment, including any of the foregoing, the solution comprises an acid source wherein the acid source comprises a member selected from the group consisting of H₃PO₄, H₂TiF₆, HCl, H₂SO₄, H₃BO₃, H₂ZrF₆ and a combination thereof, and the concentration of the acid source in the acidic solution is about 300 ppm to 400 ppm, about 350 ppm to 450 ppm, about 400 ppm to 500 ppm, about 450 ppm to 550 ppm, or about 450 ppm to 600 ppm. In one embodiment, including any of the foregoing, the solution comprises an acid source wherein the acid source comprises a member selected from the group consisting of H₃PO₄, H₂TiF₆, HCl, H₂SO₄, H₃BO₃, H₂ZrF₆ and a combination thereof, and the concentration of the acid source in the acidic solution is about 1000 ppm to 2000 ppm, about 1500 ppm to 2500 ppm, about 2000 ppm to 3000 ppm, about 2500 ppm to 3500 ppm, about 3000 ppm to 4000 ppm, about 3500 ppm to 4500 ppm, about 4000 to 5000 ppm, about 4500 ppm to 5500 ppm.

In one embodiment, including any of the foregoing, the acid source comprises H₃PO₄ and/or H₂PO₄⁻ and/or PO₄³⁻ and/or PO₄²⁻ and the concentration of the acid source in the solution is about 0.001% (w/v), about 0.002% (w/v), about 0.003% (w/v), about 0.004% (w/v), about 0.005% (w/v), about 0.006% (w/v), about 0.007% (w/v), about 0.008% (w/v), about 0.009% (w/v), about 0.01% (w/v), about 0.02% (w/v), about 0.03% (w/v), about 0.04% (w/v), about 0.05% (w/v), about 0.06% (w/v), about 0.07% (w/v), about 0.08% (w/v), about 0.09% (w/v), or about 0.1% (w/v). In one embodiment, including any of the foregoing, the acid source comprises H₃PO₄ and/or H₂PO₄⁻ and/or PO₄³⁻ and/or PO₄²⁻ and the concentration of the acid source in the solution is about 0.001% (w/v) to 0.0025% (w/v), about 0.002% (w/v) to 0.004% (w/v), about 0.003% (w/v) to 0.005% (w/v), about 0.004% (w/v) to 0.006% (w/v), or about 0.0045% (w/v) to 0.0065% (w/v). In one embodiment, including any of the foregoing, the acid source comprises H₃PO₄ and/or H₂PO₄⁻ and/or PO₄³⁻ and/or PO₄²⁻ and the concentration of the acid source in the solution is about 0.03% (w/v) to 0.04% (w/v), about 0.035% (w/v) to 0.045% (w/v), about 0.04% (w/v) to 0.05% (w/v), about 0.045% (w/v) to 0.055% (w/v), or about 0.045% (w/v) to 0.06% (w/v).

In one embodiment, including any of the foregoing, the acid source comprises H₃PO₄ and/or H₂PO₄⁻ and/or PO₄³⁻ and/or PO₄²⁻ and the concentration of the acid source in the solution is about 10 ppm to 25 ppm, about 20 ppm to 40 ppm, about 30 ppm to 50 ppm, about 40 ppm to 60 ppm, or about 45 ppm to 65 ppm. In one embodiment, including any of the foregoing, the acid source comprises H₃PO₄ and/or H₂PO₄⁻ and/or PO₄³⁻ and/or PO₄²⁻ and the concentration of the acid source in the solution is about 300 ppm to 400 ppm, about 350 ppm to 450 ppm, about 400 ppm to 500 ppm, about 450 ppm to 550 ppm, or about 450 ppm to 600 ppm. In one embodiment, including any of the foregoing, the acid source comprises H₃PO₄ and/or H₂PO₄ and/or PO₄³⁻ and/or PO₄²⁻ and the concentration of the acid source in the solution is about 1000 ppm to 5500 ppm, about 2000 ppm to 5500 ppm, about 3000 ppm to 5500 ppm, or about 4000 ppm to 5500 ppm. In one embodiment, including any of the foregoing, the acid source comprises H₃PO₄ and/or H₂PO₄ and/or PO₄³⁻ and/or PO₄²⁻ and the concentration of the acid source in the solution is about 1000 ppm to 2000 ppm, about 1500 ppm to 2500 ppm, about 2000 ppm to 3000 ppm, about 2500 ppm to 3500 ppm, about 3000 ppm to 4000 ppm, about 3500 ppm to 4500 ppm, about 4000 to 5000 ppm, about 4500 ppm to 5500 ppm.

In one embodiment, including any of the foregoing, the acid source comprises H₃PO₄ and/or H₂PO₄⁻ and/or PO₄³⁻ and/or PO₄²⁻ and the concentration of the acid source in the solution is about 50 ppm. In one embodiment, including any of the foregoing, the acid source comprises H₃PO₄ and/or H₂PO₄⁻ and/or PO₄³⁻ and/or PO₄²⁻ and the concentration of the acid source in the solution is about 500 ppm. In one embodiment, including any of the foregoing, the acid source comprises H₃PO₄ and/or H₂PO₄ and/or PO₄³⁻ and/or PO₄²⁻ and the concentration of the acid source in the solution is about 5000 ppm. In one embodiment, including any of the foregoing, the acid source comprises H₃PO₄ and/or H₂PO₄ and/or PO₄³⁻ and/or PO₄²⁻ and the concentration of the acid source in the solution is about 5500 ppm.

In one embodiment, including any of the foregoing, the acid source further comprises water. For example, in one embodiment, including any of the foregoing, the acid source comprises (1) H₃PO₄ and/or H₂PO₄⁻ and/or PO₄³⁻ and/or PO₄²⁻ and (2) water wherein the concentration of the acid source in the solution is about 10 ppm to 25 ppm, about 20 ppm to 40 ppm, about 30 ppm to 50 ppm, about 40 ppm to 60 ppm, or about 45 ppm to 65 ppm. In a further embodiment, including any of the foregoing, the acid source comprises (1) H₃PO₄ and/or H₂PO₄⁻ and/or PO₄³⁻ and/or PO₄²⁻ and (2) water wherein the concentration of the acid source in the solution is about 50 ppm.

In one embodiment, including any of the foregoing, the acid source comprises H₂TiF₆ and/or TiF₆²⁻ and the concentration of the acid source in the solution is about 0.001% (w/v) to 0.0025% (w/v), about 0.002% (w/v) to 0.004% (w/v), about 0.003% (w/v) to 0.005% (w/v), about 0.004% (w/v) to 0.006% (w/v), or about 0.0045% (w/v) to 0.0065% (w/v).

In one embodiment, including any of the foregoing, the acid source comprises H₂TiF₆ and/or TiF₆²⁻ and the concentration of the acid source in the solution is about 0.03% (w/v) to 0.04% (w/v), about 0.035% (w/v) to 0.045% (w/v), about 0.04% (w/v) to 0.05% (w/v), about 0.045% (w/v) to 0.055% (w/v), or about 0.045% (w/v) to 0.06% (w/v).

In one embodiment, including any of the foregoing, the acid source comprises H₂TiF₆ and/or TiF₆²⁻ and the concentration of the acid source in the solution is about 10 ppm to 25 ppm, about 20 ppm to 40 ppm, about 30 ppm to 50 ppm, about 40 ppm to 60 ppm, or about 45 ppm to 65 ppm.

In one embodiment, including any of the foregoing, the acid source comprises H₂TiF₆ and/or TiF₆²⁻ and the concentration of the acid source in the solution is about 300 ppm to 400 ppm, about 350 ppm to 450 ppm, about 400 ppm to 500 ppm, between about 450 ppm to 550 ppm, or about 450 ppm to 600 ppm. In one embodiment, including any of the foregoing, the acid source comprises H₂TiF₆ and/or TiF₆²⁻ and the concentration of the acid source in the solution is about 1000 ppm to 5500 ppm, about 2000 ppm to 5500 ppm, about 3000 ppm to 5500 ppm, or about 4000 ppm to 5500 ppm. In one embodiment, including any of the foregoing, the acid source comprises H₂TiF₆ and/or TiF₆²⁻ and the concentration of the acid source in the solution is about 1000 ppm to 2000 ppm, about 1500 ppm to 2500 ppm, about 2000 ppm to 3000 ppm, about 2500 ppm to 3500 ppm, about 3000 ppm to 4000 ppm, about 3500 ppm to 4500 ppm, about 4000 to 5000 ppm, about 4500 ppm to 5500 ppm.

In one embodiment, including any of the foregoing, the acid source comprises HCl and/or Cl⁻ and the concentration of the acid source in the solution is about 0.001% (w/v) to 0.0025% (w/v), about 0.002% (w/v) to 0.004% (w/v), about 0.003% (w/v) to 0.005% (w/v), about 0.004% (w/v) to 0.006% (w/v), or about 0.0045% (w/v) to 0.0065% (w/v).

In one embodiment, including any of the foregoing, the acid source comprises HCl and/or Cl⁻ and the concentration of the acid source in the solution is about 0.03% (w/v) to 0.04% (w/v), about 0.035% (w/v) to 0.045% (w/v), about 0.04% (w/v) to 0.05% (w/v), about 0.045% (w/v) to 0.055% (w/v), or about 0.045% (w/v) to 0.06% (w/v).

In one embodiment, including any of the foregoing, the acid source comprises HCl and/or Cl⁻ and the concentration of the acid source in the solution is about 10 ppm to 25 ppm, about 20 ppm to 40 ppm, about 30 ppm to 50 ppm, about 40 ppm to 60 ppm, or about 45 ppm to 65 ppm.

In one embodiment, including any of the foregoing, the acid source comprises HCl and/or Cl⁻ and the concentration of the acid source in the solution is about 300 ppm to 400 ppm, about 350 ppm to 450 ppm, about 400 ppm to 500 ppm, about 450 ppm to 550 ppm, or about 450 ppm to 600 ppm.

In one embodiment, including any of the foregoing, the acid source comprises HCl and/or Cl⁻ and the concentration of the acid source in the solution is about 1000 ppm to 5500 ppm, about 2000 ppm to 5500 ppm, about 3000 ppm to 5500 ppm, or about 4000 ppm to 5500 ppm.

In one embodiment, including any of the foregoing, the acid source comprises H₂SO₄ and/or HSO₄⁻ and/or SO₄⁻ and/or SO₄⁻ and the concentration of the acid source in the solution is about 0.001% (w/v) to 0.0025% (w/v), about 0.002% (w/v) to 0.004% (w/v), about 0.003% (w/v) to 0.005% (w/v), about 0.004% (w/v) to 0.006% (w/v), or about 0.0045% (w/v) to 0.0065% (w/v). In one embodiment, including any of the foregoing, the acid source comprises H₂SO₄ and/or HSO₄⁻ and/or SO₄⁻ and/or SO₄⁻ and the concentration of the acid source in the solution is about 0.03% (w/v) to 0.04% (w/v), about 0.035% (w/v) to 0.045% (w/v), about 0.04% (w/v) to 0.05% (w/v), about 0.045% (w/v) to 0.055% (w/v), or about 0.045% (w/v) to 0.06% (w/v).

In one embodiment, including any of the foregoing, the acid source comprises H₂SO₄ and/or HSO₄⁻ and/or SO₄⁻ and/or SO₄⁻ and the concentration of the acid source in the solution is about 10 ppm to 25 ppm, about 20 ppm to 40 ppm, about 30 ppm to 50 ppm, about 40 ppm to 60 ppm, or about 45 ppm to 65 ppm. In one embodiment, including any of the foregoing, the acid source comprises H₂SO₄ and/or HSO₄⁻ and/or SO₄⁻ and/or SO₄⁻ and the concentration of acid source in the solution is about 300 ppm to 400 ppm, about 350 ppm to 450 ppm, about 400 ppm to 500 ppm, about 450 ppm to 550 ppm, or about 450 ppm to 600 ppm. In one embodiment, including any of the foregoing, the acid source comprises H₂SO₄ and/or HSO₄⁻ and/or SO₄⁻ and/or SO₄⁻ and the concentration of the acid source in the solution is about 1000 ppm to 5500 ppm, about 2000 ppm to 5500 ppm, about 3000 ppm to 5500 ppm, or about 4000 ppm to 5500 ppm. In one embodiment, including any of the foregoing, the acid source comprises H₃BO₃ and/or B(OH)₄⁻ and/or BH₂O³⁻ and the concentration of acid source in the solution is about 0.001% (w/v) to 0.0025% (w/v), about 0.002% (w/v) to 0.004% (w/v), about 0.003% (w/v) to 0.005% (w/v), about 0.004% (w/v) to 0.006% (w/v), or about 0.0045% (w/v) to 0.0065% (w/v). In one embodiment, including any of the foregoing, the acid source comprises H₃BO₃ and/or B(OH)₄⁻ and/or BH₂O³⁻ and the concentration of the acid source in the solution is about 0.03% (w/v) to 0.04% (w/v), about 0.035% (w/v) to 0.045% (w/v), about 0.04% (w/v) to 0.05% (w/v), about 0.045% (w/v) to 0.055% (w/v), or about 0.045% (w/v) to 0.06% (w/v).

In one embodiment, including any of the foregoing, the acid source comprises H₃BO₃ and/or B(OH)₄⁻ and/or BH₂O³⁻ and the concentration of the acid source in the solution is about 10 ppm to 25 ppm, about 20 ppm to 40 ppm, about 30 ppm to 50 ppm, about 40 ppm to 60 ppm, or about 45 ppm to 65 ppm. In one embodiment, including any of the foregoing, the acid source comprises H₃BO₃ and/or B(OH)₄⁻ and/or BH₂O³⁻ and the concentration of the acid source in the solution is about 1000 ppm to 2000 ppm, about 1500 ppm to 2500 ppm, about 2000 ppm to 3000 ppm, about 2500 ppm to 3500 ppm, about 3000 ppm to 4000 ppm, about 3500 ppm to 4500 ppm, about 4000 to 5000 ppm, about 4500 ppm to 5500 ppm.

In one embodiment, including any of the foregoing, the acid source comprises H₂ZrF₆ and/or ZrF₆²⁻ and the concentration of the acid source in the solution is about 0.001% (w/v) to 0.0025% (w/v), about 0.002% (w/v) to 0.004% (w/v), about 0.003% (w/v) to 0.005% (w/v), about 0.004% (w/v) to 0.006% (w/v), or about 0.0045% (w/v) to 0.0065% (w/v).

In one embodiment, including any of the foregoing, the acid source comprises H₂ZrF₆ and/or ZrF₆²⁻ and the concentration of the acid source in the solution is about 0.03% (w/v) to 0.04% (w/v), about 0.035% (w/v) to 0.045% (w/v), about 0.04% (w/v) to 0.05% (w/v), about 0.045% (w/v) to 0.055% (w/v), or about 0.045% (w/v) to 0.06% (w/v).

In one embodiment, including any of the foregoing, the acid source comprises H₂ZrF₆ and/or ZrF₆²⁻ and the concentration of the acid source in the solution is about 10 ppm to 25 ppm, about 20 ppm to 40 ppm, about 30 ppm to 50 ppm, about 40 ppm to 60 ppm, or about 45 ppm to 65 ppm.

In one embodiment, including any of the foregoing, the acid source comprises H₂ZrF₆ and/or ZrF₆²⁻ and the concentration of the acid source in the solution is about 300 ppm to 400 ppm, about 350 ppm to 450 ppm, about 400 ppm to 500 ppm, about 450 ppm to 550 ppm, or about 450 ppm to 600 ppm.

In one embodiment, including any of the foregoing, the acid source further comprises water.

In some embodiments, including any of the foregoing, the solution comprises a solvent. In one embodiment, the solvent is selected from the group consisting of ethylene sulfite (ES), ethylene carbonate (EC), diethylene carbonate, dimethyl carbonate (DMC), ethyl-methyl carbonate (EMC), propylmethyl carbonate, nitroethyl carbonate, propylene carbonate (PC), diethyl carbonate (DEC), methyl propyl carbonate (MPC), 2,5-dioxahexanedioic acid dimethyl ester, tetrahydrofuran (THF), γ-butyrolactone (GBL), fluoroethylene carbonate (FEC), fluoromethyl ethylene carbonate (FMEC), trifluoroethyl methyl carbonate (F-EMC), fluorinated 3-(1,1,2,2-tetrafluoroethoxy)-1,1,2,2-tetrafluoropropane/1,1,2,2-tetrafluoro-3-(1,1,2,2-tetrafluoroethoxy)propane (F-EPE), fluorinated cyclic carbonate (F-AEC), dioxolane, prop-1-ene-1,3-sultone (PES), sulfolane, acetonitrile (ACN), succinonitrile (SCN), pimelonitrile, suberonitrile, propionitrile, propanedinitrile, glutaronitrile (GLN), adiponitrile (ADN), hexanedinitrile, pentanedinitrile, acetophenone, isophorone, benzonitrile, ethyl propionate, methyl propionate, methylene methanedisulfonate, dimethyl sulfate, dimethyl sulfoxide (DMSO), ethyl acetate, methyl butyrate, dimethyl ether (DME), diethyl ether, dioxolane, gamma butyl-lactone, methyl benzoate, 2-methyl-5-oxooxolane-2-carbonitrile, N,N-Dimethylformamide (DMF), N,N-Dimethylacetamide (DMAC) and combinations thereof. In some examples, the combinations of solvents are those combinations which are miscible.

In some embodiments, including any of the foregoing, the acidic solution comprises a solution described in PCT Application WO 2023/121838 filed Nov. 30, 2022, titled CATHOLYTES FOR A SOLID-STATE BATTERY, the entire contents of which are herein incorporated by reference in its entirety.

In some embodiments, including any of the foregoing, the solution comprises ethylene sulfite (ES). In some embodiments, including any of the foregoing, the solution comprises sulfolane.

In some embodiments, including any of the foregoing, the solution comprises a solvent selected from the group consisting of ethylene carbonate (EC), diethylene carbonate, dimethyl carbonate (DMC), ethyl-methyl carbonate (EMC), propylmethyl carbonate, nitroethyl carbonate, propylene carbonate (PC), diethyl carbonate (DEC), methyl propyl carbonate (MPC), 2,5-dioxahexanedioic acid dimethyl ester, tetrahydrofuran (THF), 7-butyrolactone (GBL), fluoroethylene carbonate (FEC), fluoromethyl ethylene carbonate (FMEC), trifluoroethyl methyl carbonate (F-EMC), fluorinated 3-(1,1,2,2-tetrafluoroethoxy)-1,1,2,2-tetrafluoropropane/1,1,2,2-tetrafluoro-3-(1,1,2,2-tetrafluoroethoxy)propane (F-EPE), and fluorinated cyclic carbonate (F-AEC).

In some embodiments, including any of the foregoing, the solution comprises a solvent selected from the group consisting of dioxolane, prop-1-ene-1,3-sultone (PES), sulfolane, acetonitrile (ACN), succinonitrile (SCN), pimelonitrile, suberonitrile, propionitrile, propanedinitrile, glutaronitrile (GLN), adiponitrile (ADN), hexanedinitrile, pentanedinitrile, acetophenone, isophorone, benzonitrile, ethyl propionate, methyl propionate, and methylene methanedisulfonate.

In some embodiments, including any of the foregoing, the solution comprises a solvent selected from the group consisting of dimethyl sulfate, dimethyl sulfoxide (DMSO), ethyl acetate, methyl butyrate, dimethyl ether (DME), diethyl ether, dioxolane, gamma butyl-lactone, methyl benzoate, and 2-methyl-5-oxooxolane-2-carbonitrile.

In some embodiments, including any of the foregoing, the solution comprises ethylene sulfite (ES) and sulfolane. In some embodiments, including any of the foregoing, the ethylene sulfite (ES) to sulfolane is about 7:3 by volume (v/v) to about 5:5 by volume (v/v). In some embodiments, including any of the foregoing, the ethylene sulfite (ES) to sulfolane is about 9:3 by volume, about 8:3 by volume, about 7:3 by volume, about 6:3 by volume, or about 5:3 by volume. In some embodiments, including any of the foregoing, the ethylene sulfite (ES) to sulfolane is about 7:3 by volume. In some embodiments, including any of the foregoing, the ethylene sulfite (ES) to sulfolane is about 7:3 by volume. In some embodiments, including any of the foregoing, the ethylene sulfite (ES) to sulfolane is about 5:5 by volume.

In some embodiments, including any of the foregoing, the solution further comprises a lithium salt. In some embodiments, including any of the foregoing, the concentration of the lithium salt is about 0.5 molar (M) to 5 (M). In some embodiments, including any of the foregoing, the solution comprises ethylene sulfite (ES) and sulfolane and a lithium salt wherein the concentration of the lithium salt is about 0.5 molar (M) to 5 (M). In some embodiments, including any of the foregoing, the lithium salt is selected from the group consisting of LiPF₆, lithium bis(oxalato)borate (LiBOB), lithium bis(perfluoroethanesulfonyl)imide (LIBETI), bis(trifluoromethane)sulfonimide (LiTFSI), LiBF₄, LiClO₄, LiAsF₆, lithium bis(fluorosulfonyl)imide (LiFSI), LiF, LiI, LiBr, LiCl, and combinations thereof. In some embodiments, including any of the foregoing, the lithium salt is selected from LiPF₆ or LiBF₄. In some embodiments, including any of the foregoing, the lithium salt is LiBF₄. In some embodiments, including any of the foregoing, the lithium salt is selected from 1.4M LiPF₆; 1.4M LiBF₄; and 1.6M LiBF₄. In some embodiments, including any of the foregoing, the lithium salt is selected from 1.4M LiBF₄ and 1.6M LiBF₄.

In one embodiment, including any of the foregoing, the solution comprises (1) an acid source wherein the acid source comprises an acid selected from H₃PO₄, H₂TiF₆, HCl, H₂SO₄, H₃BO₃, and H₂ZrF₆; and (2) a solvent wherein the solvent comprises ethylene sulfite (ES).

In one embodiment, including any of the foregoing, the solution comprises (1) an acid source wherein the acid source comprises an acid selected from H₃PO₄, H₂TiF₆, HCl, H₂SO₄, H₃BO₃, and H₂ZrF₆; and (2) a solvent wherein the solvent comprises ethylene sulfite (ES) and sulfolane.

In one embodiment, including any of the foregoing, the solution comprises (1) an acid source wherein the acid source comprises an acid selected from H₃PO₄, H₂TiF₆, HCl, H₂SO₄, H₃BO₃, and H₂ZrF₆; and (2) a solvent wherein the solvent comprises ethylene sulfite (ES) and sulfolane; and, the concentration of the acid source is about 0.001% (w/v), about 0.002% (w/v), about 0.003% (w/v), about 0.004% (w/v), about 0.005% (w/v), about 0.006% (w/v), about 0.007% (w/v), about 0.008% (w/v), about 0.009% (w/v), about 0.01% (w/v), about 0.02% (w/v), about 0.03% (w/v), about 0.04% (w/v), about 0.05% (w/v), about 0.06% (w/v), about 0.07% (w/v), about 0.08% (w/v), about 0.09% (w/v), or about 0.1% (w/v).

In one embodiment, including any of the foregoing, the solution comprises (1) an acid source wherein the acid source comprises H₃PO₄ and water and (2) a solvent wherein the solvent comprises ethylene sulfite (ES).

In one embodiment, including any of the foregoing, the solution comprises (1) an acid source wherein the acid source comprises H₃PO₄ and water and (2) a solvent wherein the solvent comprises ethylene sulfite (ES) and sulfolane.

In one embodiment, including any of the foregoing, the solution comprises (1) an acid source wherein the acid source comprises H₃PO₄ and (2) a solvent wherein the solvent comprises ethylene sulfite (ES) and sulfolane; and, the concentration of the acid source is about 0.001% (w/v), about 0.002% (w/v), about 0.003% (w/v), about 0.004% (w/v), about 0.005% (w/v), about 0.006% (w/v), about 0.007% (w/v), about 0.008% (w/v), about 0.009% (w/v), about 0.01% (w/v), about 0.02% (w/v), about 0.03% (w/v), about 0.04% (w/v), about 0.05% (w/v), about 0.06% (w/v), about 0.07% (w/v), about 0.08% (w/v), about 0.09% (w/v), or about 0.1% (w/v).

In one embodiment, including any of the foregoing, the solution comprises (1) an acid source wherein the acid source comprises H₃PO₄ and (2) a solvent wherein the solvent comprises ethylene sulfite (ES) and sulfolane; and the concentration of the acid source in the acidic solution is about 0.001% (w/v) to 0.0025% (w/v), about 0.002% (w/v) to 0.004% (w/v), about 0.003% (w/v) to 0.005% (w/v), about 0.004% (w/v) to 0.006% (w/v), or about 0.0045% (w/v) and 0.0065% (w/v).

In one embodiment, including any of the foregoing, the solution comprises (1) an acid source wherein the acid source comprises H₃PO₄ and (2) a solvent wherein the solvent comprises ethylene sulfite (ES) and sulfolane; and the concentration of the acid source in the acidic solution is about 0.03% (w/v) to 0.04% (w/v), about 0.035% (w/v) to 0.045% (w/v), about 0.04% (w/v) to 0.05% (w/v), about 0.045% (w/v) to 0.055% (w/v), or about 0.045% (w/v) to 0.06% (w/v).

In one embodiment, including any of the foregoing, the solution comprises (1) an acid source wherein the acid source comprises H₃PO₄ and (2) a solvent wherein the solvent comprises ethylene sulfite (ES) and sulfolane; and the concentration of the acid source in the acidic solution is about 10 ppm to 25 ppm, about 20 ppm to 40 ppm, about 30 ppm to 50 ppm, about 40 ppm to 60 ppm, or about 45 ppm to 65 ppm.

In one embodiment, including any of the foregoing, the solution comprises (1) an acid source wherein the acid source comprises H₃PO₄ and (2) a solvent wherein the solvent comprises ethylene sulfite (ES) and sulfolane; and the concentration of the acid source in the acidic solution is about 300 ppm to 400 ppm, about 350 ppm to 450 ppm, about 400 ppm to 500 ppm, about 450 ppm to 550 ppm, or about 450 ppm to 600 ppm.

In one embodiment, including any of the foregoing, the solution comprises (1) an acid source wherein the acid source comprises H₃PO₄ and (2) a solvent wherein the solvent comprises ethylene sulfite (ES) and sulfolane; and the concentration of the acid source in the acidic solution is about 50 ppm.

In one embodiment, including any of the foregoing, the solution comprises (1) an acid source wherein the acid source comprises H₃PO₄ and (2) a solvent wherein the solvent comprises ethylene sulfite (ES) and sulfolane; and the concentration of the acid source in the acidic solution is about 500 ppm.

In one embodiment, including any of the foregoing, the solution comprises (1) an acid source wherein the acid source comprises H₃PO₄ and (2) a solvent wherein the solvent comprises ethylene sulfite (ES); and the concentration of the acid source in the acidic solution is about 10 ppm to 25 ppm, about 20 ppm to 40 ppm, about 30 ppm to 50 ppm, about 40 ppm to 60 ppm, or about 45 ppm to 65 ppm. In one embodiment, including any of the foregoing, the solution comprises (1) an acid source wherein the acid source comprises H₃PO₄ and (2) a solvent wherein the solvent comprises ethylene sulfite (ES); and the concentration of the acid source in the acidic solution is about 300 ppm to 400 ppm, about 350 ppm to 450 ppm, about 400 ppm to 500 ppm, about 450 ppm to 550 ppm, or about 450 ppm to 600 ppm. In one embodiment, including any of the foregoing, the solution comprises (1) an acid source wherein the acid source comprises H₃PO₄ and (2) a solvent wherein the solvent comprises ethylene sulfite (ES); and the concentration of the acid source in the acidic solution is about 50 ppm. In one embodiment, including any of the foregoing, the solution comprises (1) an acid source wherein the acid source comprises H₃PO₄ and (2) a solvent wherein the solvent comprises ethylene sulfite (ES); and the concentration of the acid source in the acidic solution is about 500 ppm. In one embodiment, including any of the foregoing, the solution comprises (1) an acid source wherein the acid source comprises H₃PO₄ and (2) a solvent wherein the solvent comprises ethylene sulfite (ES); and the concentration of the acid source in the acidic solution is about 1000 ppm to 5500 ppm, about 2000 ppm to 5500 ppm, about 3000 ppm to 5500 ppm, or about 4000 ppm to 5500 ppm. In one embodiment, including any of the foregoing, the solution comprises (1) an acid source wherein the acid source comprises H₃PO₄ and (2) a solvent wherein the solvent comprises ethylene sulfite (ES); and the concentration of the acid source in the acidic solution is about 1000 ppm to 2000 ppm, about 1500 ppm to 2500 ppm, about 2000 ppm to 3000 ppm, about 2500 ppm to 3500 ppm, about 3000 ppm to 4000 ppm, about 3500 ppm to 4500 ppm, about 4000 to 5000 ppm, about 4500 ppm to 5500 ppm. In one embodiment, including any of the foregoing, the solution comprises (1) an acid source wherein the acid source comprises H₃PO₄ and (2) a solvent wherein the solvent comprises ethylene sulfite (ES); and the concentration of the acid source in the acidic solution is about 5000 ppm. In one embodiment, including any of the foregoing, the solution comprises (1) an acid source wherein the acid source comprises H₃PO₄ and (2) a solvent wherein the solvent comprises ethylene sulfite (ES); and the concentration of the acid source in the acidic solution is about 5500 ppm.

In one embodiment, including any of the foregoing, the acid source further comprises water. For example, in one embodiment, including any of the foregoing, the solution comprises (1) an acid source wherein the acid source comprises H₃PO₄ and water; and (2) a solvent wherein the solvent comprises ethylene sulfite (ES) and sulfolane; and the concentration of the acid source in the acidic solution is about 10 ppm to 25 ppm, about 20 ppm to 40 ppm, about 30 ppm to 50 ppm, about 40 ppm to 60 ppm, or about 45 ppm to 65 ppm. In one embodiment, including any of the foregoing, the solution comprises (1) an acid source wherein the acid source comprises H₃PO₄ and water; and (2) a solvent wherein the solvent comprises ethylene sulfite (ES) and sulfolane; and the concentration of the acid source in the acidic solution is about 50 ppm.

In one embodiment, including any of the foregoing, the acid source further comprises water. For example, in one embodiment, including any of the foregoing, the solution comprises (1) an acid source wherein the acid source comprises H₃PO₄ and water; and (2) a solvent wherein the solvent comprises ethylene sulfite (ES); and the concentration of the acid source in the acidic solution is about 10 ppm to 25 ppm, about 20 ppm to 40 ppm, about 30 ppm to 50 ppm, about 40 ppm to 60 ppm, or about 45 ppm to 65 ppm. In one embodiment, including any of the foregoing, the solution comprises (1) an acid source wherein the acid source comprises H₃PO₄ and water; and (2) a solvent wherein the solvent comprises ethylene sulfite (ES); and the concentration of the acid source in the acidic solution is about 50 ppm.

In some embodiments, the bilayer contacts the solution, the bilayer is immersed in the solution, the bilayer is immersed in the solution as the solution is being recirculated, the bilayer is immersed in the solution as the solution is being sonicated, the bilayer is immersed in the solution as the solution is being bubbled with gas, the bilayer is sprayed with the solution, the solution is dispensed as a constant stream unto the bilayer, or combinations thereof. In one embodiment, the bilayer contacts the solution. In one embodiment, the bilayer is immersed in the solution. In one embodiment, the bilayer is immersed in the solution as the solution is being recirculated. In one embodiment, the bilayer is immersed in the solution as the solution is being sonicated. In one embodiment, the bilayer is immersed in the solution as the solution is being bubbled with gas. In one embodiment, the bilayer is sprayed with the solution. In one embodiment, solution is dispensed as a constant stream unto the bilayer.

In some embodiments, the bilayer, contacts the solution for at least about 1 second, at least about 10 seconds, at least about 30 seconds, at least about 1 minute, at least about 2 minutes, at least about 3 minutes, at least about 4 minutes, at least about 5 minutes, at least about 10 minutes, at least about 15 minutes, at least about 20 minutes, at least about 25 minutes, at least about 30 minutes, at least about 35 minutes, at least about 40 minutes, at least about 45 minutes, at least about 50 minutes, at least about 55 minutes, or at least about 60 minutes.

In some embodiments, the bilayer contacts the solution for no more than about 2 hours, no more than about 1 hour and 45 minutes, no more than about 1 hour and 30 minutes, no more than about 1 hour and 15 minutes, no more than about 1 hour, no more than about 45 minutes, no more than about 30 minutes, no more than about 15 minutes, no more than about 10 minutes, no more than about 5 minutes, no more than about 4 minutes, no more than about 3 minutes, no more than about 2 minutes, or no more than about 1 minute.

In some embodiments, the bilayer is immersed in the solution for at least about 1 second, at least about 10 seconds, at least about 30 seconds, at least about 1 minute, at least about 2 minutes, at least about 3 minutes, at least about 4 minutes, at least about 5 minutes, at least about 10 minutes, at least about 15 minutes, at least about 20 minutes, at least about 25 minutes, at least about 30 minutes, at least about 35 minutes, at least about 40 minutes, at least about 45 minutes, at least about 50 minutes, at least about 55 minutes, or at least about 60 minutes.

In some embodiments, the bilayer is immersed in the solution for no more than about 2 hours, no more than about 1 hour and 45 minutes, no more than about 1 hour and 30 minutes, no more than about 1 hour and 15 minutes, no more than about 1 hour, no more than about 45 minutes, no more than about 30 minutes, no more than about 15 minutes, no more than about 10 minutes, no more than about 5 minutes, no more than about 4 minutes, no more than about 3 minutes, no more than about 2 minutes, or no more than about 1 minute.

In one embodiment, the bilayer is contacted with the solution at a temperature about 18° C. to 65° C., about 40° C. to 60° C., about 50° C. to 60° C., about 20° C. to 40° C., about 30° C. to 40° C., about 20° C. to 30° C., or about 20° C. to 25° C. In one embodiment, the bilayer is contacted with the solution at a temperature about 20° C. to 22° C.

In one embodiment, the bilayer is immersed in the solution at a temperature about 18° C. to 65° C., about 40° C. to 60° C., about 50° C. to 60° C., about 20° C. to 40° C., about 30° C. to 40° C., about 20° C. to 30° C., or about 20° C. to 25° C. In one embodiment, the bilayer is immersed in the solution at a temperature about 20° C. to 22° C.

In one embodiment, the bilayer is immersed in the solution as the solution is being recirculated at a temperature about 18° C. to 65° C., about 40° C. to 60° C., about 50° C. to 60° C., about 20° C. to 40° C., about 30° C. to 40° C., about 20° C. to 30° C., or about 20° C. to 25° C. In one embodiment, the bilayer is immersed in the solution as the solution is being recirculated at a temperature about 20° C. to 22° C.

In one embodiment, the bilayer is immersed in the solution as the solution is being sonicated at a temperature about 18° C. to 65° C., about 40° C. to 60° C., about 50° C. to 60° C., about 20° C. to 40° C., about 30° C. to 40° C., about 20° C. to 30° C., or about 20° C. to 25° C. In one embodiment, the bilayer is immersed in the solution as the solution is being sonicated at a temperature about 20° C. to 22° C.

In one embodiment, the bilayer is immersed in the solution as the solution is being bubbled with gas at a temperature about 18° C. to 65° C., about 40° C. to 60° C., about 50° C. to 60° C., about 20° C. to 40° C., about 30° C. to 40° C., about 20° C. to 30° C., or about 20° C. to 25° C. In one embodiment, the bilayer is immersed in the solution as the solution is being bubbled with gas at a temperature about 20° C. to 22° C.

In some embodiments, the bilayers are cut prior to being contacted with the solution. In some embodiments, the bilayers are cut after being contacted the solution.

In some embodiments, the bilayers are annealed prior to being contacted with the solution. Example annealing processes are described in U.S. Pat. No. 9,966,630 B2, which issued May 8, 2018, and is titled ANNEALED GARNET ELECTROLYTE S, the entire contents of which are herein incorporated by reference in its entirety for all purposes. In some embodiments, the films are annealed by beating it after it is in a reducing atmosphere and at elevated temperatures. In some embodiments, the heating is 500° C. to 800° C. and the reducing atmosphere is Ar:H₂ or Ar or an inert atmosphere. In some embodiments, the bilayers are heated for 30 mins to 2 hours at elevated temperatures during the annealing process.

In some embodiments, including any of the foregoing, the process further includes (d) that comprises contacting the acid-treated bilayer with a first rinse solution for about 1 second to 5 minutes and removing the acid-treated bilayer from the first rinse solution to afford a rinsed acid-treated bilayer. In some embodiments, (d) is performed for about 1 second to 1 min. In some embodiments, (d) is performed for about 1 second, about 3 seconds, about 5 seconds, about 10 seconds, about 15 seconds, about 20 seconds, 30 seconds, about 1 minute, about 2 minutes, about 3 minutes, about 4 minutes, or about 5 minutes.

In some embodiments, including any of the foregoing, the rinse solution of (d) comprises a solution described in PCT Application WO 2023/121838 filed Nov. 30, 2022, titled CATHOLYTES FOR A SOLID-STATE BATTERY.

In some embodiments, including any of the foregoing, the rinse solution of (d) comprises a solvent selected from the group consisting of ethylene sulfite (ES), ethylene carbonate (EC), diethylene carbonate, dimethyl carbonate (DMC), ethyl-methyl carbonate (EMC), propylmethyl carbonate, nitroethyl carbonate, propylene carbonate (PC), diethyl carbonate (DEC), methyl propyl carbonate (MPC), 2,5-dioxahexanedioic acid dimethyl ester, tetrahydrofuran (THF), γ-butyrolactone (GBL), fluoroethylene carbonate (FEC), fluoromethyl ethylene carbonate (FMEC), trifluoroethyl methyl carbonate (F-EMC), fluorinated 3-(1,1,2,2-tetrafluoroethoxy)-1,1,2,2-tetrafluoropropane/1,1,2,2-tetrafluoro-3-(1,1,2,2-tetrafluoroethoxy)propane (F-EPE), fluorinated cyclic carbonate (F-AEC), dioxolane, prop-1-ene-1,3-sultone (PES), sulfolane, acetonitrile (ACN), succinonitrile (SCN), pimelonitrile, suberonitrile, propionitrile, propanedinitrile, glutaronitrile (GLN), adiponitrile (ADN), hexanedinitrile, pentanedinitrile, acetophenone, isophorone, benzonitrile, ethyl propionate, methyl propionate, methylene methanedisulfonate, dimethyl sulfate, dimethyl sulfoxide (DMSO), ethyl acetate, methyl butyrate, dimethyl ether (DME), diethyl ether, dioxolane, gamma butyl-lactone, methyl benzoate, 2-methyl-5-oxooxolane-2-carbonitrile, N,N-Dimethylformamide (DMF), N,N-Dimethylacetamide (DMAC) and combinations thereof.

In some embodiments, including any of the foregoing, the rinse solution of (d) comprises ethylene sulfite (ES).

In some embodiments, the process further includes (e) that comprises contacting the acid-treated bilayer with a second rinse solution for about 1 second to 5 minutes and removing the acid-treated bilayer from the second rinse solution to afford a rinsed acid-treated bilayer. In some embodiments, (e) is performed for about 1 second to 1 min. In some embodiments, (e) is performed for about 1 second, about 3 seconds, about 5 seconds, about 10 seconds, about 15 seconds, about 20 seconds, 30 seconds, about 1 minute, about 2 minutes, about 3 minutes, about 4 minutes, or about 5 minutes.

In some embodiments, including any of the foregoing, the rinse solution of (e) comprises a solvent selected from the group consisting of ethylene sulfite (ES), ethylene carbonate (EC), diethylene carbonate, dimethyl carbonate (DMC), ethyl-methyl carbonate (EMC), propylmethyl carbonate, nitroethyl carbonate, propylene carbonate (PC), diethyl carbonate (DEC), methyl propyl carbonate (MPC), 2,5-dioxahexanedioic acid dimethyl ester, tetrahydrofuran (THF), 7-butyrolactone (GBL), fluoroethylene carbonate (FEC), fluoromethyl ethylene carbonate (FMEC), trifluoroethyl methyl carbonate (F-EMC), fluorinated 3-(1,1,2,2-tetrafluoroethoxy)-1,1,2,2-tetrafluoropropane/1,1,2,2-tetrafluoro-3-(1,1,2,2-tetrafluoroethoxy)propane (F-EPE), fluorinated cyclic carbonate (F-AEC), dioxolane, prop-1-ene-1,3-sultone (PES), sulfolane, acetonitrile (ACN), succinonitrile (SCN), pimelonitrile, suberonitrile, propionitrile, propanedinitrile, glutaronitrile (GLN), adiponitrile (ADN), hexanedinitrile, pentanedinitrile, acetophenone, isophorone, benzonitrile, ethyl propionate, methyl propionate, methylene methanedisulfonate, dimethyl sulfate, dimethyl sulfoxide (DMSO), ethyl acetate, methyl butyrate, dimethyl ether (DME), diethyl ether, dioxolane, gamma butyl-lactone, methyl benzoate, 2-methyl-5-oxooxolane-2-carbonitrile, N,N-Dimethylformamide (DMF), N,N-Dimethylacetamide (DMAC) and combinations thereof.

In some embodiments, including any of the foregoing, the rinse solution of (e) comprises acetonitrile (ACN).

In other embodiments, including any of the foregoing, the process further comprises (f) that comprises drying the rinsed acid-treated bilayer. In some embodiments, the process for treating a bilayer comprises the following: (a) providing a solution comprising an acid source wherein the acid source comprises an acid selected from H₃PO₄, H₂TiF₆, HCl, H₂SO₄, H₃BO₃, H₂ZrF₆, and a combination thereof at a concentration of 10 ppm to 5500 ppm in a solvent wherein the solvent comprises ethylene sulfite; (b) contacting the bilayer with the solution for about one hour or less; (c) removing the bilayer from the solution to afford an acid-treated bilayer; (d) contacting the acid-treated bilayer with a first rinse solution comprising ethylene sulfite for about 1 second to 5 minutes and removing the acid-treated bilayer from the first rinse solution; and (e) contacting the acid-treated bilayer with a second rinse solution comprising acetonitrile for about 1 second to 5 minutes and removing the acid-treated bilayer from the second rinse solution to afford a rinsed acid-treated bilayer.

In some embodiments, the process for treating a bilayer comprises the following: (a) providing a solution comprising an acid source wherein the acid source comprises H₃PO₄ and/or H₂PO₄ and/or PO₄³⁻ and/or PO₄²⁻ at a concentration of 10 ppm to 5500 ppm in a solvent wherein the solvent comprises ethylene sulfite; (b) contacting the bilayer with the solution for about one hour or less; (c) removing the bilayer from the solution to afford an acid-treated bilayer; (d) contacting the acid-treated bilayer with a first rinse solution comprising ethylene sulfite for about 1 second to 5 minutes and removing the acid-treated bilayer from the first rinse solution; and (e) contacting the acid-treated bilayer with a second rinse solution comprising acetonitrile for about 1 second to 5 minutes and removing the acid-treated bilayer from the second rinse solution to afford a rinsed acid-treated bilayer.

In some embodiments, the process for treating a bilayer comprises the following: (a) providing a solution comprising an acid source wherein the acid source comprises H₂SO₄ and/or HSO₄⁻ and/or SO₄⁻ and/or SO₄⁻ at a concentration of 10 ppm to 5500 ppm in a solvent wherein the solvent comprises ethylene sulfite; (b) contacting the bilayer with the solution for about one hour or less; (c) removing the bilayer from the solution to afford an acid-treated bilayer; (d) contacting the acid-treated bilayer with a first rinse solution comprising ethylene sulfite for about 1 second to 5 minutes and removing the acid-treated bilayer from the first rinse solution; and (e) contacting the acid-treated bilayer with a second rinse solution comprising acetonitrile for about 1 second to 5 minutes and removing the acid-treated bilayer from the second rinse solution to afford a rinsed acid-treated bilayer.

In some embodiments, the process for treating a bilayer comprises the following: (a) providing a solution comprising an acid source wherein the acid source comprises HCl and/or Cl⁻ at a concentration of 10 ppm to 5500 ppm in a solvent wherein the solvent comprises ethylene sulfite; (b) contacting the bilayer with the solution for about one hour or less; (c) removing the bilayer from the solution to afford an acid-treated bilayer; (d) contacting the acid-treated bilayer with a first rinse solution comprising ethylene sulfite for about 1 second to 5 minutes and removing the acid-treated bilayer from the first rinse solution; and (e) contacting the acid-treated bilayer with a second rinse solution comprising acetonitrile for about 1 second to 5 minutes and removing the acid-treated bilayer from the second rinse solution to afford a rinsed acid-treated bilayer.

In some embodiments, the process for treating a bilayer comprises the following: (a) providing a solution comprising an acid source wherein the acid source comprises aqueous H₃PO₄ at a concentration of 10 ppm to 5500 ppm in a solvent wherein the solvent comprises ethylene sulfite; (b) contacting the bilayer with the solution for about one hour or less; (c) removing the bilayer from the solution to afford an acid-treated bilayer; (d) contacting the acid-treated bilayer with a first rinse solution comprising ethylene sulfite for about 1 second to 5 minutes and removing the acid-treated bilayer from the first rinse solution; and (e) contacting the acid-treated bilayer with a second rinse solution comprising acetonitrile for about 1 second to 5 minutes and removing the acid-treated bilayer from the second rinse solution to afford a rinsed acid-treated bilayer.

In some embodiments, (b) is done in a continuous fashion. In some embodiments, (b) and (c) are done in a continuous fashion. In some embodiments, (b), (c), and (d) are done in a continuous fashion. In some embodiments, (b), (c), (d), and (e) are done in a continuous fashion. In some embodiments, (b), (c), (d), (e), and (f) are done in a continuous fashion. In some embodiments, every portion of the acid treatment process is done in a continuous fashion.

In some embodiments, the bilayer contacts the solution in a continuous fashion. In some embodiments, the bilayer is immersed in the solution in a continuous fashion. In some embodiments, the bilayer is immersed in the solution as the solution is being recirculated in a continuous fashion. In some embodiments, the bilayer is immersed in the solution as the solution is being sonicated in a continuous fashion. In some embodiments, the bilayer is immersed in the solution as the solution is being bubbled with gas in a continuous fashion. In some embodiments, the bilayer is sprayed with the solution in a continuous fashion. In some embodiments, the solution is dispensed as a constant stream unto the bilayer in a continuous fashion.

In some embodiments, the bilayer is kept flat with a magnetic sheet during (b). In some embodiments, the bilayer is kept flat with a magnetic sheet during (b) and (c). In some embodiments, the bilayer is kept flat with a magnetic sheet during (b), (c), and (d). In some embodiments, the bilayer is kept flat with a magnetic sheet during (b), (c), (d), and (e). In some embodiments, the bilayer is kept flat with a magnetic sheet during (b), (c), (d), (e), and (f).

In some embodiments, the lithium-stuffed garnet layer of the bilayer is a lithium-stuffed garnet thin film.

In some embodiments, including any of the foregoing, the lithium-stuffed garnet layer, prior to (b), is characterized by the chemical formula Li_{A}La_{B}Al_{C}M″_{D}Zr_{E}O_{F}, wherein 5<A<8, 1.5<B<4, 0.1<C<2, 0<D<2, 1<E<3, 10<F<13, and M″ is selected from the group consisting of Mo, W, Nb, Y, Ta, Ga, Sb, Ca, Ba, Sr, Ce, Hf, and Rb. In some examples, M′ and M″ are the same element selected from the from the group consisting of Al, Mo, W, Nb, Sb, Ca, Ba, Sr, Ce, Hf, Rb, and Ta. However, unless stated explicitly to the contrary, M′ and M″ are not the same element.

In some embodiments, including any of the foregoing, the lithium-stuffed garnet layer, prior to (b), is characterized by the chemical formula LiₐLa_{b}Zr_{c}O_{d}Alₑ, wherein 5<a<8, 2<b<4, 1<c<2, 11<d<14, and 0<e<1, and wherein a, b, c, d, and e, are selected so the formula, LiₐLa_{b}Zr_{c}O_{d}Alₑ, is charge neutral. In some embodiments, including any of the foregoing, a is 6, 6.25, 6.50, 6.75, or 7. In some embodiments, including any of the foregoing, e is 0, 0.25, 0.5, 0.75, or 1. In some embodiments, including any of the foregoing, b is 3 and z is 2. In some embodiments, including any of the foregoing, d is 12. In some embodiments, including any of the foregoing, a is 6.25, b is 3, c is 2, d is 12, and e is 0.25. In some embodiments, including any of the foregoing, a is about 6.25, b is about 3, c is about 2, d is about 12, and e is about 0.25.

In some embodiments, including any of the foregoing, the lithium-stuffed garnet layer, prior to (b), is characterized by the chemical formula LiₓLa₃Zr₂O₁₂+yAl₂O₃, wherein x is from 5.8 to 7.0, and y is 0.1, 0.2, 0.3, 0.4, 0.5, 0.6, 0.7, 0.8, 0.9, or 1.0.

In some embodiments, including any of the foregoing, the lithium-stuffed garnet layer, prior to (b), is characterized by a formula selected from the group consisting of Li_{A}La_{B}M′_{C}M″_{D}Zr_{E}O_{F}, Li_{A}La_{B}M′_{C}M″_{D}Ta_{E}O_{F}, and Li_{A}La_{B}M′_{C}M″_{D}Nb_{E}O_{F}, wherein 4<A<8.5, 1.5<B<4, 0<C<2, 0<D<2; 0<E<2, 10<F<14, and wherein M′ and M″ are each, independently, selected from the group consisting of Al, Mo, W, Nb, Sb, Ca, Ba, Sr, Ce, Hf, Rb, and Ta. In some embodiments, including any of the foregoing, the lithium-stuffed garnet layer, prior to (b), is characterized by a formula selected from the group consisting of LiₐLa_{b}Zr_{c}Al_{d}M″ₑO_{f} wherein 5<a<7.7; 2<b<4; 0<c<2.5; 0<d<2; 0<e<2, and 10<f<14, and wherein M″ₑ is a metal selected from the group consisting of Nb, Ta, V, W, Mo, and Sb.

In some embodiments, including any of the foregoing, the lithium-stuffed garnet layer, prior to (b), is characterized by a formula selected from the group consisting of LiₐLa_{b}Z_{rc}Al_{d}O_{f} wherein 5<a<7.7; 2<b<4; 0<c<2.5; 0<d<2; and 10<f<14. In some embodiments, including any of the foregoing, the lithium-stuffed garnet layer, prior to (b), is characterized by a formula selected from the group consisting of LiₓLa₃Zr₂O₁₂·35Al₂O₃ wherein 4<x<8.5. In some embodiments, including any of the foregoing, the lithium-stuffed garnet layer, prior to (b), is characterized by a formula selected from the group consisting of LiₓLa₃Zr₂O₁₂.5Al₂O₃ wherein 4<x<8.5.

In some embodiments, including any of the foregoing, the lithium-stuffed garnet layer, prior to (b), is characterized by a formula selected from the group consisting of LiₓLa₃Zr₂O₁₂.65Al₂O₃ wherein 4<x<8.5. In some embodiments, including any of the foregoing, the lithium-stuffed garnet layer, prior to (b), is characterized by a formula selected from the group consisting of LiₓLa₃Zr₂O₁₂·Al₂O₃ wherein 4<x<8.5. In some embodiments, including any of the foregoing, the lithium-stuffed garnet layer, prior to (b), is characterized by a formula selected from the group consisting of Li_{A}La_{B}M′_{C}M″_{D}Zr_{E}O_{F}, Li_{A}La_{B}M′_{C}M″_{D}Ta_{E}O_{F}, and Li_{A}La_{B}M′_{C}M″_{D}Nb_{E}O_{F}, wherein 4<A<8.5, 1.5<B<4, 0<C<2.5, 0<D<2.5; 0<E<2.5, 10<F<14, and wherein M′ and M″ are each, independently, selected from the group consisting of Al, Mo, W, Nb, Ga, Y, Gd, Sb, Ca, Ba, Sr, Ce, Hf, Rb, and Ta.

In some embodiments, including any of the foregoing, the lithium-stuffed garnet layer, prior to (b), is characterized by a formula selected from the group consisting of LiₐLa_{b}Zr_{c}Al_{d}M″ₑO_{f} wherein 5<a<7.7; 2<b<4; 0<c<2.5; 0<d<2.5; 0<e<2.5, 10<f<14, and wherein M″ₑ is a metal selected from the group consisting of Nb, Ta, V, W, Mo, and Sb. In some embodiments, including any of the foregoing, the lithium-stuffed garnet layer, prior to (b), is characterized by a formula selected from the group consisting of LiₐLa_{b}Z_{rc}Al_{d}O_{f} wherein 5<a<7.7; 2<b<4; 0<c<2.5; 0<d<2.5; 10<f<14.

In some embodiments, including any of the foregoing, the lithium-stuffed garnet layer is about Li₇La₃Zr₂O₁₂, about Li_{6.25}La₃Zr₂O₁₂Al_{0.25}, about Li_{5.5}La₃Zr₂O₁₂Al_{0.5}, about Li_{4.75}La₃Zr₂O₁₂Al_{0.75}, or about Li₄La₃Zr₂O₁₂Al.

In some embodiments, including any of the foregoing, the lithium-stuffed garnet layer is Li₇La₃Zr₂O₁₂, Li_{6.25}La₃Zr₂O₁₂Al_{0.25}, Li_{5.5}La₃Zr₂O₁₂Al_{0.5}, Li_{4.75}La₃Zr₂O₁₂Al_{0.75}, or Li₄La₃Zr₂O₁₂Al.

In some embodiments, the bilayer prior to (b) includes a contaminant.

In some embodiments, including any of the foregoing, the contaminant is selected from the group consisting of hydroxides, peroxides, oxides, carbonates, and combination thereof.

In some examples, the bilayer following (c), comprises an acid and/or its conjugate base and/or ions thereof incorporated into or bonded to the bilayer. In some examples, the bilayer following (c), comprises an acid and/or its conjugate base and/or ions thereof incorporated into or bonded to the surface of the lithium-stuffed garnet layer of the bilayer.

In some examples, the bilayer following (c), comprises H₃PO₄ and/or its conjugate base, H₂PO₄⁻, and/or ions thereof, PO₄³⁻ and/or PO₄²⁻, incorporated into or bonded to the bilayer. In some examples, the bilayer following (c), comprises H₃PO₄ and/or its conjugate base, H₂PO₄⁻, and/or ions thereof, PO₄³⁻ and/or PO₄²⁻, incorporated into or bonded to the surface of the lithium-stuffed garnet layer of the bilayer. In some examples, the bilayer following (c), comprises H₂TiF₆ and/or its ion thereof, TiF₆²⁻, incorporated into or bonded to the bilayer. In some examples, the bilayer following (c), comprises H₂TiF₆ and/or its ion thereof, TiF₆²⁻, incorporated into or bonded to the surface of the lithium-stuffed garnet layer of the bilayer. In some examples, the bilayer following (c), comprises HCl and/or its conjugate base, Cl⁻, incorporated into or bonded to the bilayer. In some examples, the bilayer following (c), comprises HCl and/or its conjugate base, Cl⁻, incorporated into or bonded to the surface of the lithium-stuffed garnet layer of the bilayer.

In some examples, the bilayer following (c), comprises H₂SO₄ and/or its conjugate base, HSO₄⁻, and/or ions thereof, SO₄²⁻ and/or SO₄⁻, incorporated into or bonded to the bilayer. In some examples, the bilayer following (c), comprises H₂SO₄ and/or its conjugate base, HSO₄⁻, and/or ions thereof, SO₄²⁻ and/or SO₄⁻, incorporated into or bonded to the surface of the lithium-stuffed garnet layer of the bilayer.

In some examples, the bilayer following (c), comprises a phosphorous-containing layer of Li₃PO₄, LiH₂PO₄, Li₂HPO₄, Li(CH₃)₂PO₄ (i.e., lithium dimethylphosphate), Li₂(CH₃)PO₄ (i.e, dilithium methylphosphate), Li₄P₂O₇, or combinations thereof. In some examples, the lithium-stuffed garnet layer of the bilayer following (c), comprises a phosphorous-containing layer of Li₃PO₄, LiH₂PO₄, Li₂HPO₄, Li(CH₃)₂PO₄, Li₂(CH₃)PO₄, Li₄P₂O₇, or combinations thereof.

In some examples, the bilayer following (c), comprises Li₃PO₄. In some examples, the bilayer following (c), comprises LiH₂PO₄. In some examples, the bilayer following (c), comprises Li₂HPO₄. In some examples, the bilayer following (c), comprises Li(CH₃)₂PO₄. In some examples, the bilayer following (c), comprises Li₂(CH₃)PO₄. In some examples, the bilayer following (c), comprises Li₄P₂O₇.

In some examples, the lithium-stuffed garnet layer of the bilayer following (c), comprises Li₃PO₄. In some examples, the lithium-stuffed garnet layer of the bilayer following (c), comprises LiH₂PO₄. In some examples, the lithium-stuffed garnet layer of the bilayer following (c), comprises Li₂HPO₄. In some examples, the lithium-stuffed garnet layer of the bilayer following (c), comprises Li(CH₃)₂PO₄. In some examples, the lithium-stuffed garnet layer of the bilayer following (c), comprises Li₂(CH₃)PO₄. In some examples, the lithium-stuffed garnet layer of the bilayer following (c), comprises Li₄P₂O₇.

In some examples, the bilayer following (c), comprises a partial phosphorous containing layer of Li₃PO₄, LiH₂PO₄, Li₂HPO₄, Li(CH₃)₂PO₄, Li₂(CH₃)PO₄, Li₄P₂O₇, or combinations thereof. In some examples, the lithium-stuffed garnet layer of the bilayer following (c), comprises a partial phosphorous containing layer of Li₃PO₄, LiH₂PO₄, Li₂HPO₄, Li(CH₃)₂PO₄, Li₂(CH₃)PO₄, Li₄P₂O₇, or combinations thereof.

In some examples, the bilayer following (c), comprises a continuous phosphorous containing layer of Li₃PO₄, LiH₂PO₄, Li₂HPO₄, Li(CH₃)₂PO₄, Li₂(CH₃)PO₄, Li₄P₂O₇, or combinations thereof. In some examples, the lithium-stuffed garnet layer of the bilayer following (c), comprises a continuous phosphorous containing layer of Li₃PO₄, LiH₂PO₄, Li₂HPO₄, Li(CH₃)₂PO₄, Li₂(CH₃)PO₄, Li₄P₂O₇, or combinations thereof.

In some examples, the bilayer following (c), comprises a discontinuous phosphorous containing layer of Li₃PO₄, LiH₂PO₄, Li₂HPO₄, Li(CH₃)₂PO₄, Li₂(CH₃)PO₄, Li₄P₂O₇, or combinations thereof. In some examples, the lithium-stuffed garnet layer of the bilayer following (c), comprises a discontinuous phosphorous containing layer of Li₃PO₄, LiH₂PO₄, Li₂HPO₄, Li(CH₃)₂PO₄, Li₂(CH₃)PO₄, Li₄P₂O₇, or combinations thereof.

In some embodiments, the bilayer following (c), comprises a member selected from the group consisting of phosphorus, titanium, chloride, chlorine, sulfur, boron, zirconium, and a combination thereof greater than 0.05 atomic percent as measured by X-ray photo-electron spectroscopy (XPS). In some embodiments, the lithium-stuffed garnet layer of the bilayer following (c), comprises a member selected from the group consisting of phosphorus, titanium, chloride, chlorine, sulfur, boron, zirconium, and a combination thereof greater than 0.05 atomic percent as measured by X-ray photo-electron spectroscopy (XPS).

In some embodiments, the bilayer following (c), comprises a member selected from the group consisting of phosphorus, titanium, chloride, chlorine, sulfur, boron, zirconium, and a combination thereof greater than 0.1 atomic percent as measured by XPS. In some embodiments, the lithium-stuffed garnet layer of the bilayer following (c), comprises a member selected from the group consisting of phosphorus, titanium, chloride, chlorine, sulfur, boron, zirconium, and a combination thereof greater than 0.1 atomic percent as measured by XPS.

In some embodiments, the bilayer following (c), comprises a member selected from the group consisting of phosphorus, titanium, chloride, chlorine, sulfur, boron, zirconium, and a combination thereof greater than 0.2 atomic percent as measured by XPS. In some embodiments, the lithium-stuffed garnet layer of the bilayer following (c), comprises a member selected from the group consisting of phosphorus, titanium, chloride, chlorine, sulfur, boron, zirconium, and a combination thereof greater than 0.2 atomic percent as measured by XPS.

In some embodiments, the bilayer following (c), comprises an amount of phosphorus greater than 0.05 atomic percent, greater than 0.1 atomic percent, or greater than 0.2 atomic percent as measured by XPS. In some embodiments, the lithium-stuffed garnet layer of the bilayer following (c), comprises an amount of phosphorus greater than 0.05 atomic percent, greater than 0.1 atomic percent, or greater than 0.2 atomic percent as measured by XPS.

In some embodiments, the bilayer following (c), comprises an amount of titanium greater than 0.05 atomic percent, greater than 0.1 atomic percent, or greater than 0.2 atomic percent as measured by XPS. In some embodiments, the lithium-stuffed garnet layer of the bilayer following (c), comprises an amount of titanium greater than 0.05 atomic percent, greater than 0.1 atomic percent, or greater than 0.2 atomic percent as measured by XPS.

In some embodiments, the bilayer following (c), comprises an amount of chloride or chlorine or combinations thereof greater than 0.05 atomic percent, greater than 0.1 atomic percent, or greater than 0.2 atomic percent as measured by XPS. In some embodiments, the lithium-stuffed garnet layer of the bilayer following (c), comprises an amount of chloride or chlorine or combinations thereof greater than 0.05 atomic percent, greater than 0.1 atomic percent, or greater than 0.2 atomic percent as measured by XPS.

In some embodiments, the bilayer following (c), comprises an amount of sulfur greater than 0.05 atomic percent, greater than 0.1 atomic percent, or greater than 0.2 atomic percent as measured by XPS. In some embodiments, the lithium-stuffed garnet layer of the bilayer following (c), comprises an amount of sulfur greater than 0.05 atomic percent, greater than 0.1 atomic percent, or greater than 0.2 atomic percent as measured by XPS.

In some embodiments, the bilayer following (c), comprises an amount of boron greater than 0.05 atomic percent, greater than 0.1 atomic percent, or greater than 0.2 atomic percent as measured by XPS. In some embodiments, the lithium-stuffed garnet layer of the bilayer following (c), comprises an amount of boron greater than 0.05 atomic percent, greater than 0.1 atomic percent, or greater than 0.2 atomic percent as measured by XPS.

In some embodiments, the bilayer following (c), comprises an amount of zirconium greater than 0.05 atomic percent, greater than 0.1 atomic percent, or greater than 0.2 atomic percent as measured by XPS. In some embodiments, the lithium-stuffed garnet layer of the bilayer following (c), comprises an amount of zirconium greater than 0.05 atomic percent, greater than 0.1 atomic percent, or greater than 0.2 atomic percent as measured by XPS.

In some embodiments, the bilayer following (c), comprises a member selected from the group consisting of phosphorus, titanium, chloride, chlorine, sulfur, boron, zirconium, and a combination thereof at a depth of penetration of about 1 μm to 20 μm as measured by XPS. In some embodiments, the lithium-stuffed garnet layer of the bilayer following (c), comprises a member selected from the group consisting of phosphorus, titanium, chloride, chlorine, sulfur, boron, zirconium, and a combination thereof at a depth of penetration of about 1 μm to 20 μm as measured by XPS.

In some embodiments, the bilayer following (c), comprises a member selected from the group consisting of phosphorus, titanium, chloride, chlorine, sulfur, boron, zirconium, and a combination thereof at a depth of penetration of about 1 μm to 2 μm as measured by XPS. In some embodiments, the lithium-stuffed garnet layer of the bilayer following (c), comprises a member selected from the group consisting of phosphorus, titanium, chloride, chlorine, sulfur, boron, zirconium, and a combination thereof at a depth of penetration of about 1 μm to 2 μm as measured by XPS.

In some embodiments, the bilayer following (c), comprises a member selected from the group consisting of phosphorus, titanium, chloride, chlorine, sulfur, boron, zirconium, and a combination thereof at a depth of penetration of about 1 μm to 5 μm as measured by XPS. In some embodiments, the lithium-stuffed garnet layer of the bilayer following (c), comprises a member selected from the group consisting of phosphorus, titanium, chloride, chlorine, sulfur, boron, zirconium, and a combination thereof at a depth of penetration of about 1 μm to 5 μm as measured by XPS.

In some embodiments, the bilayer following (c), comprises a member selected from the group consisting of phosphorus, titanium, chloride, chlorine, sulfur, boron, zirconium, and a combination thereof at a depth of penetration of about 5 μm to 10 μm as measured by XPS. In some embodiments, the lithium-stuffed garnet layer of the bilayer following (c), comprises a member selected from the group consisting of phosphorus, titanium, chloride, chlorine, sulfur, boron, zirconium, and a combination thereof at a depth of penetration of about 5 μm to 10 μm as measured by XPS.

In some embodiments, the bilayer following (c), comprises a member selected from the group consisting of phosphorus, titanium, chloride, chlorine, sulfur, boron, zirconium, and a combination thereof at a depth of penetration of about 10 μm to 15 μm as measured by XPS. In some embodiments, the lithium-stuffed garnet layer of the bilayer following (c), comprises a member selected from the group consisting of phosphorus, titanium, chloride, chlorine, sulfur, boron, zirconium, and a combination thereof at a depth of penetration of about 10 μm to 15 μm as measured by XPS.

In some embodiments, the bilayer following (c), comprises a member selected from the group consisting of phosphorus, titanium, chloride, chlorine, sulfur, boron, zirconium, and a combination thereof at a depth of penetration of about 15 μm to 20 μm as measured by XPS. In some embodiments, the lithium-stuffed garnet layer of the bilayer following (c), comprises a member selected from the group consisting of phosphorus, titanium, chloride, chlorine, sulfur, boron, zirconium, and a combination thereof at a depth of penetration of about 15 μm to 20 μm as measured by XPS.

In some embodiments, the bilayer following (c), comprises an amount of phosphorus at a depth of penetration of about 1 μm to 20 μm as measured by XPS. In some embodiments, the lithium-stuffed garnet layer of the bilayer following (c), comprises an amount of phosphorus at a depth of penetration of about 1 μm to 20 μm as measured by XPS.

In some embodiments, the bilayer following (c), comprises an amount of phosphorus at a depth of penetration of about 1 μm to 2 μm, about 1 μm to 5 μm, or about 1 μm to 10 μm as measured by XPS. In some embodiments, the lithium-stuffed garnet layer of the bilayer following (c), comprises an amount of phosphorus at a depth of penetration of about 1 μm to 2 μm, about 1 μm to 5 μm, or about 1 μm to 10 μm as measured by XPS.

In some embodiments, the bilayer following (c), comprises an amount of titanium at a depth of penetration of about 1 μm to 20 μm as measured by XPS. In some embodiments, the lithium-stuffed garnet layer of the bilayer following (c), comprises an amount of titanium at a depth of penetration of about 1 μm to 20 μm as measured by XPS.

In some embodiments, the bilayer following (c), comprises an amount of titanium at a depth of penetration of about 1 μm to 2 μm, about 1 to 5 μm, or about 1 μm to 10 μm as measured by XPS. In some embodiments, the lithium-stuffed garnet layer of the bilayer following (c), comprises an amount of titanium at a depth of penetration of about 1 μm to 2 μm, about 1 to 5 μm, or about 1 μm to 10 μm as measured by XPS.

In some embodiments, the bilayer following (c), comprises an amount of chloride or chlorine or combinations thereof at a depth of penetration of about 1 μm to 20 μm as measured by XPS. In some embodiments, the lithium-stuffed garnet layer of the bilayer following (c), comprises an amount of chloride or chlorine or combinations thereof at a depth of penetration of about 1 μm to 20 μm as measured by XPS.

In some embodiments, the bilayer following (c), comprises an amount of chloride or chlorine or combinations thereof at a depth of penetration of about 1 μm to 2 μm, about 1 μm to 5 μm, or about 1 μm to 10 μm as measured by XPS. In some embodiments, the lithium-stuffed garnet layer of the bilayer following (c), comprises an amount of chloride or chlorine or combinations thereof at a depth of penetration of about 1 μm to 2 μm, about 1 μm to 5 μm, or about 1 μm to 10 μm as measured by XPS.

In some embodiments, the bilayer following (c), comprises an amount of sulfur at a depth of penetration of about 1 μm to 20 μm as measured by XPS. In some embodiments, the lithium-stuffed garnet layer of the bilayer following (c), comprises an amount of sulfur at a depth of penetration of about 1 μm to 20 μm as measured by XPS.

In some embodiments, the bilayer following (c), comprises an amount of sulfur at a depth of penetration of about 1 μm to 2 μm, about 1 μm to 5 μm, or about 1 μm to 10 μm as measured by XPS. In some embodiments, the lithium-stuffed garnet layer of the bilayer following (c), comprises an amount of sulfur at a depth of penetration of about 1 μm to 2 μm, about 1 μm to 5 μm, or about 1 μm to 10 μm as measured by XPS.

In some embodiments, the bilayer following (c), comprises an amount of boron at a depth of penetration of about 1 μm to 20 μm as measured by XPS. In some embodiments, the lithium-stuffed garnet layer of the bilayer following (c), comprises an amount of boron at a depth of penetration of about 1 μm to 20 μm as measured by XPS. In some embodiments, the bilayer following (c), comprises an amount of boron at a depth of penetration of about 1 μm to 2 μm, about 1 μm to 5 μm, or about 1 μm to 10 μm as measured by XPS. In some embodiments, the lithium-stuffed garnet layer of the bilayer following (c), comprises an amount of boron at a depth of penetration of about 1 μm to 2 μm, about 1 μm to 5 μm, or about 1 μm to 10 μm as measured by XPS. In some embodiments, the bilayer following (c), comprises an amount of zirconium at a depth of penetration of about 1 μm to 20 μm as measured by XPS. In some embodiments, the lithium-stuffed garnet layer of the bilayer following (c), comprises an amount of zirconium at a depth of penetration of about 1 μm to 20 μm as measured by XPS.

In some embodiments, the bilayer following (c), comprises an amount of zirconium at a depth of penetration of about 1 μm to 2 μm, about 1 μm to 5 μm, or about 1 μm to 10 μm as measured by XPS. In some embodiments, the lithium-stuffed garnet layer of the bilayer following (c), comprises an amount of zirconium at a depth of penetration of about 1 μm to 2 μm, about 1 μm to 5 μm, or about 1 μm to 10 μm as measured by XPS.

In some embodiments, the bilayer following (c), comprises an amount of fluoride or fluorine or combinations thereof at a depth of penetration of less than 1 μm as measured by XPS. In some embodiments, the lithium-stuffed garnet layer of the bilayer following (c), comprises an amount of fluoride or fluorine or combinations thereof at a depth of penetration of less than 1 μm as measured by XPS.

In some embodiments, the bilayer following (c), is characterized by an atomic percent ratio of P to Zr about 1 to 15.0 as measured by XPS. In some embodiments, the bilayer following (c), is characterized by an atomic percent ratio of P to Zr about 1.5 to 10 as measured by XPS. In some embodiments, the bilayer following (c), is characterized by an atomic percent ratio of P to Zr about 1.5 to 5 as measured by XPS. In some embodiments, the bilayer following (c), is characterized by an atomic percent ratio of P to Zr about 1.5 to 3 as measured by XPS. In some embodiments, the lithium-stuffed garnet layer of the bilayer following (c), is characterized by an atomic percent ratio of P to Zr about 1 to 15.0 as measured by XPS. In some embodiments, the lithium-stuffed garnet layer of the bilayer following (c), is characterized by an atomic percent ratio of P to Zr about 1.5 to 10 as measured by XPS. In some embodiments, the lithium-stuffed garnet layer of the bilayer following (c), is characterized by an atomic percent ratio of P to Zr about 1.5 to 5 as measured by XPS. In some embodiments, the lithium-stuffed garnet layer of the bilayer following (c), is characterized by an atomic percent ratio of P to Zr about 1.5 to 3 as measured by XPS.

In some embodiments, the bilayer following (c), is characterized by an atomic percent ratio of S to Zr about 0 to 3 as measured by XPS. In some embodiments, the bilayer following (c), is characterized by an atomic percent ratio of S to Zr about 0 to 1 as measured by XPS. In some embodiments, the lithium-stuffed garnet layer of the bilayer following (c), is characterized by an atomic percent ratio of S to Zr about 0 to 3 as measured by XPS. In some embodiments, the bilayer following (c), is characterized by an atomic percent ratio of S to Zr about 0 to 1 as measured by XPS.

In some embodiments, the bilayer following (c), is characterized by an atomic percent ratio of the functional group CO₃ to Zr of less than about 1, but greater than 0, as measured by XPS. In some embodiments, the lithium-stuffed garnet layer of the bilayer following (c), is characterized by an atomic percent ratio of the functional group CO₃ to Zr of less than about 1, but greater than 0, as measured by XPS.

In some embodiments, the bilayer following (c), has less than about 5 atomic percent of lithium carbonate as measured by XPS. In some embodiments, the lithium-stuffed garnet layer of the bilayer following (c), has less than about 5 atomic percent of lithium carbonate as measured by XPS. In some embodiments, the bilayer following (c), has less than about 4 atomic percent of lithium carbonate as measured by XPS. In some embodiments, the lithium-stuffed garnet layer of the bilayer following (c), has less than about 4 atomic percent of lithium carbonate as measured by XPS. In some embodiments, the bilayer following (c), has less than about 3 atomic percent of lithium carbonate as measured by XPS. In some embodiments, the lithium-stuffed garnet layer of the bilayer following (c), has less than about 3 atomic percent of lithium carbonate as measured by XPS. In some embodiments, the bilayer following (c), has less than about 2 atomic percent of lithium carbonate as measured by XPS. In some embodiments, the lithium-stuffed garnet layer of the bilayer following (c), has less than about 2 atomic percent of lithium carbonate as measured by XPS. In some embodiments, the bilayer following (c), has less than about 1 atomic percent of lithium carbonate as measured by XPS. In some embodiments, the lithium-stuffed garnet layer of the bilayer following (c), has less than about 1 atomic percent of lithium carbonate as measured by XPS. In some embodiments, the bilayer following (c), has less than about 0.5 atomic percent of lithium carbonate as measured by XPS. In some embodiments, the lithium-stuffed garnet layer of the bilayer following (c), has less than about 0.5 atomic percent of lithium carbonate as measured by XPS. In some embodiments, the bilayer following (c), has less than about 0.25 atomic percent of lithium carbonate as measured by XPS. In some embodiments, the lithium-stuffed garnet layer of the bilayer following (c), has less than about 0.25 atomic percent of lithium carbonate as measured by XPS.

In some embodiments, the bilayer prior to (b), is characterized by an atomic percent ratio of the functional group CO₃ to Zr of about 1 to 10, as measured by XPS and following (c) is characterized by an atomic percent ratio of the functional group CO₃ to Zr of less than about 9, but greater than 0, as measured by XPS. In some embodiments, the bilayer prior to (b), is characterized by an atomic percent ratio of the functional group CO₃ to Zr of about 1 to 10, as measured by XPS and following (c) is characterized by an atomic percent ratio of the functional group CO₃ to Zr of less than about 5, but greater than 0, as measured by XPS. In some embodiments, the bilayer prior to (b), is characterized by an atomic percent ratio of the functional group CO₃ to Zr of about 1 to 10, as measured by XPS and following (c) is characterized by an atomic percent ratio of the functional group CO₃ to Zr of less than about 3, but greater than 0, as measured by XPS. In some embodiments, the bilayer prior to (b), is characterized by an atomic percent ratio of the functional group CO₃ to Zr of about 1 to 4, as measured by XPS and following (c) is characterized by an atomic percent ratio of the functional group CO₃ to Zr of less than about 3, but greater than 0, as measured by XPS. In some embodiments, the bilayer prior to (b), is characterized by an atomic percent ratio of the functional group CO₃ to Zr of about 1 to 4, as measured by XPS and following (c) is characterized by an atomic percent ratio of the functional group CO₃ to Zr of less than about 1, but greater than 0, as measured by XPS.

In some embodiments, the bilayer after (c) is characterized by an atomic percent ratio of the functional group CO₃ to Zr of less than about 9, but greater than about 0, less than about 5, but greater than about 0, or less than about 3, but greater than about 0. In some embodiments, the bilayer after (c) is characterized by an atomic percent ratio of the functional group CO₃ to Zr of less than about 9, but greater than about 0. In some embodiments, the bilayer after (c) is characterized by an atomic percent ratio of the functional group CO₃ to Zr of less than about 5, but greater than about 0. In some embodiments, the bilayer after (c) is characterized by an atomic percent ratio of the functional group CO₃ to Zr of less than about 3, but greater than about 0.

In some embodiments, the lithium-stuffed garnet layer of the bilayer after (c) is characterized by an atomic percent ratio of the functional group CO₃ to Zr of less than about 9, but greater than about 0. In some embodiments, the lithium-stuffed garnet layer of the bilayer after (c) is characterized by an atomic percent ratio of the functional group CO₃ to Zr of less than about 5, but greater than about 0. In some embodiments, the lithium-stuffed garnet layer of the bilayer after (c) is characterized by an atomic percent ratio of the functional group CO₃ to Zr of or less than about 3, but greater than about 0.

In some embodiments, the bilayer after (c), and up to 21 days in storage under dry air conditions, is characterized by an atomic percent ratio of the functional group CO₃ to Zr of less than about 5, but greater than 0, as measured by XPS. In some embodiments, the lithium-stuffed garnet layer of the bilayer after (c), and up to 21 days in storage under dry air conditions, is characterized by an atomic percent ratio of the functional group CO₃ to Zr of less than about 5, but greater than 0, as measured by XPS.

In some embodiments, the bilayer has a lower interfacial resistance after (b) than before (b).

In some embodiments, the bilayer has a lower interfacial resistance after (c) than before (b).

In some embodiments and examples set forth herein is a method that include providing a bilayer as described herein; exposing the bilayer to ambient conditions; and measuring the ASR of the bilayer. In some examples, the measuring occurs in a dry room. In some examples, the measuring is accomplished by electrical impedance spectroscopy (EIS).

In some embodiments, the bilayer has an ASR of less than about 65 Ω-cm², but greater than 5 Ω-cm² at 25° C. after (c). In some embodiments, the bilayer has an ASR at 25° C. of less than about 60 Ω-cm², less than about 55 Ω-cm², less than about 50 Ω-cm², less than about 45 Ω-cm², less than about 40 Ω-cm², less than about 35 Ω-cm², less than about 30 Ω-cm², less than about 25 Ω-cm², less than about 20 Ω-cm², less than about 15 Ω-cm², or less than about 10 Ω-cm² after (c).

In some embodiments, the bilayer has an ASR of less than about 65 Ω-cm², but greater than 5 Ω-cm² at 25° C. when measured at least about one month after (c). In some embodiments, the bilayer has an ASR at 25° C. of less than about 60 Ω-cm², less than about 55 Ω-cm², less than about 50 Ω-cm², less than about 45 Ω-cm², less than about 40 Ω-cm², less than about 35 Ω-cm², less than about 30 Ω-cm², less than about 25 Ω-cm², less than about 20 Ω-cm², less than about 15 Ω-cm², or less than about 10 Ω-cm² measured at least about one month after (c).

In some embodiments, the bilayer has an ASR of less than about 65 Ω-cm², but greater than 5 Ω-cm² at 25° C. when measured at least about three months after (c). In some embodiments, the bilayer has an ASR at 25° C. of less than about 60 Ω-cm², less than about 55 Ω-cm², less than about 50 Ω-cm², less than about 45 Ω-cm², less than about 40 Ω-cm², less than about 35 Ω-cm², less than about 30 Ω-cm², less than about 25 Ω-cm², less than about 20 Ω-cm², less than about 15 Ω-cm², or less than about 10 Ω-cm² measured at least about three months after (c).

In some embodiments, the bilayer has an ASR of less than about 65 Ω-cm², but greater than 5 Ω-cm² at 25° C. when measured at least about six months after (c). In some embodiments, the bilayer has an ASR at 25° C. of less than about 60 Ω-cm², less than about 55 Ω-cm², less than about 50 Ω-cm², less than about 45 Ω-cm², less than about 40 Ω-cm², less than about 35 Ω-cm², less than about 30 Ω-cm², less than about 25 Ω-cm², less than about 20 Ω-cm², less than about 15 Ω-cm², or less than about 10 Ω-cm² measured at least about six months after (c).

In some embodiments, the bilayer has an ASR of less than about 65 Ω-cm², but greater than 5 Ω-cm² at 25° C. when measured at least about one year after (c). In some embodiments, the bilayer has an ASR at 25° C. of less than about 60 Ω-cm², less than about 55 Ω-cm², less than about 50 Ω-cm², less than about 45 Ω-cm², less than about 40 Ω-cm², less than about 35 Ω-cm², less than about 30 Ω-cm², less than about 25 Ω-cm², less than about 20 Ω-cm², less than about 15 Ω-cm², or less than about 10 Ω-cm² measured at least about one year after (c).

In some embodiments, the bilayer is kept at a resting voltage of 4.25 V or 4.35 V, during after a high temperature high voltage (HTHV) test at 60° C. for 1 month. In some embodiments, the bilayer is kept at a resting voltage of 4.25 V, during after a high temperature high voltage (HTHV) test at 60° C. for 1 month. In some embodiments, the bilayer is kept at a resting voltage of 4.35 V, during after a high temperature high voltage (HTHV) test at 60° C. for 1 month.

In some embodiments, the bilayer has an ASR of less than about 65 Ω-cm², but greater than 5 Ω-cm² at 25° C. after (c) and after a high temperature high voltage (HTHV) test at 60° C. for 1 month. In some embodiments, the bilayer has an ASR at 25° C. of less than about 60 Ω-cm², less than about 55 Ω-cm², less than about 50 Ω-cm², less than about 45 Ω-cm², less than about 40 Ω-cm², less than about 35 Ω-cm², less than about 30 Ω-cm², less than about 25 Ω-cm², less than about 20 Ω-cm², less than about 15 Ω-cm², or less than about 10 Ω-cm² after (c) and after a high temperature high voltage (HTHV) test at 60° C. for 1 month.

In some embodiments, the bilayer has an ASR of less than about 65 Ω-cm², but greater than 5 Ω-cm² at 25° C. after (c) and at least about one month after a high temperature high voltage (HTHV) test at 60° C. for 1 month. In some embodiments, the bilayer has an ASR at 25° C. of less than about 60 Ω-cm², less than about 55 Ω-cm², less than about 50 Ω-cm², less than about 45 Ω-cm², less than about 40 Ω-cm², less than about 35 Ω-cm², less than about 30 Ω-cm², less than about 25 Ω-cm², less than about 20 Ω-cm², less than about 15 Ω-cm², or less than about 10 Ω-cm² after (c) and at least about one month after a high temperature high voltage (HTHV) test at 60° C. for 1 month.

In some embodiments, the bilayer experiences less than about a 10% increase in ASR at 25° C. following a high temperature high voltage (HTHV) test. In some embodiments, including any of the foregoing, at least the top or bottom surface of the lithium-stuffed garnet thin film experiences less than about a 10% increase in ASR at 25° C. following a high temperature high voltage (HTHV) test at 60° C. for 1 month and this low ASR is sustained for at least about one week, at least about one month, at least about two months, at least about three months, at least about six months, at least about nine months, at least about one year, or more.

In some embodiments, the bilayer experiences less than about a 10% increase in ASR at 25° C. following a high temperature high voltage (HTHV) test at 60° C. for 1 month and this low ASR is sustained for at least about one week.

In some embodiments, the bilayer experiences less than about a 10% increase in ASR at 25° C. following a high temperature high voltage (HTHV) test at 60° C. for 1 month and this low ASR is sustained for at least about one month.

In some embodiments, the bilayer experiences less than about a 10% increase in ASR at 25° C. following a high temperature high voltage (HTHV) test at 60° C. for 1 month and this low ASR is sustained for at least about two months.

In some embodiments, the bilayer experiences less than about a 10% increase in ASR at 25° C. following a high temperature high voltage (HTHV) test at 60° C. for 1 month and this low ASR is sustained for at least about three months.

In some embodiments, the bilayer experiences less than about a 10% increase in ASR at 25° C. following a high temperature high voltage (HTHV) test at 60° C. for 1 month and this low ASR is sustained for at least about six months.

In some embodiments, the bilayer experiences less than about a 15% increase in ASR at 25° C. after a high temperature high voltage (HTHV) test at 60° C. for 1 month. In some embodiments, the bilayer experiences less than about a 20% increase, about a 25% increase, about a 30% increase, about a 35% increase, about a 40% increase, about a 45% increase, about a 50% increase, about a 55% increase, about a 60%, about a 65% increase, or about a 70% increase in ASR at 25° C. after a HTHV test at 60° C. for 1 month. In some embodiments, the bilayer experiences less than about a 15% increase, about a 20% increase, about a 25% increase, about a 30% increase, about a 35% increase, about a 40% increase, about a 45% increase, about a 50% increase, about a 55% increase, about a 60%, about a 65% increase, or about a 70% increase in ASR at 25° C. after a HTHV test at 60° C. for 1 month and this low ASR is sustained for at least about one month, at least about two months, at least about three months, at least about six months, at least about nine months, at least about one year, or more. In some embodiments, the bilayer experiences less than about a 20% increase in ASR at 25° C. following a high temperature high voltage (HTHV) test at 60° C. for 1 month and this low ASR is sustained for at least about one week. In some embodiments, the bilayer experiences less than about a 20% increase in ASR at 25° C. following a high temperature high voltage (HTHV) test at 60° C. for 1 month and this low ASR is sustained for at least about one month. In some embodiments, the bilayer experiences less than about a 20% increase in ASR at 25° C. following a high temperature high voltage (HTHV) test at 60° C. for 1 month and this low ASR is sustained for at least about two months. In some embodiments, the bilayer experiences less than about a 20% increase in ASR at 25° C. following a high temperature high voltage (HTHV) test at 60° C. for 1 month and this low ASR is sustained for at least about three months. In some embodiments, the bilayer experiences less than about a 20% increase in ASR at 25° C. following a high temperature high voltage (HTHV) test at 60° C. for 1 month and this low ASR is sustained for at least about six months. In some embodiments, the bilayer experiences less than about a 30% increase in ASR at 25° C. following a high temperature high voltage (HTHV) test at 60° C. for 1 month and this low ASR is sustained for at least about one week. In some embodiments, the bilayer experiences less than about a 30% increase in ASR at 25° C. following a high temperature high voltage (HTHV) test at 60° C. for 1 month and this low ASR is sustained for at least about one month. In some embodiments, the bilayer experiences less than about a 30% increase in ASR at 25° C. following a high temperature high voltage (HTHV) test at 60° C. for 1 month and this low ASR is sustained for at least about two months. In some embodiments, the bilayer experiences less than about a 30% increase in ASR at 25° C. following a high temperature high voltage (HTHV) test at 60° C. for 1 month and this low ASR is sustained for at least about three months. In some embodiments, the bilayer experiences less than about a 30% increase in ASR at 25° C. following a high temperature high voltage (HTHV) test at 60° C. for 1 month and this low ASR is sustained for at least about six months. In some embodiments, the bilayer experiences less than about a 40% increase in ASR at 25° C. following a high temperature high voltage (HTHV) test at 60° C. for 1 month and this low ASR is sustained for at least about one week. In some embodiments, the bilayer experiences less than about a 40% increase in ASR at 25° C. following a high temperature high voltage (HTHV) test at 60° C. for 1 month and this low ASR is sustained for at least about one month. In some embodiments, the bilayer experiences less than about a 40% increase in ASR at 25° C. following a high temperature high voltage (HTHV) test at 60° C. for 1 month and this low ASR is sustained for at least about two months.

In some embodiments, the bilayer experiences less than about a 40% increase in ASR at 25° C. following a high temperature high voltage (HTHV) test at 60° C. for 1 month and this low ASR is sustained for at least about three months.

In some embodiments, the bilayer experiences less than about a 40% increase in ASR at 25° C. following a high temperature high voltage (HTHV) test at 60° C. for 1 month and this low ASR is sustained for at least about six months.

In some embodiments, the bilayer experiences less than about a 50% increase in ASR at 25° C. following a high temperature high voltage (HTHV) test at 60° C. for 1 month and this low ASR is sustained for at least about one week.

In some embodiments, the bilayer experiences less than about a 50% increase in ASR at 25° C. following a high temperature high voltage (HTHV) test at 60° C. for 1 month and this low ASR is sustained for at least about one month.

In some embodiments, the bilayer experiences less than about a 50% increase in ASR at 25° C. following a high temperature high voltage (HTHV) test at 60° C. for 1 month and this low ASR is sustained for at least about two months.

In some embodiments, the bilayer experiences less than about a 50% increase in ASR at 25° C. following a high temperature high voltage (HTHV) test at 60° C. for 1 month and this low ASR is sustained for at least about three months.

In some embodiments, the bilayer experiences less than about a 50% increase in ASR at 25° C. following a high temperature high voltage (HTHV) test at 60° C. for 1 month and this low ASR is sustained for at least about six months. In some embodiments, the bilayer experiences less than about a 60% increase in ASR at 25° C. following a high temperature high voltage (HTHV) test at 60° C. for 1 month and this low ASR is sustained for at least about one week. In some embodiments, the bilayer experiences less than about a 60% increase in ASR at 25° C. following a high temperature high voltage (HTHV) test at 60° C. for 1 month and this low ASR is sustained for at least about six months. In some embodiments, the bilayer experiences less than about a 70% increase in ASR at 25° C. following a high temperature high voltage (HTHV) test at 60° C. for 1 month and this low ASR is sustained for at least about one week. In some embodiments, the bilayer experiences less than about a 70% increase in ASR at 25° C. following a high temperature high voltage (HTHV) test at 60° C. for 1 month and this low ASR is sustained for at least about six months. In some embodiments, the bilayer is characterized by an atomic percent ratio of the functional group CO₃ to Zr of less than about 1, but greater than 0, as measured by XPS one week following a high temperature high voltage (HTHV) test at 60° C. for 1 month.

### Acid-Treated Lithium-Stuffed Garnet Electrolytes

In some embodiments, set forth herein is a bilayer made by a process described herein.

In some embodiments, set forth herein is a bilayer wherein the bilayer comprises an acid and/or its conjugate base and/or dissolved ions thereof incorporated into or bonded to the bilayer and wherein the acid, and/or its conjugate base, and/or dissolved ions thereof is selected from the group consisting of:
(a) H₃PO₄ and/or H₂PO₄⁻ and/or PO₄³⁻ and/or PO₄²⁻;
(b) H₂SO₄ and/or HSO₄⁻ and/or SO₄⁻ and/or SO₄⁻;
(c) HCl and/or Cl⁻;
(d) H₃BO₃ and/or B(OH)₄⁻ and/or BH₂O³⁻;
(e) H₂TiF₆ and/or TiF₆²⁻;
(f) H₂ZrF₆ and/or ZrF₆²⁻; and
(g) combinations thereof.

In some embodiments, the bilayer is characterized by an atomic percent ratio of S to Zr greater than 0, but less than 4, as measured by XPS.

In certain embodiments, the bilayer is characterized as having less than 1 m layer thereupon which includes a lithium carbonate, lithium hydroxide, lithium oxide, a hydrate thereof, an oxide thereof, or a combination thereof. In certain embodiments, the bilayer has less than about 9, but greater than 0, atomic percent of lithium carbonate as measured by X-ray photoelectron spectroscopy (XPS). In certain embodiments, the bilayer has less than about 5, but greater than 0, atomic percent of lithium carbonate as measured by X-ray photoelectron spectroscopy (XPS). In certain embodiments, the bilayer has less than about 3, but greater than 0, atomic percent of lithium carbonate as measured by X-ray photoelectron spectroscopy (XPS). In certain embodiments, the bilayer has less than about 1, but greater than 0, atomic percent of lithium carbonate as measured by X-ray photoelectron spectroscopy (XPS). In certain embodiments, the bilayer is sintered. In certain embodiments, the lithium-stuffed garnet layer of the bilayer is a lithium-stuffed garnet thin film. In some embodiments, the lithium-stuffed garnet layer of the bilayer is a sintered lithium-stuffed garnet thin film.

In some embodiments, including any of the foregoing, the bulk, but not the surface, of the lithium-stuffed garnet layer is characterized by the chemical formula Li_{A}La_{B}Al_{C}M″_{D}Zr_{E}O_{F}, wherein 5<A<8, 1.5<B<4, 0.1<C<2, 0<D<2, 1<E<3, 10<F<13, and M″ is selected from the group consisting of Mo, W, Nb, Y, Ta, Ga, Sb, Ca, Ba, Sr, Ce, Hf, and Rb.

In some embodiments, including any of the foregoing, the bulk, but not the surface, of the lithium-stuffed garnet layer is characterized by the chemical formula LiₓLa₃Zr₂O₁₂+yAl₂O₃, wherein x is from 5.8 to 7.0, and y is 0.1, 0.2, 0.3, 0.4, 0.5, 0.6, 0.7, 0.8, 0.9, or 1.0.

In some embodiments, including any of the foregoing, the bulk, but not the surface, of the lithium-stuffed garnet layer is characterized by the chemical formula LiₐLa_{b}Zr_{C}O_{d}Alₑ, wherein 5≤a≤8, 2≤b≤4, 1≤c≤2, 11≤d≤14, and 0≤e≤1, and wherein a, b, c, d, and e, are selected so the formula, LiₐLa_{b}Zr_{c}O_{d}Alₑ, is charge neutral. In some embodiments, including any of the foregoing, a is 6, 6.25, 6.50, 6.75, or 7. In some embodiments, including any of the foregoing, e is 0, 0.25, 0.5, 0.75, or 1. In some embodiments, including any of the foregoing, b is 3 and z is 2. In some embodiments, including any of the foregoing, d is 12. In some embodiments, including any of the foregoing, a is 6.25, b is 3, c is 2, d is 12, and e is 0.25. In some embodiments, including any of the foregoing, a is about 6.25, b is about 3, c is about 2, d is about 12, and e is about 0.25.

In some embodiments, including any of the foregoing, the bulk, but not the surface, of the lithium-stuffed garnet layer is characterized by a formula selected from the group consisting of Li_{A}La_{B}M′_{C}M″_{D}Zr_{E}O_{F}, Li_{A}La_{B}M′_{C}M″_{D}Ta_{E}O_{F}, and Li_{A}La_{B}M′_{C}M″_{D}Nb_{E}O_{F}, wherein 4<A<8.5, 1.5<B<4, 0<C<2, 0<D<2; 0<E<2, 10<F<14, and wherein M′ and M″ are each, independently, selected from the group consisting of Al, Mo, W, Nb, Sb, Ca, Ba, Sr, Ce, Hf, Rb, and Ta. In some examples, M′ and M″ are the same member selected from the from the group consisting of Al, Mo, W, Nb, Sb, Ca, Ba, Sr, Ce, Hf, Rb, and Ta. However, unless stated explicitly to the contrary, M′ and M″ are not the same element.

In some embodiments, including any of the foregoing, the bulk, but not the surface, of the lithium-stuffed garnet layer is characterized by a formula selected from the group consisting of Li_{A}La_{B}M′_{C}M″_{D}Zr_{E}O_{F}, Li_{A}La_{B}M′_{C}M′_{D}Ta_{E}O_{F}, and Li_{A}La_{B}M′_{C}M″_{D}Nb_{E}O_{F}, wherein 4<A<8.5, 1.5<B<4, 0<C<2.5, 0<D<2.5; 0<E<2.5, 10<F<14, and wherein M′ and M″ are each, independently, selected from the group consisting of Al, Mo, W, Nb, Ga, Y, Gd, Sb, Ca, Ba, Sr, Ce, Hf, Rb, and Ta.

In some embodiments, including any of the foregoing, the bulk, but not the surface, of the lithium-stuffed garnet layer is characterized by a formula selected from the group consisting of LiₐLa_{b}Zr_{c}Al_{d}Me″ₑO_{f} wherein 5<a<7.7; 2<b<4; 0<c<2.5; 0<d<2.5; 0≤e<2.5, 10<f<14, and wherein Me″ is a metal selected from the group consisting of Nb, Ta, V, W, Mo, and Sb.

In some embodiments, including any of the foregoing, the bulk, but not the surface, of the lithium-stuffed garnet layer is characterized by a formula selected from the group consisting of LiₐLa_{b}Zr_{c}Al_{d}O_{f} wherein 5<a<7.7; 2<b<4; 0<c<2.5; 0<d<2.5; 10<f<14.

In some embodiments, including any of the foregoing, the bulk, but not the surface, of the lithium-stuffed garnet layer is characterized by a formula selected from the group consisting of LiₐLa_{b}Z_{rc}Al_{d}Me″ₑO_{f} wherein 5<a<7.7; 2<b<4; 0<c<2.5; 0<d<2; 0<e<2, 10<f<14, and wherein Me″ is a metal selected from the group consisting of Nb, Ta, V, W, Mo, and Sb.

In some embodiments, including any of the foregoing, the bulk, but not the surface, of the lithium-stuffed garnet layer is characterized by a formula selected from the group consisting of LiₐLa_{b}Zr_{c}Al_{d}O_{f} wherein 5<a<7.7; 2<b<4; 0<c<2.5; 0<d<2; 10<f<14.

In some embodiments, including any of the foregoing, the bulk, but not the surface, of the lithium-stuffed garnet layer is characterized by a formula selected from the group consisting of LiₓLa₃Zr₂O₁₂.35Al₂O₃ wherein 4<x<8.5.

In some embodiments, including any of the foregoing, the bulk, but not the surface, of the lithium-stuffed garnet layer is characterized by a formula selected from the group consisting of LiₓLa₃Zr₂O₁₂.5Al₂O₃ wherein 4<x<8.5.

In some embodiments, including any of the foregoing, the bulk, but not the surface, of the lithium-stuffed garnet layer is characterized by a formula selected from the group consisting of LiₓLa₃Zr₂O₁₂.65Al₂O₃ wherein 4<x<8.5.

In some embodiments, including any of the foregoing, the bulk, but not the surface, of the lithium-stuffed garnet layer is characterized by a formula selected from the group consisting of LiₓLa₃Zr₂O₁₂·Al₂O₃ wherein 4<x<8.5.

In some embodiments, including any of the foregoing, the bulk, but not the surface, of the lithium-stuffed garnet layer is characterized by about Li₆La₃Zr₂O₁₂Al_{1/3}; about Li_{6.25}La₃Zr₂O₁₂Al_{0.25}; about Li₄La₃Zr₂O₁₂Al₁; about Li_{6.7}La₃Zr₂O₁₂Al_{0.3}; or about Li₇La₃Zr₂O₁₂.

In some embodiments, including any of the foregoing, the bulk, but not the surface, of the lithium-stuffed garnet layer is polycrystalline.

In some embodiments, the bilayer comprises H₃PO₄ and/or its conjugate base, H₂PO₄⁻, and/or ions thereof, PO₄³⁻ and/or PO₄²⁻, incorporated into or bonded to the bilayer. In some embodiments, the bilayer comprises H₃PO₄ and/or its conjugate base, H₂PO₄, and/or ions thereof, PO₄³⁻ and/or PO₄²⁻, incorporated into or bonded to the surface of the lithium-stuffed garnet layer of the bilayer.

In some embodiments, the bilayer comprises H₂TiF₆ and/or its ion thereof, TiF₆²⁻, incorporated into or bonded to the bilayer. In some embodiments, the bilayer comprises H₃PO₄ and/or its conjugate base, H₂TiF₆ and/or its ion thereof, TiF₆²⁻, incorporated into or bonded to the surface of the lithium-stuffed garnet layer of the bilayer.

In some embodiments, the bilayer comprises HCl and/or its conjugate base, Cl⁻, incorporated into or bonded to the bilayer. In some embodiments, the bilayer comprises HCl and/or its conjugate base, Cl⁻, incorporated into or bonded to the surface of the lithium-stuffed garnet layer of the bilayer.

In some embodiments, the bilayer comprises H₂SO₄ and/or its conjugate base, HSO₄⁻, and/or ions thereof, SO₄⁻ and/or SO₄⁻, incorporated into or bonded to the bilayer. In some embodiments, the bilayer comprises H₂SO₄ and/or its conjugate base, HSO₄⁻, and/or ions thereof, SO₄⁻ and/or SO₄⁻, incorporated into or bonded to the surface of the lithium-stuffed garnet layer of the bilayer.

In some embodiments, the bilayer comprises H₃BO₃ and/or its conjugate base, B(OH)₄⁻, and/or its ion thereof, BH₂O³⁻, incorporated into or bonded to the bilayer. In some embodiments, the bilayer comprises H₃BO₃ and/or its conjugate base, B(OH)₄⁻, and/or its ion thereof, BH₂O³⁻, incorporated into or bonded to the surface of the lithium-stuffed garnet layer of the bilayer.

In some embodiments, the bilayer comprises H₂ZrF₆ and/or its ion, ZrF₆²⁻, thereof incorporated into or bonded to the bilayer. In some embodiments, the bilayer comprises H₂ZrF₆ and/or its ion, ZrF₆²⁻, thereof incorporated into or bonded to the surface of the lithium-stuffed garnet layer of the bilayer.

In some embodiments, the bilayer comprises a phosphorous-containing layer of Li₃PO₄, LiH₂PO₄, Li₂HPO₄, Li(CH₃)₂PO₄ (i.e., lithium dimethylphosphate), Li₂(CH₃)PO₄ (i.e, dilithium methylphosphate), Li₄P₂O₇, or combinations thereof. In some embodiments, the lithium-stuffed garnet layer of the bilayer following (c), comprises a phosphorous-containing layer of Li₃PO₄, LiH₂PO₄, Li₂HPO₄, Li(CH₃)₂PO₄, Li₂(CH₃)PO₄, Li₄P₂O₇, or combinations thereof.

In some embodiments, the bilayer comprises Li₃PO₄. In some embodiments, the bilayer comprises LiH₂PO₄. In some embodiments, the bilayer comprises Li₂HPO₄. In some embodiments, the bilayer comprises Li(CH₃)₂PO₄. In some embodiments, the bilayer comprises Li₂(CH₃)PO₄. In some embodiments, the lithium-stuffed garnet layer of the bilayer comprises Li₃PO₄. In some embodiments, the lithium-stuffed garnet layer of the bilayer comprises LiH₂PO₄. In some embodiments, the lithium-stuffed garnet layer of the bilayer comprises Li₂HPO₄. In some embodiments, the lithium-stuffed garnet layer of the bilayer comprises Li(CH₃)₂PO₄. In some embodiments, the lithium-stuffed garnet layer of the bilayer comprises Li₂(CH₃)PO₄.

In some embodiments, the bilayer comprises a partial phosphorous-containing layer of Li₃PO₄, LiH₂PO₄, Li₂HPO₄, Li(CH₃)₂PO₄, Li₂(CH₃)PO₄, Li₄P₂O₇, or combinations thereof. In some embodiments, the lithium-stuffed garnet layer of the bilayer comprises a partial phosphorous-containing layer of Li₃PO₄, LiH₂PO₄, Li₂HPO₄, Li(CH₃)₂PO₄, Li₂(CH₃)PO₄, Li₄P₂O₇, or combinations thereof.

In some embodiments, the bilayer comprises a continuous phosphorous-containing layer of Li₃PO₄, LiH₂PO₄, Li₂HPO₄, Li(CH₃)₂PO₄, Li₂(CH₃)PO₄, Li₄P₂O₇, or combinations thereof. In some embodiments, the lithium-stuffed garnet layer of the bilayer comprises a continuous phosphorous-containing layer of Li₃PO₄, LiH₂PO₄, Li₂HPO₄, Li(CH₃)₂PO₄, Li₂(CH₃)PO₄, Li₄P₂O₇, or combinations thereof.

In some embodiments, the bilayer comprises a discontinuous phosphorous-containing layer of Li₃PO₄, LiH₂PO₄, Li₂HPO₄, Li(CH₃)₂PO₄, Li₂(CH₃)PO₄, Li₄P₂O₇, or combinations thereof. In some embodiments, the lithium-stuffed garnet layer of the bilayer comprises a discontinuous phosphorous-containing layer of Li₃PO₄, LiH₂PO₄, Li₂HPO₄, Li(CH₃)₂PO₄, Li₂(CH₃)PO₄, Li₄P₂O₇, or combinations thereof.

In some embodiments, the bilayer comprises a member selected from the group consisting of phosphorus, titanium, chloride, chlorine, sulfur, boron, zirconium, and a combination thereof greater than about 0.05 atomic percent as measured by X-ray photo-electron spectroscopy (XPS). In some embodiments, the lithium-stuffed garnet layer of the bilayer comprises a member selected from the group consisting of phosphorus, titanium, chloride, chlorine, sulfur, boron, zirconium, and a combination thereof greater than about 0.05 atomic percent as measured by X-ray photo-electron spectroscopy (XPS).

In some embodiments, the bilayer comprises a member selected from the group consisting of phosphorus, titanium, chloride, chlorine, sulfur, boron, zirconium, and a combination thereof greater than about 0.1 atomic percent or greater than about 0.2 atomic percent as measured by XPS. In some embodiments, the lithium-stuffed garnet layer of the bilayer comprises a member selected from the group consisting of phosphorus, titanium, chloride, chlorine, sulfur, boron, zirconium, and a combination thereof greater than about 0.1 atomic percent or greater than about 0.2 atomic percent as measured by XPS.

In some embodiments, the bilayer comprises an amount of phosphorus greater than about 0.05 atomic percent, greater than about 0.1 atomic percent or greater than about 0.2 atomic percent as measured by XPS. In some embodiments, the lithium-stuffed garnet layer of the bilayer comprises an amount of phosphorus greater than about 0.05 atomic percent, greater than about 0.1 atomic percent or greater than about 0.2 atomic percent as measured by XPS.

In some embodiments, the bilayer comprises an amount of titanium greater than about 0.05 atomic percent, greater than about 0.1 atomic percent or greater than about 0.2 atomic percent as measured by XPS. In some embodiments, the lithium-stuffed garnet layer of the bilayer comprises an amount of titanium greater than about 0.05 atomic percent, greater than about 0.1 atomic percent or greater than about 0.2 atomic percent as measured by XPS.

In some embodiments, the bilayer comprises an amount of chloride or chlorine or combinations thereof greater than about 0.05 atomic percent, greater than about 0.1 atomic percent or greater than about 0.2 atomic percent as measured by XPS. In some embodiments, the lithium-stuffed garnet layer of the bilayer comprises an amount of chloride or chlorine or combinations thereof greater than about 0.05 atomic percent, greater than about 0.1 atomic percent or greater than about 0.2 atomic percent as measured by XPS.

In some embodiments, the bilayer comprises an amount of sulfur greater than about 0.05 atomic percent, greater than about 0.1 atomic percent or greater than about 0.2 atomic percent as measured by XPS. In some embodiments, the lithium-stuffed garnet layer of the bilayer comprises an amount of sulfur greater than about 0.05 atomic percent, greater than about 0.1 atomic percent or greater than about 0.2 atomic percent as measured by XPS.

In some embodiments, the bilayer comprises an amount of boron greater than about 0.05 atomic percent, greater than about 0.1 atomic percent or greater than about 0.2 atomic percent as measured by XPS. In some embodiments, the lithium-stuffed garnet layer of the bilayer comprises an amount of boron greater than about 0.05 atomic percent, greater than about 0.1 atomic percent or greater than about 0.2 atomic percent as measured by XPS.

In some embodiments, the bilayer comprises an amount of zirconium greater than about 0.05 atomic percent, greater than about 0.1 atomic percent or greater than about 0.2 atomic percent as measured by XPS. In some embodiments, the lithium-stuffed garnet layer of the bilayer comprises an amount of zirconium greater than about 0.05 atomic percent, greater than about 0.1 atomic percent or greater than about 0.2 atomic percent as measured by XPS.

In some embodiments, the bilayer comprises a member selected from the group consisting of phosphorus, titanium, chloride, chlorine, sulfur, boron, zirconium, and a combination thereof at a depth of penetration of about 1 μm to 20 μm as measured by XPS. In some embodiments, the lithium-stuffed garnet layer of the bilayer comprises a member selected from the group consisting of phosphorus, titanium, chloride, chlorine, sulfur, boron, zirconium, and a combination thereof at a depth of penetration of about 1 μm to 20 μm as measured by XPS.

In some embodiments, the bilayer comprises a member selected from the group consisting of phosphorus, titanium, chloride, chlorine, sulfur, boron, zirconium, and a combination thereof at a depth of penetration of about 1 μm to 2 μm as measured by XPS. In some embodiments, the lithium-stuffed garnet layer of the bilayer comprises a member selected from the group consisting of phosphorus, titanium, chloride, chlorine, sulfur, boron, zirconium, and a combination thereof at a depth of penetration of about 1 μm to 2 μm as measured by XPS.

In some embodiments, the bilayer comprises a member selected from the group consisting of phosphorus, titanium, chloride, chlorine, sulfur, boron, zirconium, and a combination thereof at a depth of penetration of about 1 μm to 5 μm as measured by XPS. In some embodiments, the lithium-stuffed garnet layer of the bilayer comprises a member selected from the group consisting of phosphorus, titanium, chloride, chlorine, sulfur, boron, zirconium, and a combination thereof at a depth of penetration of about 1 μm to 5 μm as measured by XPS.

In some embodiments, the bilayer comprises a member selected from the group consisting of phosphorus, titanium, chloride, chlorine, sulfur, boron, zirconium, and a combination thereof at a depth of penetration of about 5 μm to 10 μm as measured by XPS. In some embodiments, the lithium-stuffed garnet layer of the bilayer comprises a member selected from the group consisting of phosphorus, titanium, chloride, chlorine, sulfur, boron, zirconium, and a combination thereof at a depth of penetration of about 5 μm to 10 μm as measured by XPS.

In some embodiments, the bilayer comprises a member selected from the group consisting of phosphorus, titanium, chloride, chlorine, sulfur, boron, zirconium, and a combination thereof at a depth of penetration of about 10 μm to 15 μm as measured by XPS. In some embodiments, the lithium-stuffed garnet layer of the bilayer comprises a member selected from the group consisting of phosphorus, titanium, chloride, chlorine, sulfur, boron, zirconium, and a combination thereof at a depth of penetration of about 10 μm to 15 μm as measured by XPS.

In some embodiments, the bilayer comprises a member selected from the group consisting of phosphorus, titanium, chloride, chlorine, sulfur, boron, zirconium, and a combination thereof at a depth of penetration of about 15 μm to 20 μm as measured by XPS. In some embodiments, the lithium-stuffed garnet layer of the bilayer comprises a member selected from the group consisting of phosphorus, titanium, chloride, chlorine, sulfur, boron, zirconium, and a combination thereof at a depth of penetration of about 15 μm to 20 μm as measured by XPS.

In some embodiments, the bilayer comprises a member selected from the group consisting of phosphorus at a depth of penetration of about 1 μm to 20 μm as measured by XPS. In some embodiments, the lithium-stuffed garnet layer of the bilayer comprises a member selected from the group consisting of phosphorus at a depth of penetration of about 1 μm to 20 μm as measured by XPS.

In some embodiments, the bilayer comprises an amount of phosphorus at a depth of penetration of about 1 μm to 2 μm, about 1 μm to 5 μm, or about 1 μm to 10 μm as measured by XPS. In some embodiments, the lithium-stuffed garnet layer of the bilayer comprises an amount of phosphorus at a depth of penetration of about 1 μm to 2 μm, about 1 μm to 5 μm, or about 1 μm to 10 μm as measured by XPS.

In some embodiments, the bilayer comprises an amount of titanium at a depth of penetration of about 1 μm to 20 μm as measured by XPS. In some embodiments, the lithium-stuffed garnet layer of the bilayer comprises an amount of titanium at a depth of penetration of about 1 μm to 20 μm as measured by XPS.

In some embodiments, the bilayer comprises an amount of titanium at a depth of penetration of about 1 μm to 2 μm, about 1 μm to 5 μm, or about 1 μm to 10 μm as measured by XPS. In some embodiments, the lithium-stuffed garnet layer of the bilayer comprises an amount of titanium at a depth of penetration of about 1 μm to 2 μm, about 1 μm to 5 μm, or about 1 μm to 10 μm as measured by XPS.

In some embodiments, the bilayer comprises an amount of chloride or chlorine or combinations thereof at a depth of penetration of about 1 μm to 20 μm as measured by XPS. In some embodiments, the lithium-stuffed garnet layer of the bilayer comprises an amount of chloride or chlorine or combinations thereof at a depth of penetration of about 1 μm to 20 μm as measured by XPS.

In some embodiments, the bilayer comprises an amount of chloride or chlorine or combinations thereof at a depth of penetration of about 1 μm to 2 μm, about 1 μm to 5 μm, or about 1 μm to 10 μm as measured by XPS. In some embodiments, the lithium-stuffed garnet layer of the bilayer comprises an amount of chloride or chlorine or combinations thereof at a depth of penetration of about 1 μm to 2 μm, about 1 μm to 5 μm, or about 1 μm to 10 μm as measured by XPS.

In some embodiments, the bilayer comprises an amount of sulfur at a depth of penetration of about 1 μm to 20 μm as measured by X-ray photo-electron spectroscopy. In some embodiments, the lithium-stuffed garnet layer of the bilayer comprises an amount of sulfur at a depth of penetration of about 1 μm to 20 μm as measured by X-ray photo-electron spectroscopy.

In some embodiments, the bilayer comprises an amount of sulfur at a depth of penetration of about 1 μm to 2 μm, about 1 μm to 5 μm, or about 1 μm to 10 μm as measured by XPS. In some embodiments, the lithium-stuffed garnet layer of the bilayer comprises an amount of sulfur at a depth of penetration of about 1 μm to 2 μm, about 1 μm to 5 μm, or about 1 μm to 10 μm as measured by XPS.

In some embodiments, the bilayer comprises an amount of boron at a depth of penetration of about 1 μm to 20 μm as measured by XPS. In some embodiments, the lithium-stuffed garnet layer of the bilayer comprises an amount of boron at a depth of penetration of about 1 μm to 20 μm as measured by XPS.

In some embodiments, the bilayer comprises an amount of boron at a depth of penetration of about 1 μm to 2 μm, about 1 μm to 5 μm, or about 1 μm to 10 μm as measured by XPS. In some embodiments, the lithium-stuffed garnet layer of the bilayer comprises an amount of boron at a depth of penetration of about 1 μm to 2 μm, about 1 μm to 5 μm, or about 1 μm to 10 μm as measured by XPS.

In some embodiments, the bilayer comprises an amount of zirconium at a depth of penetration of about 1 μm to 20 μm as measured by XPS. In some embodiments, the lithium-stuffed garnet layer of the bilayer comprises an amount of zirconium at a depth of penetration of about 1 μm to 20 μm as measured by XPS.

In some embodiments, the bilayer comprises an amount of zirconium at a depth of penetration of about 1 μm to 2 μm, about 1 μm to 5 μm, or about 1 μm to 10 μm as measured by XPS. In some embodiments, the lithium-stuffed garnet layer of the bilayer comprises an amount of zirconium at a depth of penetration of about 1 μm to 2 μm, about 1 μm to 5 μm, or about 1 μm to 10 μm as measured by XPS.

In some embodiments, the bilayer comprises an amount of fluoride or fluorine or combinations thereof at a depth of penetration of less than 1 μm as measured by XPS. In some embodiments, the lithium-stuffed garnet layer of the bilayer comprises an amount of fluoride or fluorine or combinations thereof at a depth of penetration of less than 1 μm as measured by XPS.

In some embodiments, the bilayer has less than about 5 atomic percent of lithium carbonate as measured by XPS. In some embodiments, the lithium-stuffed garnet layer of the bilayer has less than about 5 atomic percent of lithium carbonate as measured by XPS. In some embodiments, the bilayer has less than about 3 atomic percent of lithium carbonate as measured by XPS. In some embodiments, the lithium-stuffed garnet layer of the bilayer has less than about 3 atomic percent of lithium carbonate as measured by XPS. In some embodiments, the bilayer has less than about 1 atomic percent of lithium carbonate as measured by XPS. In some embodiments, the lithium-stuffed garnet layer of the bilayer has less than about 1 atomic percent of lithium carbonate as measured by XPS. In some embodiments, the bilayer has less than about 0.5 atomic percent of lithium carbonate as measured by XPS. In some embodiments, the lithium-stuffed garnet layer of the bilayer has less than about 0.5 atomic percent of lithium carbonate as measured by XPS. In some embodiments, the bilayer has less than about 0.25 atomic percent of lithium carbonate as measured by XPS. In some embodiments, the lithium-stuffed garnet layer of the bilayer has less than about 0.25 atomic percent of lithium carbonate as measured by XPS.

In some embodiments, the bilayer following, is characterized by an atomic percent ratio of P to Zr about 1 to 15.0 as measured by XPS. In some embodiments, the bilayer, is characterized by an atomic percent ratio of P to Zr about 1.5 to 10 as measured by XPS. In some embodiments, the bilayer, is characterized by an atomic percent ratio of P to Zr about 1.5 to 5 as measured by XPS. In some embodiments, the bilayer, is characterized by an atomic percent ratio of P to Zr about 1.5 to 3 as measured by XPS. In some embodiments, the lithium-stuffed garnet layer of the bilayer, is characterized by an atomic percent ratio of P to Zr about 1 to 15.0 as measured by XPS. In some embodiments, the lithium-stuffed garnet layer of the bilayer, is characterized by an atomic percent ratio of P to Zr about 1.5 to 10 as measured by XPS. In some embodiments, the lithium-stuffed garnet layer of the bilayer, is characterized by an atomic percent ratio of P to Zr about 1.5 to 5 as measured by XPS. In some embodiments, the lithium-stuffed garnet layer of the bilayer, is characterized by an atomic percent ratio of P to Zr about 1.5 to 3 as measured by XPS.

In some embodiments, the bilayer is characterized by an atomic percent ratio of S to Zr about 0 to 3 as measured by XPS. In some embodiments, the bilayer is characterized by an atomic percent ratio of S to Zr about 0 to 1 as measured by XPS.

In some embodiments, the bilayer is characterized by an atomic percent ratio of the functional group CO₃ to Zr of less than about 1, but greater than 0, as measured by XPS.

In some embodiments, the bilayer has an ASR of less than about 65 Ω-cm², but greater than 5 Ω-cm² at 25° C. In some embodiments, the bilayer has an ASR of less than about 60 Ω-cm², but greater than 5 Ω-cm² at 25° C. In some embodiments, the bilayer has an ASR of less than about 55 Ω-cm², but greater than 5 Ω-cm² at 25° C. In some embodiments, the bilayer has an ASR of less than about 50 Ω-cm², but greater than 5 Ω-cm² at 25° C. In some embodiments, the bilayer has an ASR of less than about 45 Ω-cm², but greater than 5 Ω-cm² at 25° C. In some embodiments, the bilayer has an ASR of less than about 40 Ω-cm², but greater than 5 Ω-cm² at 25° C. In some embodiments, the bilayer has an ASR of less than about 35 Ω-cm², but greater than 5 Ω-cm² at 25° C. In some embodiments, the bilayer has an ASR of less than about 30 Ω-cm², but greater than 5 Ω-cm² at 25° C. In some embodiments, the bilayer has an ASR of less than about 25 Ω-cm², but greater than 5 Ω-cm² at 25° C. In some embodiments, the bilayer has an ASR of less than about 20 Ω-cm², but greater than 5 Ω-cm² at 25° C. In some embodiments, the bilayer has an ASR of less than about 15 Ω-cm², but greater than 5 Ω-cm² at 25° C. In some embodiments, the bilayer has an ASR of less than about 10 Ω-cm², but greater than 5 Ω-cm² at 25° C.

In some embodiments, the bilayer is kept at a resting voltage of 4.25 V or 4.35 V, during after a high temperature high voltage (HTHV) test at 60° C. for 1 month. In some embodiments, the bilayer is kept at a resting voltage of 4.25 V, during after a high temperature high voltage (HTHV) test at 60° C. for 1 month. In some embodiments, the bilayer is kept at a resting voltage of 4.35 V, during after a high temperature high voltage (HTHV) test at 60° C. for 1 month.

In some embodiments, the bilayer has an ASR of less than about 65 Ω-cm², but greater than 5 Ω-cm² at 25° C. after a high temperature high voltage (HTHV) test at 60° C. for 1 month. In some embodiments, the bilayer has an ASR of less than about 60 Ω-cm², but greater than 5 Ω-cm² at 25° C. after a HTHV test at 60° C. for 1 month. In some embodiments, the bilayer has an ASR of less than about 55 Ω-cm², but greater than 5 Ω-cm² at 25° C. after a HTHV test at 60° C. for 1 month. In some embodiments, the bilayer has an ASR of less than about 50 Ω-cm², but greater than 5 Ω-cm² at 25° C. after a HTHV test at 60° C. for 1 month. In some embodiments, the bilayer has an ASR of less than about 45 Ω-cm², but greater than 5 Ω-cm² at 25° C. after a HTHV test at 60° C. for 1 month. In some embodiments, the bilayer has an ASR of less than about 40 Ω-cm², but greater than 5 Ω-cm² at 25° C. after a HTHV test at 60° C. for 1 month. In some embodiments, the bilayer has an ASR of less than about 35 Ω-cm², but greater than 5 Ω-cm² at 25° C. after a HTHV test at 60° C. for 1 month. In some embodiments, the bilayer has an ASR of less than about 30 Ω-cm², but greater than 5 Ω-cm² at 25° C. after a HTHV test at 60° C. for 1 month. In some embodiments, the bilayer has an ASR of less than about 25 Ω-cm², but greater than 5 Ω-cm² at 25° C. after a HTHV test at 60° C. for 1 month. In some embodiments, the bilayer has an ASR of less than about 20 Ω-cm², but greater than 5 Ω-cm² at 25° C. after a HTHV test at 60° C. for 1 month. In some embodiments, the bilayer has an ASR of less than about 15 Ω-cm², but greater than 5 Ω-cm² at 25° C. after a HTHV test at 60° C. for 1 month. In some embodiments, the bilayer has an ASR of less than about 10 Ω-cm², but greater than 5 Ω-cm² at 25° C. after a HTHV test at 60° C. for 1 month. In some embodiments, the bilayer experiences less than about a 10% increase in ASR at 25° C. after a high temperature high voltage (HTHV) test at 60° C. for 1 month. In some embodiments, the bilayer does not experience more than about a 10% increase in ASR at 25° C. after a HTHV test at 60° C. for 1 month. In some embodiments, the bilayer does not experience more than about a 15% increase in ASR at 25° C. after a HTHV test at 60° C. for 1 month. In some embodiments, the bilayer does not experience more than about a 20% increase in ASR at 25° C. after a HTHV test at 60° C. for 1 month.

In some embodiments, including any of the foregoing, the top and/or bottom surface of the lithium-stuffed garnet thin film does not experience more than about a 25% increase in ASR at 25° C. after a HTHV test at 60° C. for 1 month. In some embodiments, the bilayer does not experience more than about a 30% increase in ASR at 25° C. after a HTHV test at 60° C. for 1 month. In some embodiments, the bilayer does not experience more than about a 35% increase in ASR at 25° C. after a HTHV test at 60° C. for 1 month. In some embodiments, the bilayer does not experience more than about a 40% increase in ASR at 25° C. after a HTHV test at 60° C. for 1 month. In some embodiments, the bilayer does not experience more than about a 45% increase in ASR at 25° C. after a HTHV test at 60° C. for 1 month. In some embodiments, the bilayer does not experience more than about a 50% increase in ASR at 25° C. after a HTHV test at 60° C. for 1 month. In some embodiments, the bilayer does not experience more than about a 55% increase in ASR at 25° C. after a HTHV test at 60° C. for 1 month. In some embodiments, the bilayer does not experience more than about a 60% increase in ASR at 25° C. after a HTHV test at 60° C. for 1 month. In some embodiments, the bilayer does not experience more than about a 65% increase in ASR at 25° C. after a HTHV test at 60° C. for 1 month. In some embodiments, the bilayer does not experience more than about a 70% increase in ASR at 25° C. after a HTHV test at 60° C. for 1 month.

In some embodiments, including any of the foregoing, the low ASR is sustained for at least about one month, at least about two months, at least about three months, at least about 4 months, at least about six months, at least about nine months, at least about one year, or more.

In some embodiments, including any of the foregoing, the ASR of the bilayer does not vary by more than 10% over a surface area of at least 10 mm².

In some embodiments, including any of the foregoing, the ASR of the bilayer does not vary by more than 10% as a function of time for at least one day.

In some embodiments, including any of the foregoing, the ASR of the bilayer does not vary by more than 10% as a function of time for at least one month.

In some embodiments, including any of the foregoing, the ASR of the bilayer does not vary by more than 10% as a function of time for at least six months.

In some embodiments, including any of the foregoing, ASR of the bilayer does not vary by more than 10% as a function of time for at least one year.

In some embodiments, including any of the foregoing, the ASR of the bilayer after exposure to ambient conditions did not increase by more than 10%.

In some embodiments, including any of the foregoing, the ASR of the bilayer does not vary by more than 20% over a surface area of at least 10 mm².

In some embodiments, including any of the foregoing, the ASR of the bilayer does not vary by more than 20% as a function of time for at least one day.

In some embodiments, including any of the foregoing, the ASR of the bilayer does not vary by more than 20% as a function of time for at least one month.

In some embodiments, including any of the foregoing, the ASR of the bilayer does not vary by more than 20% as a function of time for at least six months.

In some embodiments, including any of the foregoing, the ASR of the bilayer does not vary by more than 20% as a function of time for at least one year.

In some embodiments, including any of the foregoing, the ASR of the bilayer after exposure to ambient conditions did not increase by more than 20%.

In some embodiments, including any of the foregoing, the ASR of the bilayer does not vary by more than 30% over a surface area of at least 10 mm². In some embodiments, including any of the foregoing, ASR of the bilayer does not vary by more than 30% as a function of time for at least one year. In some embodiments, including any of the foregoing, the ASR of the bilayer after exposure to ambient conditions did not increase by more than 30%. In some embodiments, including any of the foregoing, the ASR of the bilayer does not vary by more than 40% over a surface area of at least 10 mm². In some embodiments, including any of the foregoing, ASR of the bilayer does not vary by more than 40% as a function of time for at least one year. In some embodiments, including any of the foregoing, the ASR of the bilayer after exposure to ambient conditions did not increase by more than 40%. In some embodiments, including any of the foregoing, the ASR of the bilayer does not vary by more than 50% over a surface area of at least 10 mm². In some embodiments, including any of the foregoing, ASR of the bilayer does not vary by more than 50% as a function of time for at least one year. In some embodiments, including any of the foregoing, the ASR of the bilayer after exposure to ambient conditions did not increase by more than 50%. In some embodiments, including any of the foregoing, the ASR of the bilayer does not vary by more than 60% over a surface area of at least 10 mm². In some embodiments, including any of the foregoing, ASR of the bilayer does not vary by more than 60% as a function of time for at least one year. In some embodiments, including any of the foregoing, the ASR of the bilayer after exposure to ambient conditions did not increase by more than 60%. In some embodiments, including any of the foregoing, the ASR of the bilayer does not vary by more than 70% over a surface area of at least 10 mm². In some embodiments, including any of the foregoing, ASR of the bilayer does not vary by more than 70% as a function of time for at least one year. In some embodiments, including any of the foregoing, the ASR of the bilayer after exposure to ambient conditions did not increase by more than 70%.

In some embodiments, the bilayer is characterized by an atomic percent ratio of the functional group CO₃ to Zr of less than about 1, but greater than 0, as measured by XPS one week following a high temperature high voltage (HTHV) test at 60° C. for 1 month.

In some embodiments, the thickness of the lithium carbonate on the surface of the bilayer is about 1 nm to 500 nm prior to acid treatment. In some embodiments, the thickness of the lithium carbonate on the surface of the lithium-stuffed garnet layer of the bilayer is about 1 nm to 500 nm prior to acid treatment.

In some embodiments, the thickness of the lithium carbonate on the surface of the bilayer is about 1 nm to 50 nm post acid treatment. In some embodiments, the thickness of the lithium carbonate on the surface of the lithium-stuffed garnet layer of the bilayer is about 1 nm to 50 nm post to acid treatment.

### Devices and Vehicles

Also provided herein are electrochemical devices that comprise a bilayer described herein. In one embodiment, the electrochemical device is an electrochemical cell. In one embodiment, the electrochemical device is a rechargeable battery.

Also provided herein are electric vehicles that comprise an electrochemical device or rechargeable battery comprising a bilayer described herein.

### Continuous Bilayer Treatment Line

In an aspect set forth herein is a continuous bilayer treatment line comprising: a front roller unto which is wound a bilayer, wherein the bilayer comprises a metal foil or metal powder layer, and a lithium-stuffed garnet layer; wherein the metal layer contacts the front roller; an end roller; at least one acid treatment section between the front roller and the end roller comprising: a reservoir or a dispense unit; wherein the reservoir or the dispense unit is suspended on top of the bilayer; and wherein the reservoir or the dispense unit contains a solution comprising an acid source at a concentration of about 10 ppm to 5500 ppm. In some embodiments, the metal foil of the bilayer comprises pure nickel. In some embodiments, the metal foil of the bilayer comprises a nickel alloy. In some embodiments, the nickel alloy comprises nickel and iron. In some embodiments, the nickel alloy comprises an 85:15 ratio of nickel to iron. In some embodiments, the nickel alloy comprises an 88:12 ratio of nickel to iron.

In some embodiments, the bilayer is sintered. In some embodiments, the bilayer comprises a sintered lithium-stuffed garnet layer.

In some embodiments, the continuous bilayer treatment line further comprises a conveyor. In some embodiments, the continuous bilayer treatment line further comprises a magnetic sheet. In some embodiments, the continuous bilayer treatment line further comprises a conveyor and a magnetic sheet. In some embodiments, the magnetic sheet comprises a plurality of magnets. In some embodiments, the bilayer sits on top of the conveyor. In some embodiments, the bilayer sits on top of and contacts the conveyor. In some embodiments, the magnetic sheet sits beneath the conveyor. In some embodiments, the magnetic sheet sits beneath and contacts the conveyor.

In some embodiments, the continuous bilayer treatment line further comprises a first rinsing section. In some embodiments, the continuous bilayer treatment line further comprises a first rinsing section and a second rinsing section.

In some embodiments, the continuous bilayer treatment line further comprises a drying section. In some embodiments, the bilayer is configured to move through the bilayer treatment line.

In some embodiments, including any of the foregoing, the acid source comprises an acid, and/or its conjugate base, and/or dissolved ions thereof, selected from the group consisting of:
(a) H₃PO₄ and/or H₂PO₄⁻ and/or PO₄³⁻ and/or PO₄²⁻;
(b) H₂SO₄ and/or HSO₄⁻ and/or SO₄⁻ and/or SO₄⁻;
(c) HCl and/or Cl⁻;
(d) H₃BO₃ and/or B(OH)₄⁻ and/or BH₂O³⁻;
(e) H₂TiF₆ and/or TiF₆²⁻;
(f) H₂ZrF₆ and/or ZrF₆²⁻; and
(g) combinations thereof.

In one embodiment, including any of the foregoing, the acid source further comprises water.

In one embodiment, including any of the foregoing, the acid source comprises H₃PO₄ and/or H₂PO₄ and/or PO₄³⁻ and/or PO₄²⁻. In one embodiment, including any of the foregoing, the acid source comprises H₃PO₄ and/or H₂PO₄ and/or PO₄³⁻ and/or PO₄²⁻ in an aqueous solution. In one embodiment, including any of the foregoing, the acid source comprises H₃PO₄ and/or H₂PO₄⁻ and/or PO₄³⁻ and/or PO₄²⁻ in an aqueous solution wherein the concentration is about 85 wt %.

In some embodiments, the concentration of the acid sources in the solution is about 10 ppm to about 5500 ppm,

In one embodiment, including any of the foregoing, the concentration of the acid source in the solution is about 10 ppm to about 1000 ppm, about 100 ppm to about 800 ppm, about 250 ppm to about 750 ppm, or about 400 ppm to about 600 ppm.

In one embodiment, including any of the foregoing, the concentration of the acid source in the solution is about 10 ppm to 50 ppm, about 50 ppm to 100 ppm, about 100 ppm to 300 ppm, about 300 ppm to 500 ppm, about 500 ppm to 700 ppm, or about 700 ppm to 1000 ppm.

In one embodiment, including any of the foregoing, the concentration of the acid source in the solution is about 10 ppm to 25 ppm, about 20 ppm to 40 ppm, about 30 ppm to 50 ppm, about 40 ppm to 60 ppm, or about 45 ppm to 65 ppm. In one embodiment, including any of the foregoing, the concentration of the acid source in the solution is about 300 ppm to 400 ppm, about 350 ppm to 450 ppm, about 400 ppm to 500 ppm, about 450 ppm to 550 ppm, or about 450 ppm to 600 ppm. In one embodiment, including any of the foregoing, the concentration of the acid source in the solution is about 1000 ppm to 5500 ppm, about 2000 ppm to 5500 ppm, about 3000 ppm to 5500 ppm, or about 4000 ppm to 5500 ppm. In some embodiments, the concentration of the acid source in the solution is about 1000 ppm to 2000 ppm, about 1500 ppm to 2500 ppm, about 2000 ppm to 3000 ppm, about 2500 ppm to 3500 ppm, about 3000 ppm to 4000 ppm, about 3500 ppm to 4500 ppm, about 4000 to 5000 ppm, about 4500 ppm to 5500 ppm.

In some embodiments, the concentration of the acid source in the solution is about 1000-5000 ppm.

In one embodiment, including any of the foregoing, the solution comprises an acid source wherein the acid source comprises a member selected from the group consisting of H₃PO₄, H₂TiF₆, HCl, H₂SO₄, H₃BO₃, H₂ZrF₆ and a combination thereof, and the concentration of the acid source in the acidic solution is about 10 ppm to 25 ppm, about 20 ppm to 40 ppm about 30 ppm to 50 ppm, about 40 ppm to 60 ppm, or about 45 ppm to 65 ppm. In one embodiment, including any of the foregoing, the solution comprises an acid source wherein the acid source comprises a member selected from the group consisting of H₃PO₄, H₂TiF₆, HCl, H₂SO₄, H₃BO₃, H₂ZrF₆ and a combination thereof, and the concentration of the acid source in the acidic solution is about 300 ppm to 400 ppm, about 350 ppm to 450 ppm, about 400 ppm to 500 ppm, about 450 ppm to 550 ppm, or about 450 ppm to 600 ppm. In one embodiment, including any of the foregoing, the solution comprises an acid source wherein the acid source comprises a member selected from the group consisting of H₃PO₄, H₂TiF₆, HCl, H₂SO₄, H₃BO₃, H₂ZrF₆ and a combination thereof, and the concentration of the acid source in the acidic solution is about 1000 ppm to 2000 ppm, about 1500 ppm to 2500 ppm, about 2000 ppm to 3000 ppm, about 2500 ppm to 3500 ppm, about 3000 ppm to 4000 ppm, about 3500 ppm to 4500 ppm, about 4000 to 5000 ppm, about 4500 ppm to 5500 ppm.

In one embodiment, including any of the foregoing, the acid source comprises H₃PO₄ and/or H₂PO₄⁻ and/or PO₄³⁻ and/or PO₄²⁻ and the concentration of the acid source in the solution is about 10 ppm to 25 ppm, about 20 ppm to 40 ppm, about 30 ppm to 50 ppm, about 40 ppm to 60 ppm, or about 45 ppm to 65 ppm. In one embodiment, including any of the foregoing, the acid source comprises H₃PO₄ and/or H₂PO₄⁻ and/or PO₄³⁻ and/or PO₄²⁻ and the concentration of the acid source in the solution is about 300 ppm to 400 ppm, about 350 ppm to 450 ppm, about 400 ppm to 500 ppm, about 450 ppm to 550 ppm, or about 450 ppm to 600 ppm. In one embodiment, including any of the foregoing, the acid source comprises H₃PO₄ and/or H₂PO₄⁻ and/or PO₄³⁻ and/or PO₄²⁻ and the concentration of the acid source in the solution is about 1000 ppm to 5500 ppm, about 2000 ppm to 5500 ppm, about 3000 ppm to 5500 ppm, or about 4000 ppm to 5500 ppm. In one embodiment, including any of the foregoing, the acid source comprises H₃PO₄ and/or H₂PO₄⁻ and/or PO₄³⁻ and/or PO₄²⁻ and the concentration of the acid source in the solution is about 1000 ppm to 2000 ppm, about 1500 ppm to 2500 ppm, about 2000 ppm to 3000 ppm, about 2500 ppm to 3500 ppm, about 3000 ppm to 4000 ppm, about 3500 ppm to 4500 ppm, about 4000 to 5000 ppm, about 4500 ppm to 5500 ppm.

In one embodiment, including any of the foregoing, the acid source comprises H₃PO₄ and/or H₂PO₄⁻ and/or PO₄³⁻ and/or PO₄²⁻ and the concentration of the acid source in the solution is about 50 ppm. In one embodiment, including any of the foregoing, the acid source comprises H₃PO₄ and/or H₂PO₄⁻ and/or PO₄³⁻ and/or PO₄²⁻ and the concentration of the acid source in the solution is about 500 ppm. In one embodiment, including any of the foregoing, the acid source comprises H₃PO₄ and/or H₂PO₄ and/or PO₄³⁻ and/or PO₄²⁻ and the concentration of the acid source in the solution is about 5000 ppm. In one embodiment, including any of the foregoing, the acid source comprises H₃PO₄ and/or H₂PO₄ and/or PO₄³⁻ and/or PO₄²⁻ and the concentration of the acid source in the solution is about 5500 ppm.

In one embodiment, including any of the foregoing, the acid source further comprises water. For example, in one embodiment, including any of the foregoing, the acid source comprises (1) H₃PO₄ and/or H₂PO₄⁻ and/or PO₄³⁻ and/or PO₄²⁻ and (2) water wherein the concentration of the acid source in the solution is about 10 ppm to 25 ppm, about 20 ppm to 40 ppm, about 30 ppm to 50 ppm, about 40 ppm to 60 ppm, or about 45 ppm to 65 ppm. In a further embodiment, including any of the foregoing, the acid source comprises (1) H₃PO₄ and/or H₂PO₄⁻ and/or PO₄³⁻ and/or PO₄²⁻ and (2) water wherein the concentration of the acid source in the solution is about 50 ppm.

In one embodiment, including any of the foregoing, the acid source further comprises water.

In some embodiments, including any of the foregoing, the solution comprises a solvent. In one embodiment, the solvent is selected from the group consisting of ethylene sulfite (ES), ethylene carbonate (EC), diethylene carbonate, dimethyl carbonate (DMC), ethyl-methyl carbonate (EMC), propylmethyl carbonate, nitroethyl carbonate, propylene carbonate (PC), diethyl carbonate (DEC), methyl propyl carbonate (MPC), 2,5-dioxahexanedioic acid dimethyl ester, tetrahydrofuran (THF), 7-butyrolactone (GBL), fluoroethylene carbonate (FEC), fluoromethyl ethylene carbonate (FMEC), trifluoroethyl methyl carbonate (F-EMC), fluorinated 3-(1,1,2,2-tetrafluoroethoxy)-1,1,2,2-tetrafluoropropane/1,1,2,2-tetrafluoro-3-(1,1,2,2-tetrafluoroethoxy)propane (F-EPE), fluorinated cyclic carbonate (F-AEC), dioxolane, prop-1-ene-1,3-sultone (PES), sulfolane, acetonitrile (ACN), succinonitrile (SCN), pimelonitrile, suberonitrile, propionitrile, propanedinitrile, glutaronitrile (GLN), adiponitrile (ADN), hexanedinitrile, pentanedinitrile, acetophenone, isophorone, benzonitrile, ethyl propionate, methyl propionate, methylene methanedisulfonate, dimethyl sulfate, dimethyl sulfoxide (DMSO), ethyl acetate, methyl butyrate, dimethyl ether (DME), diethyl ether, dioxolane, gamma butyl-lactone, methyl benzoate, 2-methyl-5-oxooxolane-2-carbonitrile, N,N-Dimethylformamide (DMF), N,N-Dimethylacetamide (DMAC) and combinations thereof. In some examples, the combinations of solvents are those combinations which are miscible.

In some embodiments, including any of the foregoing, the acidic solution comprises a solution described in PCT Application PCT/US2022/051433 filed Nov. 30, 2022, titled CATHOLYTES FOR A SOLID-STATE BATTERY, the entire contents of which are herein incorporated by reference in its entirety.

In some embodiments, including any of the foregoing, the solution comprises ethylene sulfite (ES). In some embodiments, including any of the foregoing, the solution comprises sulfolane.

In some embodiments, including any of the foregoing, the solution comprises a solvent selected from the group consisting of ethylene carbonate (EC), diethylene carbonate, dimethyl carbonate (DMC), ethyl-methyl carbonate (EMC), propylmethyl carbonate, nitroethyl carbonate, propylene carbonate (PC), diethyl carbonate (DEC), methyl propyl carbonate (MPC), 2,5-dioxahexanedioic acid dimethyl ester, tetrahydrofuran (THF), γ-butyrolactone (GBL), fluoroethylene carbonate (FEC), fluoromethyl ethylene carbonate (FMEC), trifluoroethyl methyl carbonate (F-EMC), fluorinated 3-(1,1,2,2-tetrafluoroethoxy)-1,1,2,2-tetrafluoropropane/1,1,2,2-tetrafluoro-3-(1,1,2,2-tetrafluoroethoxy)propane (F-EPE), and fluorinated cyclic carbonate (F-AEC).

In some embodiments, including any of the foregoing, the solution comprises a solvent selected from the group consisting of dioxolane, prop-1-ene-1,3-sultone (PES), sulfolane, acetonitrile (ACN), succinonitrile (SCN), pimelonitrile, suberonitrile, propionitrile, propanedinitrile, glutaronitrile (GLN), adiponitrile (ADN), hexanedinitrile, pentanedinitrile, acetophenone, isophorone, benzonitrile, ethyl propionate, methyl propionate, and methylene methanedisulfonate.

In some embodiments, including any of the foregoing, the solution comprises a solvent selected from the group consisting of dimethyl sulfate, dimethyl sulfoxide (DMSO), ethyl acetate, methyl butyrate, dimethyl ether (DME), diethyl ether, dioxolane, gamma butyl-lactone, methyl benzoate, and 2-methyl-5-oxooxolane-2-carbonitrile.

In one embodiment, including any of the foregoing, the solution comprises (1) an acid source wherein the acid source comprises H₃PO₄ and water and (2) a solvent wherein the solvent comprises ethylene sulfite (ES) and sulfolane.

In one embodiment, including any of the foregoing, the solution comprises (1) an acid source wherein the acid source comprises H₃PO₄ and (2) a solvent wherein the solvent comprises ethylene sulfite (ES) and sulfolane; and the concentration of the acid source in the acidic solution is about 10 ppm to 25 ppm, about 20 ppm to 40 ppm, about 30 ppm to 50 ppm, about 40 ppm to 60 ppm, or about 45 ppm to 65 ppm.

In one embodiment, including any of the foregoing, the solution comprises (1) an acid source wherein the acid source comprises H₃PO₄ and (2) a solvent wherein the solvent comprises ethylene sulfite (ES) and sulfolane; and the concentration of the acid source in the acidic solution is about 300 ppm to 400 ppm, about 350 ppm to 450 ppm, about 400 ppm to 500 ppm, about 450 ppm to 550 ppm, or about 450 ppm to 600 ppm.

In one embodiment, including any of the foregoing, the solution comprises (1) an acid source wherein the acid source comprises H₃PO₄ and (2) a solvent wherein the solvent comprises ethylene sulfite (ES) and sulfolane; and the concentration of the acid source in the acidic solution is about 50 ppm.

In one embodiment, including any of the foregoing, the solution comprises (1) an acid source wherein the acid source comprises H₃PO₄ and (2) a solvent wherein the solvent comprises ethylene sulfite (ES) and sulfolane; and the concentration of the acid source in the acidic solution is about 500 ppm.

In one embodiment, including any of the foregoing, the solution comprises (1) an acid source wherein the acid source comprises H₃PO₄ and (2) a solvent wherein the solvent comprises ethylene sulfite (ES); and the concentration of the acid source in the acidic solution is about 10 ppm to 25 ppm, about 20 ppm to 40 ppm, about 30 ppm to 50 ppm, about 40 ppm to 60 ppm, or about 45 ppm to 65 ppm. In one embodiment, including any of the foregoing, the solution comprises (1) an acid source wherein the acid source comprises H₃PO₄ and (2) a solvent wherein the solvent comprises ethylene sulfite (ES); and the concentration of the acid source in the acidic solution is about 300 ppm to 400 ppm, about 350 ppm to 450 ppm, about 400 ppm to 500 ppm, about 450 ppm to 550 ppm, or about 450 ppm to 600 ppm. In one embodiment, including any of the foregoing, the solution comprises (1) an acid source wherein the acid source comprises H₃PO₄ and (2) a solvent wherein the solvent comprises ethylene sulfite (ES); and the concentration of the acid source in the acidic solution is about 50 ppm. In one embodiment, including any of the foregoing, the solution comprises (1) an acid source wherein the acid source comprises H₃PO₄ and (2) a solvent wherein the solvent comprises ethylene sulfite (ES); and the concentration of the acid source in the acidic solution is about 500 ppm. In one embodiment, including any of the foregoing, the solution comprises (1) an acid source wherein the acid source comprises H₃PO₄ and (2) a solvent wherein the solvent comprises ethylene sulfite (ES); and the concentration of the acid source in the acidic solution is about 1000 ppm to 5500 ppm, about 2000 ppm to 5500 ppm, about 3000 ppm to 5500 ppm, or about 4000 ppm to 5500 ppm. In one embodiment, including any of the foregoing, the solution comprises (1) an acid source wherein the acid source comprises H₃PO₄ and (2) a solvent wherein the solvent comprises ethylene sulfite (ES); and the concentration of the acid source in the acidic solution is about 1000 ppm to 2000 ppm, about 1500 ppm to 2500 ppm, about 2000 ppm to 3000 ppm, about 2500 ppm to 3500 ppm, about 3000 ppm to 4000 ppm, about 3500 ppm to 4500 ppm, about 4000 to 5000 ppm, about 4500 ppm to 5500 ppm. In one embodiment, including any of the foregoing, the solution comprises (1) an acid source wherein the acid source comprises H₃PO₄ and (2) a solvent wherein the solvent comprises ethylene sulfite (ES); and the concentration of the acid source in the acidic solution is about 5000 ppm. In one embodiment, including any of the foregoing, the solution comprises (1) an acid source wherein the acid source comprises H₃PO₄ and (2) a solvent wherein the solvent comprises ethylene sulfite (ES); and the concentration of the acid source in the acidic solution is about 5500 ppm.

In one embodiment, including any of the foregoing, the acid source further comprises water. For example, in one embodiment, including any of the foregoing, the solution comprises (1) an acid source wherein the acid source comprises H₃PO₄ and water; and (2) a solvent wherein the solvent comprises ethylene sulfite (ES) and sulfolane; and the concentration of the acid source in the acidic solution is about 10 ppm to 25 ppm, about 20 ppm to 40 ppm, about 30 ppm to 50 ppm, about 40 ppm to 60 ppm, or about 45 ppm to 65 ppm. In one embodiment, including any of the foregoing, the solution comprises (1) an acid source wherein the acid source comprises H₃PO₄ and water; and (2) a solvent wherein the solvent comprises ethylene sulfite (ES) and sulfolane; and the concentration of the acid source in the acidic solution is about 50 ppm.

In one embodiment, including any of the foregoing, the acid source further comprises water. For example, in one embodiment, including any of the foregoing, the solution comprises (1) an acid source wherein the acid source comprises H₃PO₄ and water; and (2) a solvent wherein the solvent comprises ethylene sulfite (ES); and the concentration of the acid source in the acidic solution is about 10 ppm to 25 ppm, about 20 ppm to 40 ppm, about 30 ppm to 50 ppm, about 40 ppm to 60 ppm, or about 45 ppm to 65 ppm. In one embodiment, including any of the foregoing, the solution comprises (1) an acid source wherein the acid source comprises H₃PO₄ and water; and (2) a solvent wherein the solvent comprises ethylene sulfite (ES); and the concentration of the acid source in the acidic solution is about 50 ppm.

### Non-Limiting Embodiments

The present disclosure provides at least the following non-limiting embodiments:
(a) A process for treating a bilayer, wherein the bilayer comprises a metal foil or metal powder layer, and a lithium-stuffed garnet layer, comprising:
   i. providing a solution comprising an acid source at a concentration of about 10 ppm to 5500 ppm;
   ii. contacting the bilayer, with the solution for about one hour or less; and
   iii. removing the bilayer from the solution to afford an acid-treated bilayer.
(b) The process of (a), wherein the acid source comprises an acid, and/or its conjugate base, and/or dissolved ions thereof, selected from:
   i. H₃PO₄ and/or H₂PO₄ and/or PO₄³⁻ and/or PO₄²⁻.
   ii. H₂SO₄ and/or HSO₄⁻ and/or SO₄⁻ and/or SO₄⁻;
   iii. HCl and/or Cl⁻;
   iv. H₃BO₃ and/or B(OH)₄⁻ and/or BH₂O³⁻;
   v. H₂TiF₆ and/or TiF₆²⁻;
   vi. H₂ZrF₆ and/or ZrF₆²⁻; and
   vii. combinations thereof.
(c) The process of (b), wherein the acid source further comprises water.
(d) The process of any one of embodiments (a)-(c), wherein the acid source comprises H₃PO₄.
(e) The process of any one of embodiments (a)-(d), wherein the concentration of the acid source in the solution is about 30 ppm, about 50 ppm, about 80 ppm, about 100 ppm, about 300 ppm, about 500 ppm, about 800 ppm, about 1000 ppm, about 1500 ppm, about 2000 ppm, about 2500 ppm, about 3000 ppm, about 4000 ppm, about 4500 ppm, about 5000 ppm, or about 5500 ppm.
(f) The process of (e), wherein the concentration of the acid source in the acidic solution is about 5000 ppm.
(g) The process of any one of embodiments (a)-(f), wherein the solution comprises ethylene sulfite, sulfolane, or a combination thereof.
(h) The process of (g), wherein the solution comprises ethylene sulfite.
(i) The process of (g), wherein the solution comprises sulfolane and ethylene sulfite and wherein the ratio of sulfolane:ethylene sulfite is from about 3:7 v/v to 5:5 v/v.
(j) The process of (g), wherein the solution comprises sulfolane and ethylene sulfite, and wherein the ratio of sulfolane:ethylene sulfite is about 3:7 v/v.
(k) The process of any one of embodiments (a)-(j), wherein the solution further comprises a lithium salt at about 0.1 M to 5 M concentration.
(l) The process of (k), wherein the lithium salt is selected from the group consisting of LiPF₆, lithium bis(oxalato)borate (LiBOB), lithium bis(perfluoroethanesulfonyl)imide (LIBETI), bis(trifluoromethane)sulfonimide (LiTFSI), LiBF₄, LiClO₄, LiAsF₆, lithium bis(fluorosulfonyl)imide (LiFSI), LiF, LiI, LiBr, LiCl, and combinations thereof.
(m) The process of any one of embodiments (a)-(l), wherein the bilayer contacts the solution for at least 1 second, at least 10 seconds, at least 1 minute, at least 2 minutes, at least 3 minutes, at least 4 minutes, at least 5 minutes, at least 10 minutes, at least 20 minutes, at least 30 minutes, at least 40 minutes, at least 50 minutes, or one hour in (iii).
(n) The process of any one of embodiments (a)-(m), wherein the process further comprises (iv): contacting the acid-treated bilayer with a first rinse solution for about 1 second to 1 min and removing the acid-treated bilayer to afford a rinsed acid-treated bilayer.
(o) The process of (n), wherein the first rinse solution comprises ethylene sulfite, sulfolane, or a combination thereof.
(p) The process of (o), wherein the first rinse solution comprises ethylene sulfite.
(q) The process of any one of embodiments (a)-(p), wherein the process further comprises (v): contacting the acid-treated bilayer with a second rinse solution for about 1 second to 1 min and removing the acid-treated bilayer to afford a rinsed acid-treated bilayer.
(r) The process of (q), wherein the second rinse solution comprises acetonitrile.
(s) The process of any of embodiments (a)-(q), wherein the process further comprises (vi): drying the rinsed acid-treated bilayer.
(t) The process of any of embodiments (a)-(s), wherein the lithium-stuffed garnet layer of the bilayer is a lithium-stuffed garnet thin film.
(u) The process of any one of embodiments (a)-(t), wherein the bilayer is sintered.
(v) The process of any one of embodiments (a)-(u), wherein the contacting is done in a continuous fashion.
(w) The process of any one of embodiments (a)-(u), wherein the bilayer is kept flat with a magnetic sheet.
(x) An acid-treated bilayer made by the process of any one of embodiments (a)-(w).
(y) The acid-treated bilayer of (x), wherein the bilayer comprises a member selected from the group consisting of phosphorus (P), titanium (Ti), chlorine (Cl), sulfur (S), boron (B), zirconium (Zr), an ion thereof, and combinations thereof, greater than about 0.05 atomic percent as measured by X-ray photo-electron spectroscopy.
(z) The acid-treated bilayer of (x), wherein the lithium-stuffed garnet layer comprises a member selected from the group consisting of phosphorus (P), titanium (Ti), chlorine (Cl), sulfur (S), boron (B), zirconium (Zr), an ion thereof, and combinations thereof, at a depth of penetration of about 1 μm to 20 μm as measured by X-ray photo-electron spectroscopy.
(aa) The acid-treated bilayer of (x), wherein the bulk, but not the surface, of the sintered lithium-stuffed garnet thin film layer is characterized by the chemical formula Li_{A}La_{B}Al_{C}M″_{D}Zr_{E}O_{F}, wherein 5<A<8, 1.5<B<4, 0.1<C<2, 0≤D<2, 1<E<3, 10<F<13, and M″ is selected from the group consisting of Mo, W, Nb, Y, Ta, Ga, Sb, Ca, Ba, Sr, Ce, Hf, and Rb.
(bb) The acid-treated bilayer of (x), wherein the bulk, but not the surface, of the sintered lithium-stuffed garnet thin film layer is characterized by a formula selected from the group consisting of Li_{A}La_{B}M′_{C}M″_{D}Zr_{E}O_{F}, Li_{A}La_{B}M′_{C}M″_{D}Ta_{E}O_{F}, and Li_{A}La_{B}M′_{C}M″_{D}Nb_{E}O_{F}, wherein 4<A<8.5, 1.5<B<4, 0≤C<2.5, 0≤D<2.5; 0<E<2.5, 10<F<14, and wherein M′ and M″ are each, independently, selected from the group consisting of Al, Mo, W, Nb, Ga, Y, Gd, Sb, Ca, Ba, Sr, Ce, Hf, Rb, and Ta.
(cc) The acid-treated bilayer of (x), wherein the bulk, but not the surface, of the sintered lithium-stuffed garnet thin film layer is characterized by a formula selected from the group consisting of LiₐLa_{b}Zr_{c}Al_{d}M″ₑO_{f} wherein 5<a<7.7; 2<b<4; 0<c<2.5; 0<d<2.5; 0≤e<2.5, 10<f<14, and wherein M″ is a metal selected from the group consisting of Nb, Ta, V, W, Mo, and Sb.
(dd) The acid-treated bilayer of (x), wherein the bulk, but not the surface, of the sintered lithium-stuffed garnet thin film layer is characterized by a formula selected from the group consisting of LiₐLa_{b}Zr_{c}Al_{d}O_{f} wherein 5<a<7.7; 2<b<4; 0<c<2.5; 0<d<2.5; 10<f<14.
(ee) The acid-treated bilayer of (x), wherein the bulk, but not the surface, of the sintered lithium-stuffed garnet thin film layer is characterized by about Li₆La₃Zr₂O₁₂Al_{1/3}; about Li_{6.25}La₃Zr₂O₁₂Al_{0.25}; about Li₄La₃Zr₂O₁₂Ali; about Li_{6.7}La₃Zr₂O₁₂Al_{0.3}; or about Li₇La₃Zr₂O₁₂.
(ff) The acid-treated bilayer of any one of embodiments (x)-(ee), wherein the bulk, but not the surface, of the sintered lithium-stuffed garnet thin film layer is polycrystalline.
(gg) The acid-treated bilayer of any one of embodiments (x)-(ff), wherein the bilayer is characterized by an area specific resistance (ASR) of about 5 Ω-cm² to 50 Ω-cm² at 25° C.
(hh) The acid-treated bilayer of (g), wherein the bilayer is characterized by an area specific resistance (ASR) of about 5 Ω-cm² and 30 Ω-cm² at 25° C.
(ii) The acid-treated bilayer of (g), wherein the bilayer is characterized by an area specific resistance (ASR) of about 5 Ω-cm² and 25 Ω-cm² at 25° C.
(jj) The acid-treated bilayer of any one of embodiments (x)-(ii), wherein after a high temperature high volume (HTHV) test at 60° C. for 1 month, the bilayer does not experience more than about a 50% increase in area specific resistance (ASR).
(kk) The acid-treated bilayer of claim (jj), wherein after a HTHV test at 60° C. for 1 month, the bilayer does not experience more than about a 30% increase in area specific resistance (ASR).
(ll) The acid-treated bilayer of any one of embodiments (x)-(kk), wherein up to 21 days after acid treatment and storage under dry air conditions, the bilayer is characterized by an atomic percent ratio of the functional group CO₃ to Zr of less than about 5, but greater than 0, as measured by XPS.
(mm) The acid-treated bilayer of any one of embodiments (x)-(ll), wherein one week after a HTHV test, bilayer is characterized by an atomic percent ratio of the functional group CO₃ to Zr of less than about 1, but greater than 0, as measured by XPS.
(nn) An electrochemical cell or rechargeable battery comprising the bilayer of any one of embodiments (x)-(mm).
(oo) A bilayer comprising a metal foil or metal powder layer, and a lithium-stuffed garnet layer, wherein the lithium-stuffed garnet layer comprises a member selected from the group consisting of phosphorus (P), titanium (Ti), chlorine (Cl), sulfur (S), boron (B), zirconium (Zr), an ion thereof, and combinations thereof, at a depth of penetration of about 1 μm to 20 μm as measured by X-ray photo-electron spectroscopy (XPS).
(pp) The bilayer of (oo), wherein the lithium-stuffed garnet layer comprises LiₐLa_{b}Zr_{c}O_{d}Alₑ, in which 5≤a≤8, 2≤b≤4, 1≤c≤2, 11≤d≤14, and 0≤e<1, and wherein a, b, c, d, and e, are selected so the formula, LiₐLa_{b}Zr_{c}O_{d}Alₑ, is charge neutral.
(qq) The bilayer of (pp), wherein a is 6, 6.25, 6.50, 6.75, or 7.
(rr) The bilayer of (oo) or (pp), wherein e is 0, 0.25, 0.5, 0.75, or 1.
(ss) The bilayer of any one of embodiments (oo)-(rr), wherein b is 3 and z is 2.
(tt) The bilayer of any one of embodiments (pp)-(ss), wherein d is 12.
(uu) The bilayer of (pp), wherein a is 6.25, b is 3, c is 2, d is 12, and e is 0.25.
(vv) The bilayer of (pp), wherein a is about 6.25, b is about 3, c is about 2, d is about 12, and e is about 0.25.
(ww) The bilayer of any one of embodiments (oo)-(vv), wherein the bilayer comprises an acid, and/or its conjugate base, and/or dissolved ions thereof, incorporated into, or bonded, to the bilayer wherein the acid, and/or its conjugate base, and/or dissolved ions thereof is selected from the group consisting of:
   i. H₃PO₄ and/or H₂PO₄⁻ and/or PO₄³⁻ and/or PO₄²⁻;
   ii. H₂SO₄ and/or HSO₄⁻ and/or SO₄⁻ and/or SO₄⁻;
   iii. HCl and/or Cl⁻;
   iv. H₃BO₃ and/or B(OH)₄⁻ and/or BH₂O³⁻;
   v. H₂TiF₆ and/or TiF₆²⁻;
   vi. H₂ZrF₆ and/or ZrF₆²⁻; and
   vii. combinations thereof.
(xx) The bilayer of any one of embodiments (oo)-(ww), wherein the bilayer is characterized as having less than 1 m layer thereupon which includes a lithium carbonate, lithium hydroxide, lithium oxide, a hydrate thereof, an oxide thereof, or a combination thereof.
(yy) The bilayer of any one of embodiments (oo)-(ww), wherein the bilayer has less than about 1, but greater than 0, atomic percent of lithium carbonate as measured by X-ray photoelectron spectroscopy (XPS).
(zz) The bilayer of any one of embodiments (ww)-(yy), wherein the bilayer comprises H₃PO₄ and/or H₂PO₄⁻ and/or PO₄³⁻ and/or PO₄²⁻;
(aaa) The bilayer of any one of embodiments (ww)-(zz), wherein the bilayer comprises an amount of phosphorus at a depth of penetration of about 1 μm to 20 μm as measured by X-ray photo-electron spectroscopy.
(bbb) The bilayer of any one of embodiments (ww)-(aaa), wherein the bilayer comprises a phosphorous-containing layer of Li₃PO₄, LiH₂PO₄, or combinations thereof.
(ccc) The bilayer of (bbb), wherein the phosphorous-containing layer is continuous.
(ddd) The bilayer of (bbb), wherein the phosphorous-containing layer is discontinuous.
(eee) The bilayer of any one of embodiments (oo)-(ddd), wherein the bilayer is characterized by an atomic percent ratio of P to Zr about 1.5 to 10 as measured by XPS.
(fff) The bilayer of any one of embodiments (oo)-(ddd), wherein the bilayer is characterized by an atomic percent ratio of P to Zr about 1.5 to 3 as measured by XPS.
(ggg) The bilayer of any one of embodiments (oo)-(fff), wherein the bilayer is acid-treated.
(hhh) The bilayer of any one of embodiments (oo)-(ggg), wherein the bilayer is sintered.
(iii) A continuous bilayer treatment line comprising:
   a front roller unto which is wound a bilayer, wherein the bilayer comprises a metal foil or metal powder layer, and a lithium-stuffed garnet layer;
   wherein the metal layer contacts the front roller;
   an end roller;
   at least one acid treatment section between the front roller and the end roller comprising:
      a reservoir or a dispense unit;
      wherein the reservoir or the dispense unit is suspended on top of the bilayer; and
      wherein the reservoir or the dispense unit contains a solution comprising an acid source at a concentration of about 10 ppm to 5500 ppm.
(jjj) The continuous bilayer treatment line of (iii), further comprising a conveyor and a magnetic sheet, wherein the bilayer sits on top of the conveyor and wherein the magnetic sheet sit beneath and contacts the conveyor.
(kkk) The continuous bilayer treatment line of (iii) or (jjj), further comprising a drying section.

### Examples

X-ray photoelectron spectroscopy (XPS) measurements were performed on a Thermo Scientific Model K-Alpha 1 XPS instrument. Monochromatic and Al X-ray source with X-ray energy of 1486.6 eV was used with a spot size of 400 μm. The base pressure when the measurement was conducted is 2*10⁻⁹ mbar or below.

Unless specified otherwise, lithium-stuffed garnet films were prepared as follows. A slurry of lithium-stuffed garnet precursor materials were deposited by the doctor-blade method on aluminum-based setters and sintered at 1000° C. to 1300° C. to prepare thin-films of lithium-stuffed garnet that were about 50 microns (μm) in thickness.

Unless specified otherwise, co-sintered films (CSC films) were prepared as follows. A slurry of lithium-stuffed garnet precursor materials were casted onto mylar. A second slurry comprising nickel particles and additional lithium-stuffed garnet precursor materials was deposited (either method of screen-printed or casting) on top of the slurry of lithium-stuffed garnet materials. The resulting CSC bilayer was sintered on aluminum-based setters at 1000° C. to 1300° C. to prepare CSC films that were about 50 microns in thickness.

Unless specified otherwise, bilayer (film on metal foil) were prepared as follows. A slurry of lithium-stuffed garnet precursor materials was cast onto a metal foil and dried to form a green tape. The green tape cast on metal foil (bilayer before sintering) was unrolled and cut to the appropriate dimensions for sintering. This was done using a laser cutter. It is contemplated that a blade blanking tool could also be used. Discrete green sheets were then stacked between setter components and placed on support furniture used with the sintering apparatus. In this case, setter components refer to a dense Al₂O₃ plate onto which the green sheet was placed with the green tape side up, followed by a ceramic or metal frame component, followed by a metal sheet onto which a LiAlO₂ coating has been applied, followed by another dense Al₂O₃ plate.

### Example 1. Acid Treatment O_{F} CSC Films

Preparation of ESS containing 50 ppm H₃PO₄: A solution of ethylene sulfite:sulfolane (ESS, 7:3 by volume) was prepared in a large aluminum (Al) bottle. Molecular sieves, baked at 220° C. under vacuum for 12 hours were added to the ESS stock solution at a 10% mass ratio, referenced to the solvent's total mass. The ESS stock solution was dehydrated over molecular sieve over 14 days, until the H₂O content fell below 10 ppm via Karl Fischer titration. Aliquots of the now-dry ESS stock solution were measured via a graduated cylinder and poured into smaller plastic bottles of appropriate size. H₃PO₄ (50 ppm) in ESS was prepared by measuring the appropriate volume of phosphoric acid from a stock bottle of 85% H₃PO₄ (w/w) in aqueous solution and aliquoting into the appropriate ESS aliquot. The 50 ppm H₃PO₄ in ESS aliquot was then shaken for 5 seconds by hand and left to rest for at least 2 minutes prior to using in the remaining procedure.

Rinsing CSC films in H₃PO₄ containing solvent: CSC Films were placed in individual HDPE plastic containers, with the cathode-facing side of the CSC film facing upward. The 50 ppm H₃PO₄ in ESS aliquot (15 mL) were poured on top of each solid-state CSC film, submerging it fully. The plastic container's lid was then closed, and CSC films sat in solution for 5 minutes to 1 hour. When the soak was complete, bilayers were removed from the 50 ppm H₃PO₄ in ESS soak solution and transferred to a new HDPE container with a rinse solution (15 mL of ethylene sulfite). The CSC films were in the rinse solution with the garnet side facing up for 5 minutes. The CSC films were then removed from the rinse solution, placed on an absorbent wipe, and dried with compressed dry air (CDA). The CSC films were flipped back and forth while drying to ensure both anode and cathode-facing sides of the CSC films were no longer coated in residual ethylene sulfite.

### Example 2. ASR Study O_{F} Acid Treated CSC Films

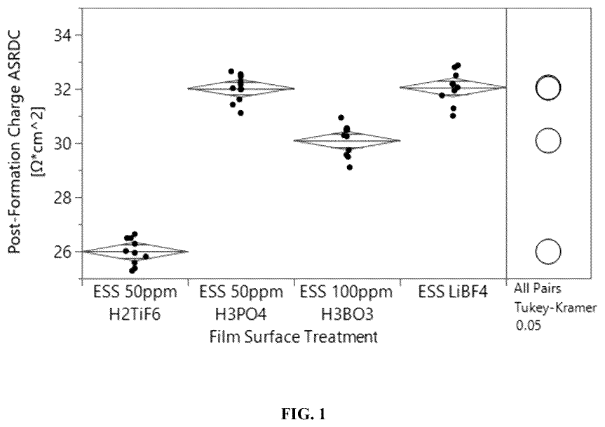

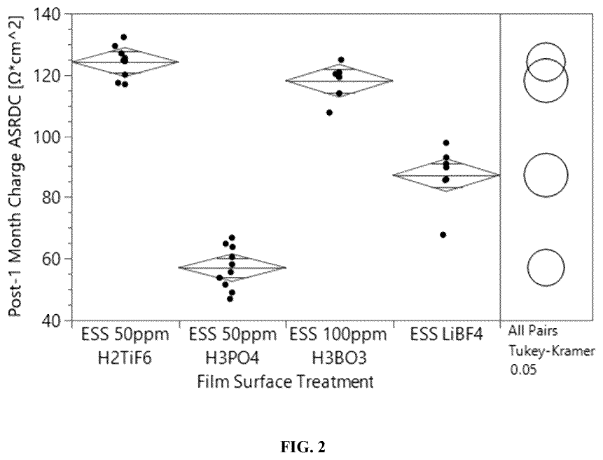

The CSC films were cut to 11 mm circles after treatment following the procedure of Example 1. Individual bilayers were used in electrochemical cells. The cells included a lithium-metal anode. The cells included Nickel Manganese Cobalt oxide active material. Cells underwent a formation cycle and then a C/3 charge to 4.35V at 25° C. The data presented in FIG. 1 represents the cell area-specific resistance (ASR) from the first C/3 cycle for 11 individual cells using bilayers treated with H₃PO₄ (50 ppm), H₂TiF₆ (50 ppm), or H₃BO₃ (100 ppm) in ESS solution compared to solid bilayers treated with LiBF₄. The cells were then placed in a 60° C. oven for 30 days at a resting voltage close to 4.35V. After high temperature high voltage exposure, cells were brought back to 25° C. ovens for a C/3 discharge [2.8V-4.35V], and a complete C/3 cycle [2.8V-4.35V]. The data presented in FIG. 2 represents the cell ASR from the full C/3 cycle after high temperature high voltage storage. This test is referred to herein as a high voltage high temperature (HVHT) test.

FIG. 1 and FIG. 2 show the ASR of acid treated solid bilayers treated with H₃PO₄ (50 ppm), H₂TiF₆ (50 ppm), H₃BO₃ (100 ppm) in ESS solution compared to solid bilayers treated with LiBF₄. The acid-treated bilayers were treated following the procedure of Example 1.

FIG. 1 is the ASR post acid treatment and FIG. 2 is the ASR following the high temperature high voltage (HTHV) test of Example 2. As shown in FIG. 2, the bilayer treated with H₃PO₄ is characterized by an ASR of less than 60 ohms*cm² one month following the high temperature high voltage test of Example 2.

### Example 3. Acid Treatment of Bilayers

Preparation of ES containing 5000 ppm H₃PO₄: A solution of ethylene sulfite (ES) was prepared in a large tank in a chemical wet bench. H₃PO₄ (5000 ppm) in ES was prepared by measuring the appropriate mass of phosphoric acid from a stock bottle of 99.9 wt % H₃PO₄ (w/w) and adding into the ES tank. The 5000 ppm H₃PO₄ was allowed to dissolve completely in the ES tank for 1 hour.

Rinsing bilayers in H₃PO₄ containing solvent: Bilayers comprising a sintered lithium-stuffed garnet film on either a pure nickel foil or a nickel alloy foil were placed in a PTFE cassette with slots for individual films. The bilayers were then submerged in the 5000 ppm H₃PO₄ in ES soak solution for 2 minutes to 5 minutes. When the soak was complete, the PTFE cassette containing the bilayers was removed from the 5000 ppm H₃PO₄ in ES soak solution and transferred to a new tank on the wet bench station with a rinse solution of ethylene sulfite. The PTFE cassette containing the bilayers were in the rinse solution for 10 seconds. The PTFE cassette containing the bilayers was then removed from the rinse solution, and transferred to a final rinse tank on the wet bench station with a rinse solution of acetonitrile. The PTFE cassette containing the bilayers was in the final rinse solution for 10 seconds. The PTFE cassette containing the bilayers was then removed from the rinse solution, transferred to an empty reservoir, and dried with compressed dry air (CDA). The bilayers were individually removed from the PTFE cassette when the drying was complete.

### Example 4. ASR Study of Acid Treated Bilayers

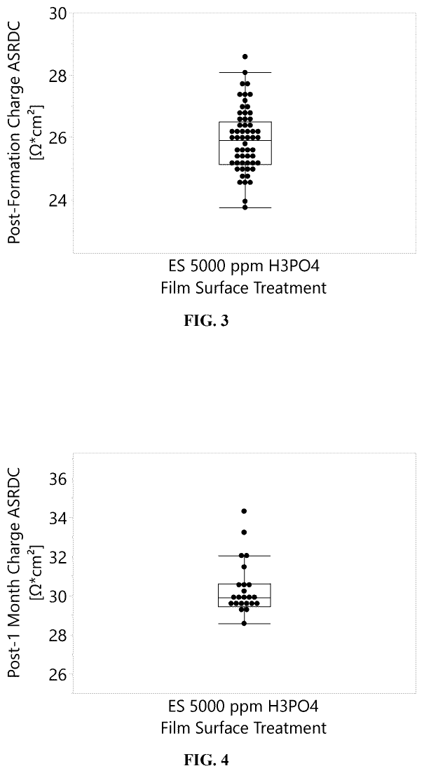

The bilayers were cut to 11 mm circles after treatment following the procedure of Example 3. Individual bilayers were used in electrochemical cells. The cells included a lithium-metal anode. The cells included Nickel Manganese Cobalt (NMC) oxide active material. Cells underwent a formation cycle and then a C/3 charge to 4.25V at 25° C. The data presented in FIG. 3 represents the cell area-specific resistance (ASR) from the first C/3 cycle for 11 individual cells using bilayers treated with H₃PO₄ at 5000 ppm in ES (ethylene sulfite) solution. The cells were then placed in a 60° C. oven for 30 days at a resting voltage close to 4.25V. After high temperature high voltage exposure, cells were brought back to 25° C. ovens for a C/3 discharge [2.8V-4.25V], and a complete C/3 cycle [2.8V-4.25V]. The data presented in FIG. 4 represents the cell ASR from the full C/3 cycle after high temperature high voltage storage. This test is referred to herein as a high voltage high temperature (HVHT) test.

FIG. 3 and FIG. 4 show the ASR of acid treated solid bilayers treated with H₃PO₄ (5000 ppm) in ES solution. FIG. 3 is the ASR post acid treatment and FIG. 4 is the ASR following the high temperature high voltage (HTHV) test of Example 4. The acid-treated bilayers were treated following the procedure of Example 3.

### Example 5. Acid Treatment and ASR Study of CSC Films

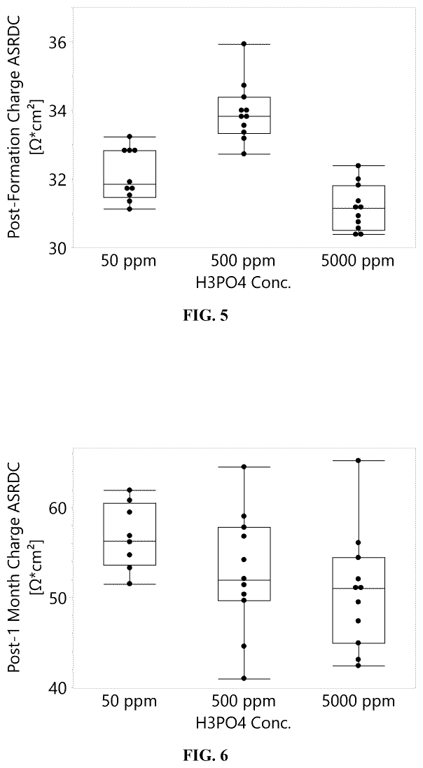

CSC bilayers, comprising a layer of lithium-stuffed garnet film and a layer comprising metal powder and lithium-stuffed garnet, were treated following the procedure of Example 3. FIG. 5 and FIG. 6 show the ASR of these acid treated CSC bilayers treated with H₃PO₄ at 50 ppm, 500 ppm, and 5000 ppm in ES solution. FIG. 5 is the ASR post acid treatment and FIG. 6 is the ASR following the high temperature high voltage (HTHV) test of Example 4. There is a slight variance in ASR between the bilayers treated with 50 ppm, 500 ppm, and 5000 ppm H₃PO₄, but all post formation ASR values remain in an acceptable range (30-35 ohms*cm²). Furthermore, as shown in FIG. 6, the ASR values of the bilayers treated with 50 ppm, 500 ppm, and 5000 ppm H₃PO₄ remain less than 66 ohms*cm² following the HTHV test of Example 4.

### Example 6. Surface Characterization of Acid Treated Bilayers

The bilayers treated with H₃PO₄ as described in Example 1 and Example 3 were characterized by XPS. The bilayers were transferred to the XPS system (ThermoFisher Scientific K-Alpha) under dry atmosphere (−50° C.). XPS analysis was performed with Monochromated, Micro-focused Al-Ka as X-ray source at a pressure of 10-8 Torr. The diameter of the analyzed area was 400 mm. The XPS spectra were fitted using Gaussian/Laurentzian product function peak shape model in combination with background.

The results are provided for the bilayer pre-formation, post-formation, and one week following the HTHV test of Example 2 or Example 4 in Table 1. The results are normalized to the Zr3d atom counts and are provided as a range of values that have been observed.

TABLE 1
XPS Analysis

| | CO₃/Zr atom | P/Zr atom | S/Zr atom |
|---|---|---|---|
| | counts ratio | counts ratio | counts ratio |
| Pre-formation | 1-4 | 2-10 | 0-0.8 |
| Post-formation | 0-1 | 2-10 | 0-1 |
| One-week HTHV | 0-1 | 2-15 | 0-2 |

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

What is claimed is:

1. A process for treating a bilayer, wherein the bilayer comprises a metal foil or metal powder layer, and a lithium-stuffed garnet layer, comprising:
(a) providing a solution comprising an acid source at a concentration of about 10 ppm to 5500 ppm;
(b) contacting the bilayer with the solution for about one hour or less; and
(c) removing the bilayer from the solution to afford an acid-treated bilayer.

2. The process of claim 1, wherein the acid source comprises an acid, and/or its conjugate base, and/or dissolved ions thereof, selected from:
(a) H₃PO₄ and/or H₂PO₄⁻ and/or PO₄³⁻ and/or PO₄²⁻;
(b) H₂SO₄ and/or HSO₄ and/or SO₄²⁻ and/or SO₄⁻;
(c) HCl and/or Cl⁻;
(d) H₃BO₃ and/or B(OH)₄⁻ and/or BH₂O₃⁻;
(e) H₂TiF₆ and/or TiF₆²⁻;
(f) H₂ZrF₆ and/or ZrF₆²⁻; and
(g) combinations thereof.

3. The process of claim 1 or 2, wherein the acid source comprises H₃PO₄.

4. The process of any one of claims 1-3, wherein the concentration of the acid source in the acidic solution is about 5000 ppm.

5. The process of any one of claims 1-4, wherein the solution comprises ethylene sulfite.

6. The process of any one of claims 1-5, wherein the process further comprises (d): contacting the acid-treated bilayer with a first rinse solution for about 1 second to 1 min and removing the acid-treated bilayer from the first rinse solution to afford a rinsed acid-treated bilayer.

7. The process of claim 6, wherein the process further comprises (e): contacting the acid-treated bilayer with a second rinse solution for about 1 second to 1 min and removing the acid-treated bilayer from the second rinse solution to afford a rinsed acid-treated bilayer.

8. The process of any one of claims 1-7, wherein the process further comprises (f): drying the rinsed acid-treated bilayer.

9. The process of any one of claims 1-8, wherein the contacting is done in a continuous fashion.

10. The process of any one of claims 1-9, wherein the bilayer is kept flat with a magnetic sheet during (b).

11. An acid-treated bilayer made by the process of any one of claims 1-10.

12. The acid-treated bilayer of claim 11, wherein the bilayer comprises a member selected from the group consisting of phosphorus (P), titanium (Ti), chlorine (Cl), sulfur (S), boron (B), zirconium (Zr), an ion thereof, and combinations thereof, greater than about 0.05 atomic percent as measured by X-ray photo-electron spectroscopy.

13. The acid-treated bilayer of claim 12, wherein the bilayer is characterized by an area specific resistance (ASR) of about 5 Ω-cm² and 30 Ω-cm² at 25° C.

14. The acid-treated bilayer of claim 11 or 12, wherein after a high temperature and high voltage (HTHV) test at 60° C. for 1 month, the bilayer does not experience more than about a 30% increase in area specific resistance (ASR).

15. The acid-treated bilayer of any one of claims 11-14, wherein up to 21 days after acid treatment and storage under dry air conditions, the bilayer is characterized by an atomic percent ratio of the functional group CO₃ to Zr of less than about 5, but greater than 0, as measured by XPS.

16. The acid-treated bilayer of any one of claims 11-15, wherein one week after a high temperature and high voltage (HTHV) test, bilayer is characterized by an atomic percent ratio of the functional group CO₃ to Zr of less than about 1, but greater than 0, as measured by XPS.

17. A bilayer comprising a metal foil or metal powder layer, and a lithium-stuffed garnet layer, wherein the lithium-stuffed garnet layer comprises a member selected from the group consisting of phosphorus (P), titanium (Ti), chlorine (Cl), sulfur (S), boron (B), zirconium (Zr), an ion thereof, and combinations thereof, at a depth of penetration of about 1 μm to 20 μm as measured by X-ray photo-electron spectroscopy (XPS).

18. The bilayer of claim 17, wherein the lithium-stuffed garnet layer comprises LiₐLa_{b}Zr_{c}O_{d}Alₑ, in which 5≤a≤8, 2≤b≤4, 1≤c≤2, 11≤d≤14, and 0≤e≤1, and wherein a, b, c, d, and e, are selected so the formula, LiₐLa_{b}Zr_{c}O_{d}Alₑ, is charge neutral.

19. The bilayer of claim 18, wherein a is about 6.25, b is about 3, c is about 2, d is about 12, and e is about 0.25.

20. The bilayer of any one of claims 17-19, wherein the bilayer comprises an acid, and/or its conjugate base, and/or dissolved ions thereof, incorporated into, or bonded, to the bilayer wherein the acid, and/or its conjugate base, and/or dissolved ions thereof is selected from the group consisting of:
(a) H₃PO₄ and/or H₂PO₄⁻ and/or PO₄³⁻ and/or PO₄²⁻;
(b) H₂SO₄ and/or HSO₄⁻ and/or SO₄²⁻ and/or SO₄⁻;
(c) HCl and/or Cl⁻;
(d) H₃BO₃ and/or B(OH)₄⁻ and/or BH₂O₃⁻;
(e) H₂TiF₆ and/or TiF₆²⁻;
(f) H₂ZrF₆ and/or ZrF₆²⁻; and
(g) combinations thereof.

21. The bilayer of any one of claims 17-20, wherein the bilayer has less than about 1, but greater than 0, atomic percent of lithium carbonate as measured by X-ray photoelectron spectroscopy (XPS).

22. The bilayer of any one of claims 17-21, wherein the bilayer comprises H₃PO₄ and/or H₂PO₄⁻ and/or PO₄³⁻ and/or PO₄²⁻.

23. The bilayer of any one of claims 17-22, wherein the bilayer comprises a phosphorous-containing layer of Li₃PO₄, LiH₂PO₄, or combinations thereof.

24. The bilayer of any one of claims 17-23, wherein the bilayer is characterized by an atomic percent ratio of P to Zr about 1.5 to 3 as measured by XPS.

25. The bilayer of any one of claims 17-24, wherein the bilayer is acid-treated.

26. A continuous bilayer treatment line comprising:
a front roller unto which is wound a bilayer, wherein the bilayer comprises a metal foil or metal powder layer, and a lithium-stuffed garnet layer;
wherein the metal layer contacts the front roller;
acid treatment section between the front roller and the end roller comprising:
a reservoir or a dispense unit;
wherein the reservoir or the dispense unit is suspended on top of the bilayer; and
wherein the reservoir or the dispense unit contains a solution comprising an acid source at a concentration of about 10 ppm to 5500 ppm.

27. The continuous bilayer treatment line of claim 26, further comprising a conveyor and a magnetic sheet, wherein the bilayer sits on top of the conveyor and wherein the magnetic sheet sits beneath and contacts the conveyor.

28. The continuous bilayer treatment line of claim 26 or 27, further comprising a drying section.
